(19) United States
(12) Patent Application Publication
(10) Pub. No.: US 2026/0129228 A1
(43) Pub. Date: May 7, 2026

(54) METHOD, APPARATUS, AND MEDIUM FOR VIDEO PROCESSING

(71) Applicant: Bytedance Inc., Los Angeles, CA (US)

(72) Inventors: Kai ZHANG, Los Angeles, CA (US); Li ZHANG, Los Angeles, CA (US)

(21) Appl. No.: 19/438,374

(22) Filed: Dec. 31, 2025

Related U.S. Application Data
(63) Continuation of application No. PCT/US2024/036573, filed on Jul. 2, 2024.
(60) Provisional application No. 63/524,686, filed on Jul. 2, 2023.

(51) Int. Cl. H04N 19/59; H04N 19/105; H04N 19/167; H04N 19/196

(52) U.S. Cl. CPC H04N 19/59; H04N 19/105; H04N 19/167; H04N 19/196

(57) ABSTRACT

Embodiments of the disclosure provide a solution for video processing. A method for video processing is proposed. The method includes: applying, for a conversion between a video unit of a video and a bitstream of the video unit, at least one of the followings in a cross-component prediction (CCP) model: a set of luma samples, a set of additional luma samples, a set of reconstructed chroma samples, or a set of predicted chroma samples; determining a prediction or reconstruction of the video unit by applying the CCP model to the video unit; and performing the conversion based on the prediction or reconstruction.

### CROSS-REFERENCE TO RELATED APPLICATIONS

This application is a continuation of International Application No. PCT/US2024/036573, filed on Jul. 2, 2024, which claims the benefit of U.S. provisional application No. 63/524,686, filed on Jul. 2, 2023. The entire contents of these applications are hereby incorporated by reference in their entireties.

### FIELDS

Embodiments of the present disclosure relates generally to video processing techniques, and more particularly, to extended cross-component prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, for a conversion between a video unit of a video and a bitstream of the video unit, at least one of the followings in a cross-component prediction (CCP) model: a set of luma samples, a set of additional luma samples, a set of reconstructed chroma samples, or a set of predicted chroma samples; determining a prediction or reconstruction of the video unit by applying the CCP model to the video unit; and performing the conversion based on the prediction or reconstruction. In this way, it can improve coding efficiency and coding performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: applying at least one of the followings in a cross-component prediction (CCP) model: a set of luma samples, a set of additional luma samples, a set of reconstructed chroma samples, or a set of predicted chroma samples; determining a prediction or reconstruction of a video unit of the video by applying the CCP model to the video unit; and generating the bitstream based on the prediction or reconstruction.

In a fifth aspect, a method for storing a bitstream of a video is proposed. The method comprises: applying at least one of the followings in a cross-component prediction (CCP) model: a set of luma samples, a set of additional luma samples, a set of reconstructed chroma samples, or a set of predicted chroma samples; determining a prediction or reconstruction of a video unit of the video by applying the CCP model to the video unit; generating the bitstream based on the prediction or reconstruction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates nominal vertical and horizontal locations of 4:2:2 luma and chroma samples in a picture;

FIG. 5 illustrates an example of encoder block diagram;

FIG. 6 illustrates 67 intra prediction modes;

FIG. 7 illustrates reference samples for wide-angular intra prediction;

FIG. 8 illustrates problem of discontinuity in case of directions beyond 45°;

FIG. 9 illustrates locations of the samples used for the derivation of α and β;

FIG. 10 illustrates an example of classifying the neighboring samples into two groups;

FIG. 11A is a schematic diagram illustrating definition of samples used by PDPC applied to a diagonal top-right mode;

FIG. 11B is a schematic diagram illustrating definition of samples used by PDPC applied to a diagonal bottom-left mode;

FIG. 11C is a schematic diagram illustrating definition of samples used by PDPC applied to an adjacent diagonal top-right mode;

FIG. 11D is a schematic diagram illustrating definition of samples used by PDPC applied to an adjacent diagonal bottom-left mode;

FIG. 12 is a schematic diagram illustrating gradient approach for non-vertical/non-horizontal mode;

FIG. 13 is a schematic diagram illustrating nScale values with respect to nTbH and mode number; for all nScale<0 cases gradient approach is used;

FIG. 14 is a schematic diagram illustrating flowcharts of current PDPC and proposed PDPC;

FIG. 15 is a schematic diagram illustrating neighbouring blocks (L, A, BL, AR, AL) used in the derivation of a general MPM list;

FIG. 16 is a schematic diagram illustrating an example on proposed intra reference mapping;

FIG. 17 is a schematic diagram illustrating an example of four reference lines neighbouring to a prediction block;

FIG. 18A is a schematic diagram illustrating examples of sub-partitions for 4×8 and 8×4 CUs;

FIG. 18B is a schematic diagram illustrating examples of sub-partitions for CUs other than 4×8, 8×4 and 4×4;

FIG. 19 is a schematic diagram illustrating matrix weighted intra prediction process;

FIG. 20 is a schematic diagram illustrating target samples, template samples and the reference samples of template used in the DIMD;

FIG. 21 is a schematic diagram illustrating proposed intra block decoding process;

FIG. 22 is a schematic diagram illustrating HoG computation from a template of width 3 pixels;

FIG. 23 is a schematic diagram illustrating prediction fusion by weighted averaging of two HoG modes and planar;

FIG. 24 is a schematic diagram illustrating spatial part of the convolutional filter;

FIG. 25 is a schematic diagram illustrating reference area (with its paddings) used to derive the filter coefficients;

FIG. 26 is a schematic diagram illustrating four Sobel based gradient patterns for GLM;

FIG. 27 is a schematic diagram illustrating spatial samples used for GL-CCCM;

FIG. 28 is a schematic diagram illustrating non-downsampled luma samples;

FIG. 29 illustrates spatial GPM candidates;

FIG. 30 illustrates GPM templates;

FIG. 31 illustrates GPM blending;

FIG. 32 illustrates binarization of cross-component prediction modes in ECM;

FIG. 33 illustrates an example of luma samples to be prepared;

FIG. 34 illustrates an example of potential candidate regions;

FIG. 35 illustrates possible templates;

FIG. 36 illustrates various downsampling filters used in the proposed cross-component models;

FIG. 37 illustrates the positions of chroma samples;

FIG. 38 illustrates an example of luma positions (which may be after down-sampling) to be used in CCP;

FIG. 39 illustrates an example of luma positions (which may be after down-sampling) and chroma positions to be used in CCP;

FIG. 40 illustrates a second example of luma positions (which may be after down-sampling) and chroma positions to be used in CCP;

FIG. 41 illustrates an example of reconstructed chroma sample positions used to derive the parameters of mixCCCM as the target values in the training process;

FIG. 42 shows an example, where L, Y and Z can only used as input values of X, but they may not be used as target values in the training process;

FIG. 43 shows an example, where L, Y and Z are used as input values of X;

FIG. 44 illustrates an example of applying the mixCCCM model in a 4×4 chroma block;

FIG. 45 illustrates a second example of applying the mixCCCM model in a 4×4 chroma block;

FIG. 46 shows an example, where L, Y and Z are used as input values of X, L, Y and Z are all prediction samples;

FIG. 47 illustrates a flowchart of a method for video processing in accordance with embodiments of the present disclosure; and

FIG. 48 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

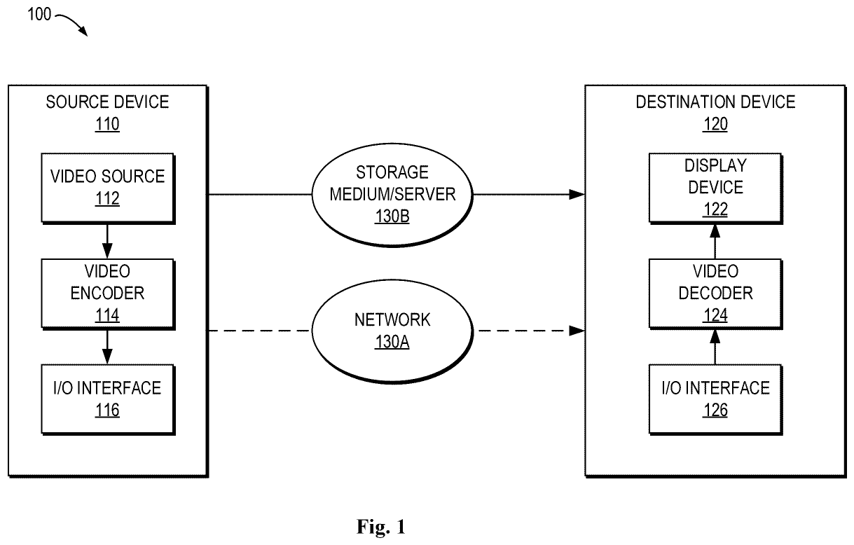

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

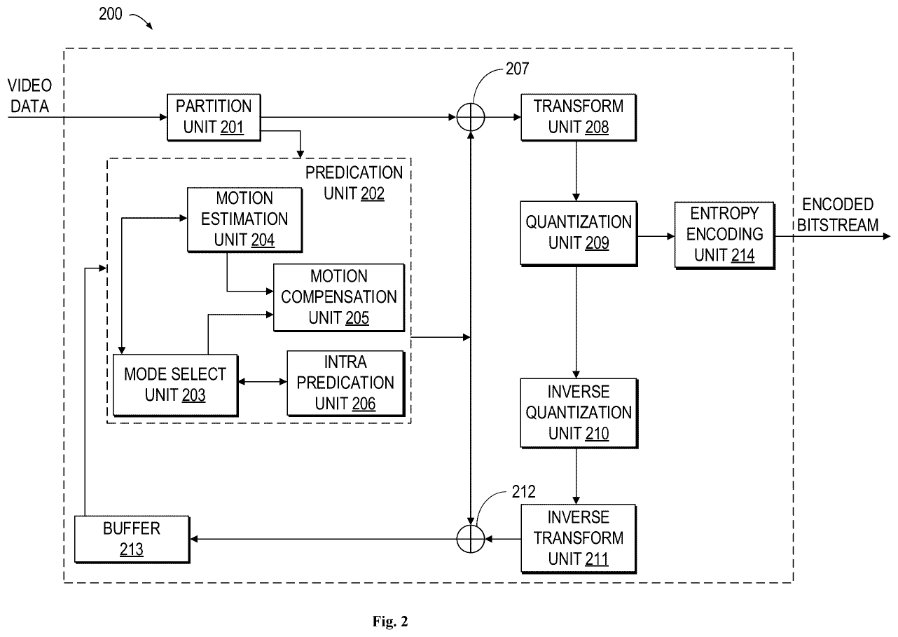

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

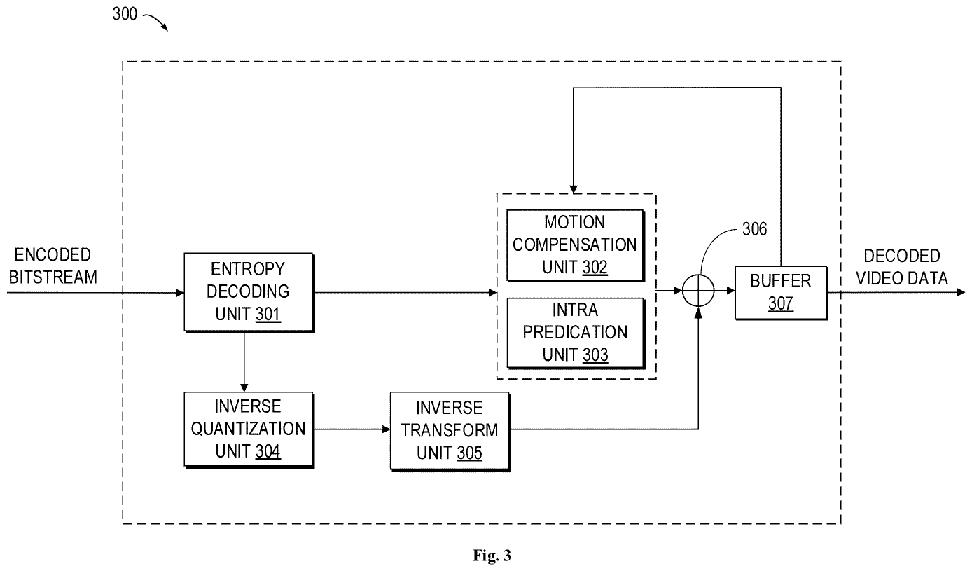

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to video coding technologies. Specifically, it is related to cross-component prediction. It may be applied to the existing video coding standard like HEVC, or Versatile Video Coding (VVC). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Color Space and Chroma Subsampling

Color space, also known as the color model (or color system), is an abstract mathematical model which simply describes the range of colors as tuples of numbers, typically as 3 or 4 values or color components (e.g., RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

### 2.1.1. 4:4:4

Each of the three Y′CbCr components have the same sample rate, thus there is no chroma subsampling. This scheme is sometimes used in high-end film scanners and cinematic post production.

### 2.1.2. 4:2:2

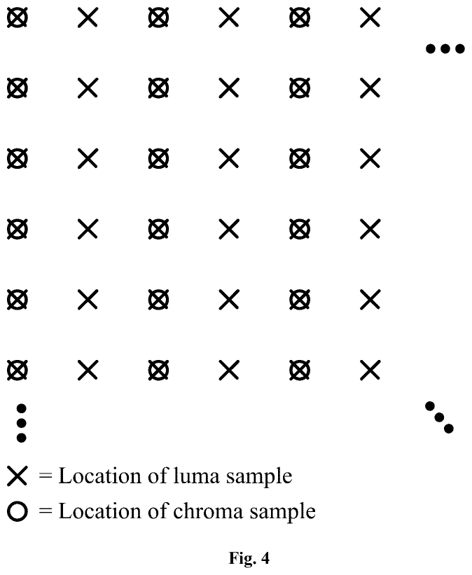

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft.

### 2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.

In MPEG-2, Cb and Cr are cosited horizontally. Cb and Cr are sited between pixels in the vertical direction (sited interstitially).

In JPEG/JFIF, H.261, and MPEG-1, Cb and Cr are sited interstitially, halfway between alternate luma samples.

In 4:2:0 DV, Cb and Cr are co-sited in the horizontal direction. In the vertical direction, they are co-sited on alternating lines.

TABLE 1
SubWidthC and SubHeightC values derived from chroma_format_{—}
idc and separate_colour_plane_flag ⊏

| | separate_{—} | | | |
|---|---|---|---|---|
| chroma_{—} | colour_{—} | Chroma | | |
| format_idc | plane_flag | format | SubWidthC | SubHeightC |
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2. Coding Flow of a Typical Video Codec

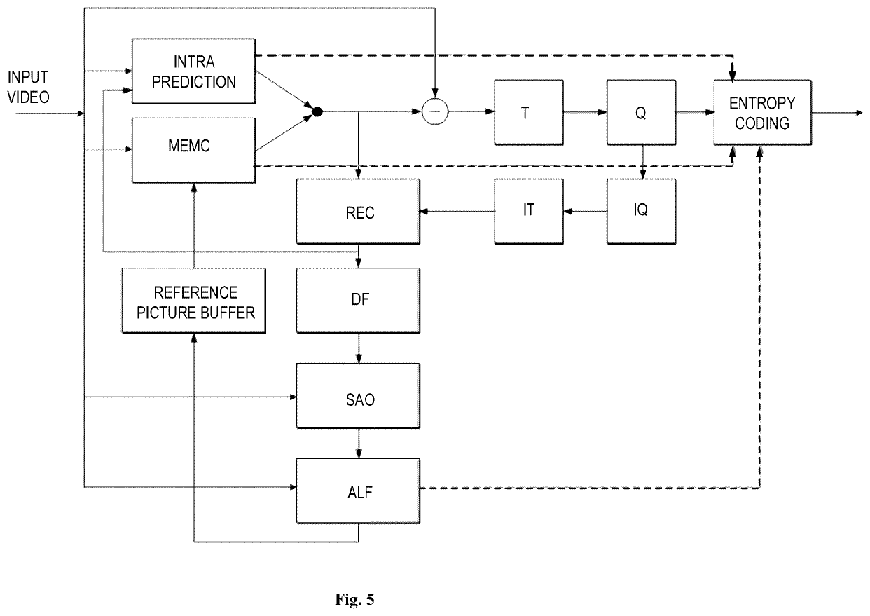

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 2.3. Intra Mode Coding with 67 Intra Prediction Modes

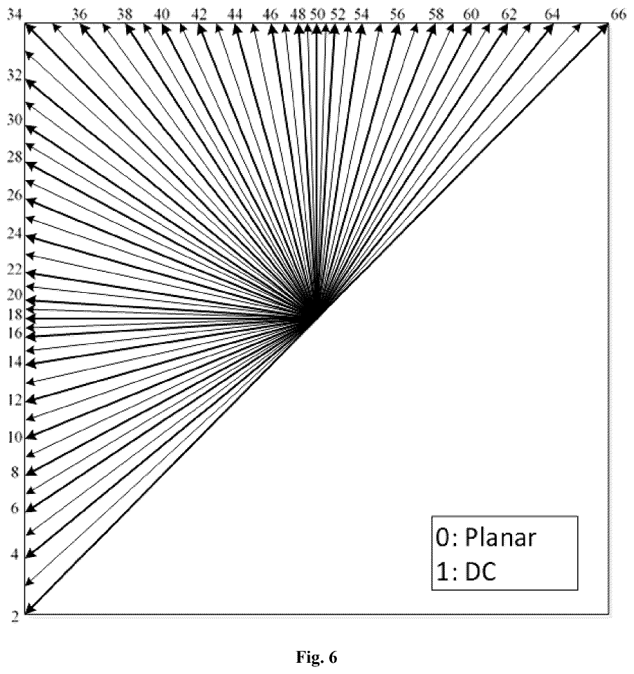

To capture the arbitrary edge directions presented in natural video, the number of directional intra modes is extended from 33, as used in HEVC, to 65, as shown in FIG. 6, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1. Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

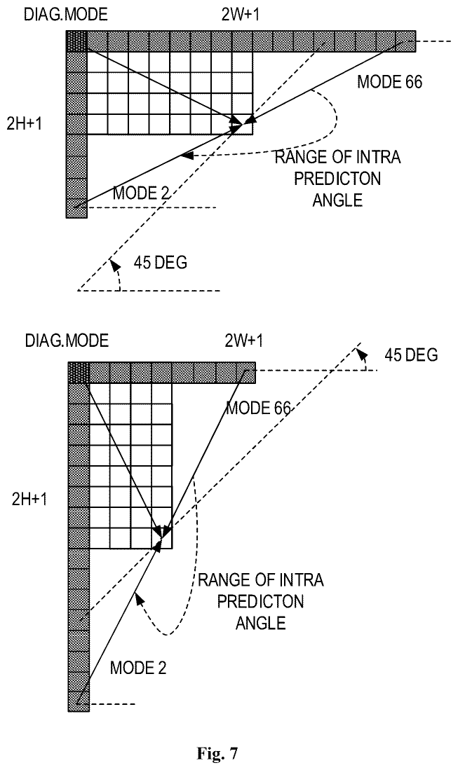

To support these prediction directions, the top reference with length 2W+1, and the left reference with length 2H+1, are defined as shown in FIG. 7.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, |
| | 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, |
| | 66 |
| W/H == 1/16 | Modes 53, 54, 55, 56, 57, 58, 59, 60, 61, 62, 63, |
| | 64, 65, 66 |

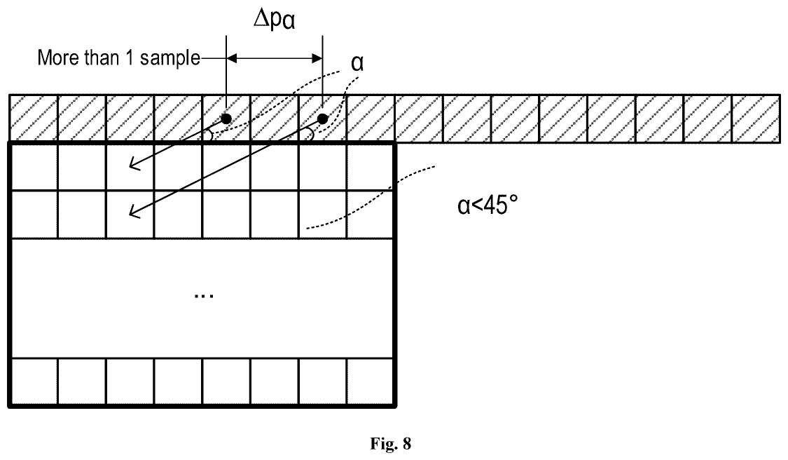

As shown in FIG. 8, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2:chroma format is updated by replacing some values of the entries of the mapping table to convert prediction angle more precisely for chroma blocks.

### 2.4. Intra Prediction Mode Coding for Chroma Component

For the chroma component of an intra PU, the encoder selects the best chroma prediction modes among five modes including Planar, DC, Horizontal, Vertical and a direct copy of the intra prediction mode for the luma component. The mapping between intra prediction direction and intra prediction mode number for chroma is shown in Table 3.

When the intra prediction mode number for the chroma component is 4, the intra prediction direction for the luma component is used for the intra prediction sample generation for the chroma component. When the intra prediction mode number for the chroma component is not 4 and it is identical to the intra prediction mode number for the luma component, the intra prediction direction of 66 is used for the intra prediction sample generation for the chroma component.

### 2.5. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.6. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.7. Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 2 - 1 )$$

where pred_{c}(i,j) represents the predicted chroma samples in a CU and rec_{L}(i,j) represents the down-sampled reconstructed luma samples of the same CU.

The CCLM parameters (α and β) are derived with at most four neighbouring chroma samples and their corresponding down-sampled luma samples. Suppose the current chroma block dimensions are W×H, then W″ and H′ are set as
W′=W, H′=H when LM mode is applied;
W′=W+H when LM_T mode is applied;
H′=H+W when LM_L mode is applied.

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM_T mode is applied or only the above neighbouring samples are available;
S[−1, H′/8], S[−1,3*H′/8], S[−1,5*H′/8], S[−1,7*H′/8] when LM_L mode is applied or only the left neighbouring samples are available.

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; {Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1. \qquad ( 2 - 2 )$$

Finally, the linear model parameters α and β are obtained according to the following equations.

$$α = \frac{{Y}_{a} - {Y}_{b}}{{X}_{a} - {X}_{b}} \qquad ( 2 - 3 )$$

$$β = {Y}_{b} - α \cdot {X}_{b} \qquad ( 2 - 4 )$$

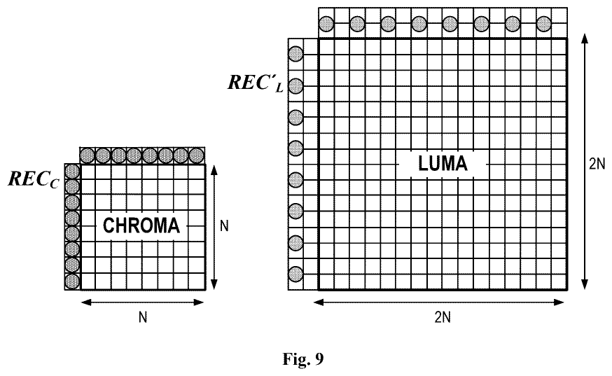

FIG. 9 shows an example of the location of the left and above samples and the sample of the current block involved in the CCLM mode.

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 2 - 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_T, and LM_L modes.

In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + \\ {rec}_{L} ( 2 i + 1 , 2 j - 1 ) + {rec}_{L} ( 2 i - 1 , 2 j ) + \\ 2 \cdot {rec}_{L} ( 2 i , 2 j ) + {rec}_{L} ( 2 i + 1 , 2 j ) + 4\end{matrix} ] >> 3 \qquad ( 2 - 6 )$$

$${rec}_{L}^{′} ( i , j ) = [ \begin{matrix}{rec}_{L} ( 2 i , 2 j - 1 ) + {rec}_{L} ( 2 i - 1 , 2 j ) + \\ 4 \cdot {rec}_{L} ( 2 i , 2 j ) + {rec}_{L} ( 2 i + 1 , 2 j ) + \\ {rec}_{L} ( 2 i , 2 j + 1 ) + 4\end{matrix} ] >> 3 \qquad ( 2 - 7 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the a and D values to the decoder.

For chroma intra mode coding, a total of 8 intra modes are allowed for chroma intra mode coding. Those modes include five conventional intra modes and three cross-component linear model modes (LM, LM_T, and LM_L). Chroma mode signalling and derivation process are shown in Table 3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 3
Derivation of chroma prediction mode
from luma mode when CCLM is enabled

| Chroma | Corresponding luma intra prediction mode | | | | |
|---|---|---|---|---|---|
| prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 4.

TABLE 4
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 4, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node is allowed to use CCLM in the following way:
If the 32×32 chroma node is not split or partitioned QT split, all chroma CUs in the 32×32 node can use CCLM;
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 2.8. Multi-Model Linear Model (MMLM)

With MMLM, there can be more than one linear models between the luma samples and chroma samples in a CU. In this method, neighboring luma samples and neighboring chroma samples of the current block are classified into several groups, each group is used as a training set to derive a linear model (i.e., particular α and β are derived for a particular group). Furthermore, the samples of the current luma block is also classified based on the same rule for the classification of neighboring luma samples.

The neighboring samples can be classified into M groups, where M is 2 or 3. The MMLM method with M=2 and M=3 are designed as two appended Chroma prediction modes named MMLM2 and MMLM3, besides the original LM mode. The encoder chooses the optimal mode in the RDO process and signal the mode.

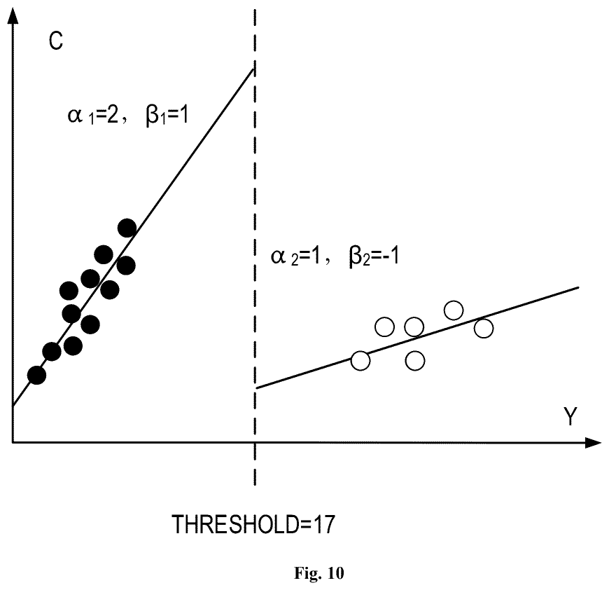

When M is equal to 2, FIG. 10 shows an example of classifying the neighboring samples into two groups. Threshold is calculated as the average value of the neighboring reconstructed Luma samples. A neighboring sample with Rec′L[x,y]<=Threshold Rc′_{L}[x,y]≤Threshold is classified into group 1; while a neighboring sample with Rec′_{L} [x, y]>Threshold Rec′L[x,y]>Threshold is classified into group 2. Similar to CCLM, there are 3 modes in MMLM, namely MMLM, MMLM_T, and MMLM_L. Two models are derived as below.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 2 - 8 )$$

The threshold which is the average of the luma reconstructed neighboring samples. The linear model of each class is derived by using the Least-Mean-Square (LMS) method, if enabled, or min/max method of VVC.

### 2.9. Position Dependent Intra Prediction Combination

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is BDPCM mode or MRL index is larger than 0, PDPC is not applied.

The prediction sample pred(x′,y′) is predicted using an intra prediction mode (DC, planar, angular) and a linear combination of reference samples according to the Equation 2-8 as follows:

$$pred ( {x}^{′} , {y}^{′} ) = Clip ( 0 , ( 1 << BitDepth ) - 1 , ( wL \times {R}_{- 1 , {y}^{′}} + wT \times {R}_{{x}^{′} , - 1} + ( 64 - wL - wT ) \times pred ( {x}^{′} , {y}^{′} ) + 32 ) >> 6 ) \qquad ( 2 - 9 )$$

where R_{x,-1}, R_{-1,y} represent the reference samples located at the top and left boundaries of current sample (x, y), respectively.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.

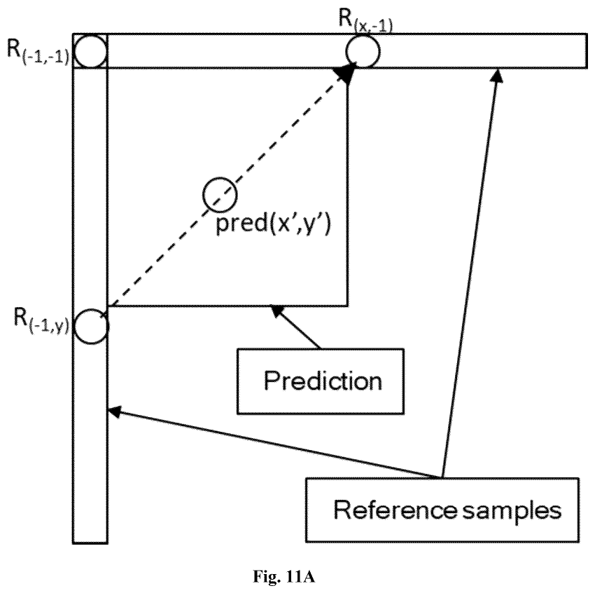

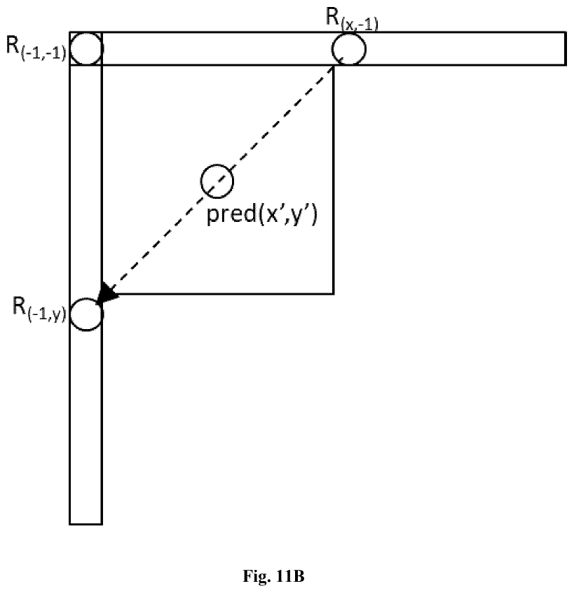

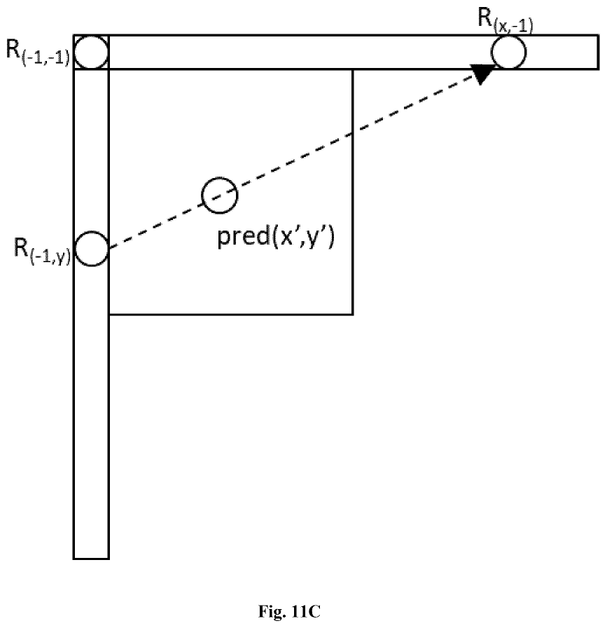

FIGS. 11A-11D illustrate the definition of reference samples (R_{x,-1} and R_{-1,y}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angular mode, the reference samples R_{x,-1} and R_{-1,j} could be located in fractional sample position. In this case, the sample value of the nearest integer sample location is used.

### 2.10. Gradient PDPC

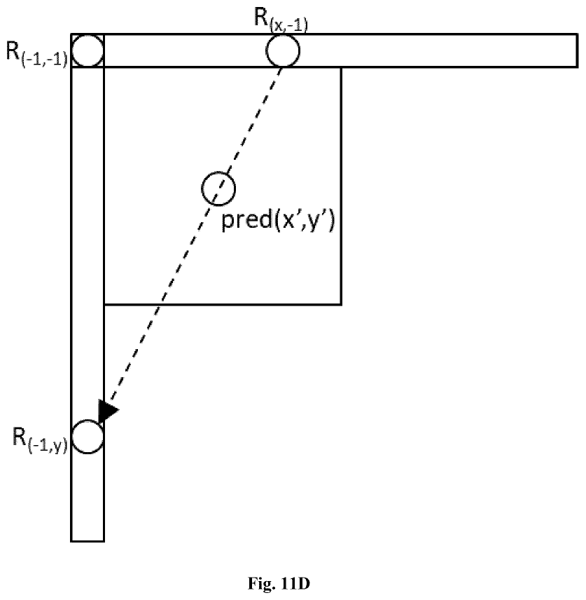

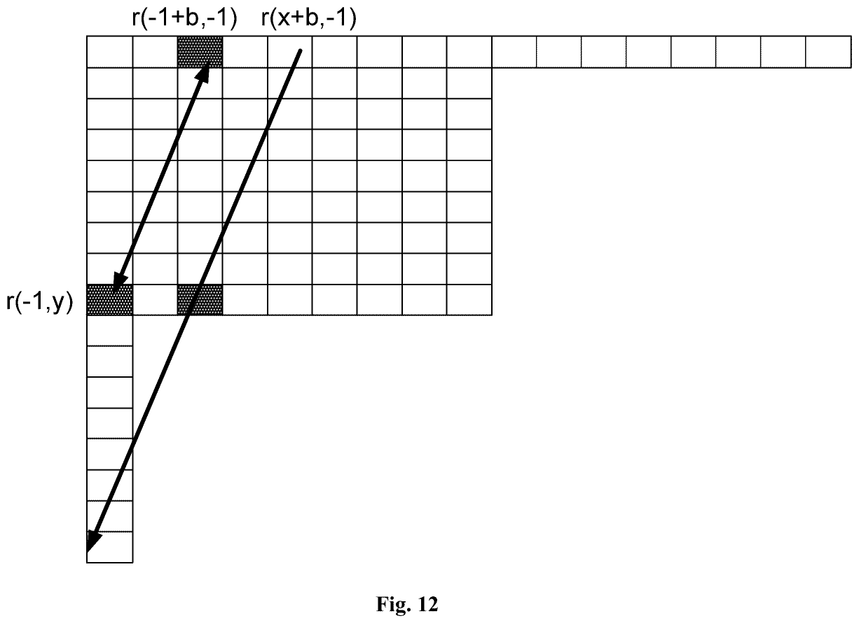

The gradient based approach is extended for non-vertical/non-horizontal mode, as shown in FIG. 12. Here, the gradient is computed as r(−1, y)−r(−1+d, −1), where d is the horizontal displacement depending on the angular direction. A few points to note here:

The gradient term r(−1, y)−r(−1+d, −1) is needed to be computed once for every row, as it does not depend on the x position.

The computation of d is already part of original intra prediction process which can be reused, so a separate computation of d is not needed. Accordingly, d is in 1/32 pixel accuracy.

It has used two tap (linear) filtering when d is at fractional position, i.e., if dPos is the displacement in 1/32 pixel accuracy, dInt is the (floored) integer part (dPos>>5), and dFract is the fractional part in 1/32 pixel accuracy (dPos & 31), then r(−1+d) is computed as:

$$r ( - 1 + d ) = ( 32 - dFrac ) * r ( - 1 + dInt ) + dFrac * r ( - 1 + dInt + 1 ) .$$

This 2 tap filtering is performed once per row (if needed), as explained in a.

Finally, the prediction signal is computed as follows:

$$p ( x , y ) = Clip ( ( ( 64 - wL ( x ) ) * p ( x , y ) + wL ( x ) * ( r ( - 1 , y ) - r ( - 1 + d , - 1 ) ) + 32 ) >> 6 )$$

where wL(x)=32>>((x<<1)>>nScale2), and nScale2=(log 2(nTbH)+log 2(nTbW)−2)>>2, which are the same as vertical/horizontal mode. In a nutshell, the same process is applied compared to vertical/horizontal mode (in fact, d=0 indicates vertical/horizontal mode).

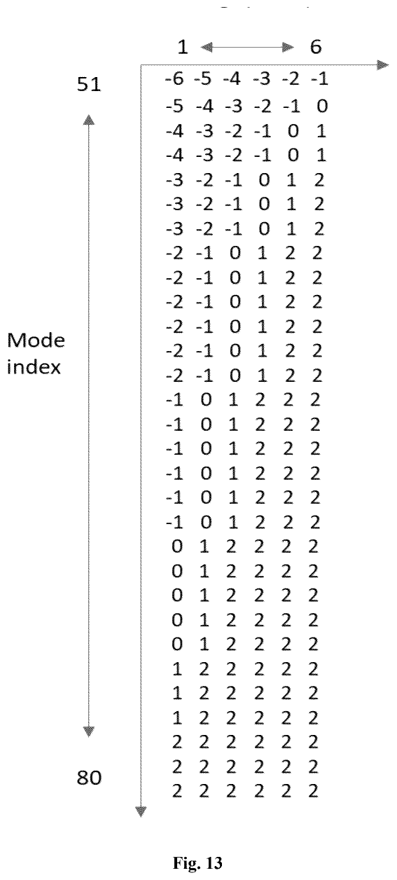

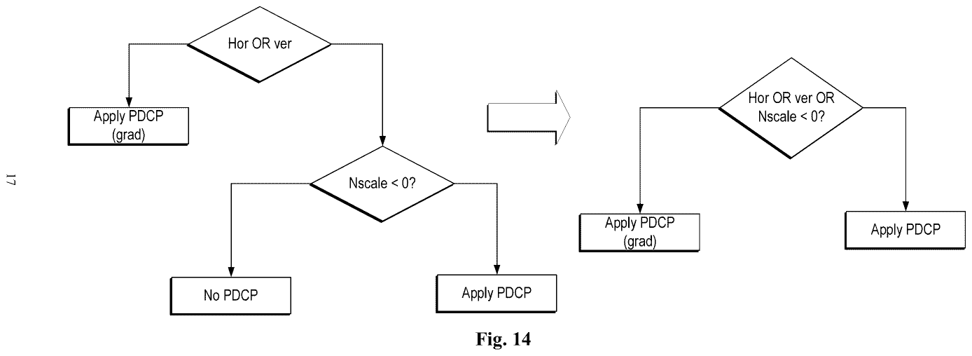

Second, it can activate the gradient based approach for non-vertical/non-horizontal mode when (nScale<0) or when PDPC can't be applied due to unavailability of secondary reference sample. It has shown the values of nScale in FIG. 13, with respect to TB size and angular mode, to better visualize the cases where gradient approach is used. Additionally, in FIG. 14, it has shown the flowchart for current and proposed PDPC.

### 2.11. Secondary MPM

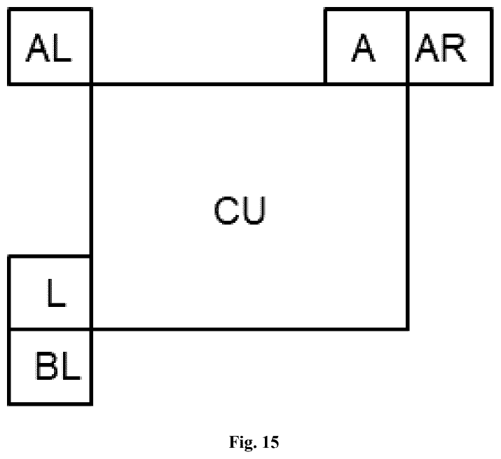

The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 15, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.12. 6-Tap Intra Interpolation Filter

To improve prediction accuracy, it is proposed to replace 4-tap Cubic interpolation filter with 6-tap interpolation filter, the filter coefficients are derived based on the same polynomial regression model, but with polynomial order of 6.

Filter coefficients are listed below,
{0, 0, 256, 0, 0, 0},//0/32 position
{0, −4, 253, 9, −2, 0},//1/32 position
{1, −7, 249, 17, −4, 0},//2/32 position
{1, −10, 245, 25, −6, 1},//3/32 position
{1, −13, 241, 34, −8, 1},//4/32 position
{2, −16, 235, 44, −10, 1},//5/32 position
{2, −18, 229, 53, −12, 2},//6/32 position
{2, −20, 223, 63, −14, 2},//7/32 position
{2, −22, 217, 72, −15, 2},//8/32 position
{3, −23, 209, 82, −17, 2},//9/32 position
{3, −24, 202, 92, −19, 2},//10/32 position
{3, −25, 194, 101, −20, 3},//11/32 position
{3, −25, 185, 111, −21, 3},//12/32 position
{3, −26, 178, 121, −23, 3},//13/32 position
{3, −25, 168, 131, −24, 3},//14/32 position
{3, −25, 159, 141, −25, 3},//15/32 position
{3, −25, 150, 150, −25, 3},//half-pel position.

The reference samples used for interpolation come from reconstructed samples or padded as in HEVC, so that the conditional check on reference sample availability is not needed.

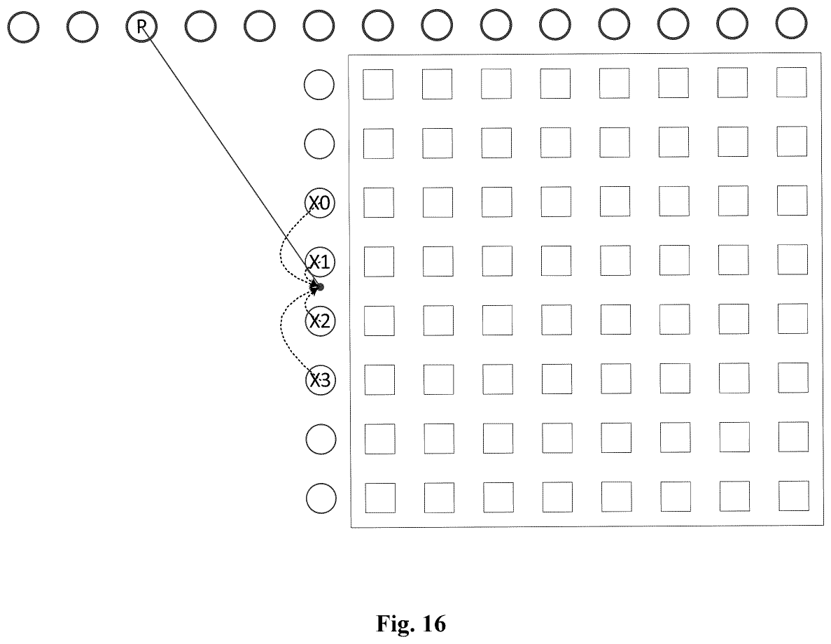

Instead of using nearest rounding operation to derive the extended Intra reference sample, it is proposed to use 4-tap Cubic interpolation filter. As shown in an example in FIG. 16, to derive the value of reference sample P, a four tap interpolation filter is used, while in JEM-3.0 or HM, P is directly set as X1.

### 2.13. Multiple Reference Line (MRL) Intra Prediction

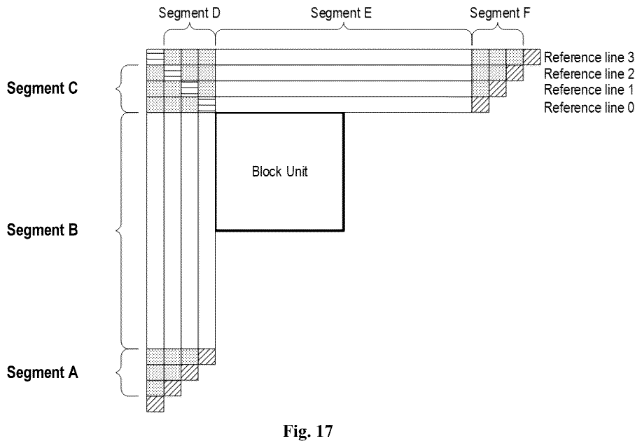

Multiple reference line (MRL) intra prediction uses more reference lines for intra prediction. In FIG. 17, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 2) are used.

The index of selected reference line (mrl_idx) is signalled and used to generate intra predictor. For reference line index, which is greater than 0, only include additional reference line modes in MPM list and only signal MPM index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned as CCLM to reduce the storage requirements for decoders.

### 2.14. Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

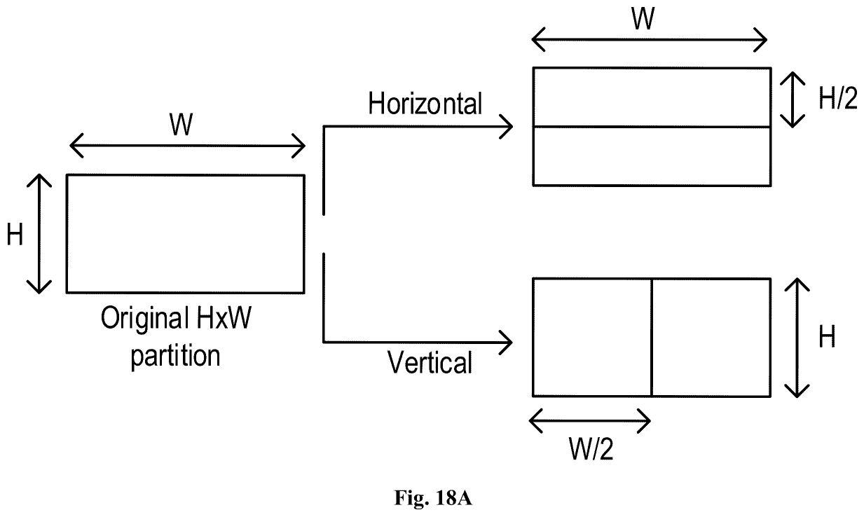

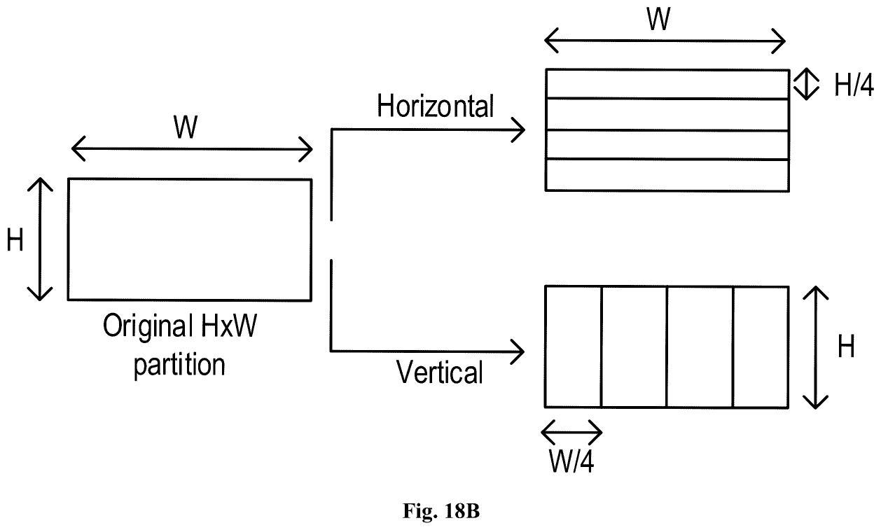

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 18A-18B show examples of the two possibilities. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 5
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 5. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w≥4 and w≤16, t_{H}=DST-VII, otherwise, t_{H}=DCT-II.
   If h≥4 and h≤16, t_{V}=DST-VII, otherwise, t_{V}=DCT-II.

In ISP mode, all 67 intra prediction modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### 2.15. Matrix Weighted Intra Prediction (MIP)

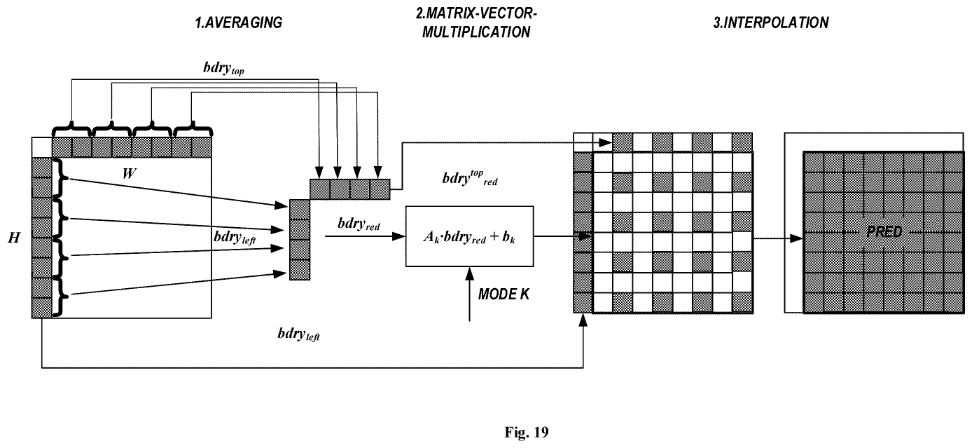

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 19.

### 2.15.1. Averaging Neighbouring Samples

Among the boundary samples, four samples or eight samples are selected by averaging based on block size and shape. Specifically, the input boundaries bdryt^{top} and bdry^{left} are reduced to smaller boundaries

$${bdry}_{red}^{top} and {bdry}_{red}^{left}$$

by averaging neighbouring boundary samples according to predefined rule depends on block size. Then, the two reduced boundaries

$$b d r {y}_{r e d}^{t o p} and {bdry}_{r e d}^{l e f t}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6\end{matrix} . \qquad ( 2 - 10 )$$

### 2.15.2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix} \qquad ( 2 - 11 )$$

$${H}_{red} = \{ \begin{matrix}4 & for max ( W , H ) \leq 8 \\ min ( H , 8 ) & for max ( W , H ) > 8\end{matrix} . \qquad ( 2 - 12 )$$

The reduced prediction signal pred_{red} is computed by calculating a matrix vector product and adding an offset:

$${pred}_{red} = A \cdot {bdry}_{red} + b . \qquad ( 2 - 13 )$$

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8\end{matrix} . \qquad ( 2 - 14 )$$

Here, each coefficient of the matrix A is represented with 8 bit precision. The set S₀ consists of 16 matrices

$${A}_{0}^{i} ,$$

i∈{0, . . . , 15} each of which has 16 rows and 4 columns and 16 offset vectors

$${b}_{0}^{i} ,$$

i∈{0, . . . , 16} each of size 16. Matrices and offset vectors of that set are used for blocks of size 4×4. The set S₁ consists of 8 matrices

$${A}_{1}^{i} ,$$

i∈{0, . . . , 7}, each of which has 16 rows and 8 columns and 8 offset vectors

$${b}_{1}^{i} ,$$

i∈{0, . . . , 7} each of size 16. The set S₂ consists of 6 matrices

$${A}_{2}^{i} ,$$

i∈{0, . . . , 5}, each of which has 64 rows and 8 columns and of 6 offset vectors

$${b}_{2}^{i} ,$$

i∈{0, . . . , 5} of size 64.

### 2.15.3. Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

### 2.15.4. Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows

$$isTransposed = predModeIntra \& 1 \qquad ( 2 - 15 )$$

$$modeId = predModeIntra >> 1.$$

MIP coding mode is harmonized with other coding tools by considering following aspects:
LFNST is enabled for MIP on large blocks. Here, the LFNST transforms of planar mode are used;
The reference sample derivation for MIP is performed exactly as for the conventional intra prediction modes;
For the up-sampling step used in the MIP-prediction, original reference samples are used instead of down-sampled ones;
Clipping is performed before up-sampling and not after up-sampling;
MIP is allowed up to 64×64 regardless of the maximum transform size.

The number of MIP modes is 32 for sizeId=0, 16 for sizeId=1 and 12 for sizeId=2.

### 2.16. Decoder-Side Intra Mode Derivation

In JEM-2.0 intra modes are extended to 67 from 35 modes in HEVC, and they are derived at encoder and explicitly signalled to decoder. A significant amount of overhead is spent on intra mode coding in JEM-2.0. For example, the intra mode signalling overhead may be up to 5˜10% of overall bitrate in all intra coding configuration. This contribution proposes the decoder-side intra mode derivation approach to reduce the intra mode coding overhead while keeping prediction accuracy.

To reduce the overhead of intra mode signalling, this contribution presents a decoder-side intra mode derivation (DIMD) approach. In the proposed approach, instead of signalling intra mode explicitly, the information is derived at both encoder and decoder from the neighbouring reconstructed samples of current block. The intra mode derived by DIMD is used in two ways:
1) For 2N×2N CUs, the DIMD mode is used as the intra mode for intra prediction when the corresponding CU-level DIMD flag is turned on;
2) For N×N CUs, the DIMD mode is used to replace one candidate of the existing MPM list to improve the efficiency of intra mode coding.

### 2.16.1. Templated Based Intra Mode Derivation

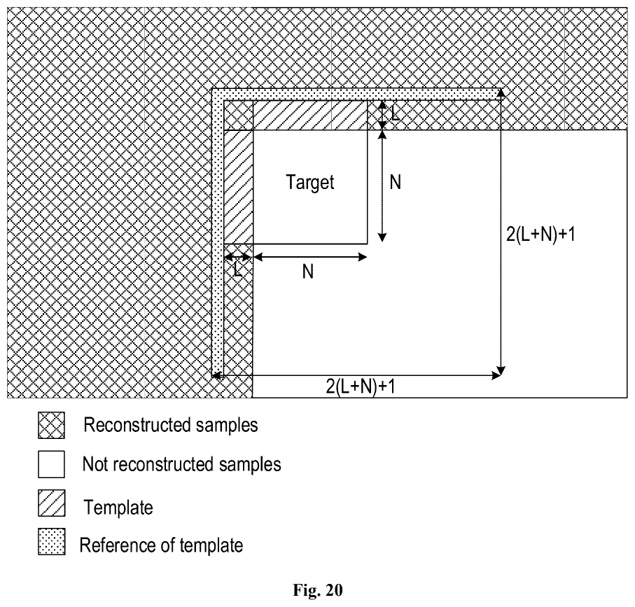

As illustrated in FIG. 20, the target denotes the current block (of block size N) for which intra prediction mode is to be estimated. The template (indicated by the patterned region in FIG. 20) specifies a set of already reconstructed samples, which are used to derive the intra mode. The template size is denoted as the number of samples within the template that extends to the above and the left of the target block, i.e., L. In the current implementation, a template size of 2 (i.e., L=2) is used for 4×4 and 8×8 blocks and a template size of 4 (i.e., L=4) is used for 16×16 and larger blocks. The reference of template (indicated by the dotted region in FIG. 20) refers to a set of neighbouring samples from above and left of the template, as defined by JEM-2.0. Unlike the template samples which are always from reconstructed region, the reference samples of template may not be reconstructed yet when encoding/decoding the target block. In this case, the existing reference samples substitution algorithm of JEM-2.0 is utilized to substitute the unavailable reference samples with the available reference samples.

For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target block.

### 2.16.2. DIMD for Intra 2N×2N CUs

For intra 2N×2N CUs, the DIMD is used as one additional intra mode, which is adaptively selected by comparing the DIMD intra mode with the optimal normal intra mode (i.e., being explicitly signalled). One flag is signalled for each intra 2N×2N CU to indicate the usage of the DIMD. If the flag is one, then the CU is predicted using the intra mode derived by DIMD; otherwise, the DIMD is not applied and the CU is predicted using the intra mode explicitly signalled in the bit-stream. When the DIMD is enabled, chroma components always reuse the same intra mode as that derived for luma component, i.e., DM mode.

Additionally, for each DIMD-coded CU, the blocks in the CU can adaptively select to derive their intra modes at either PU-level or TU-level. Specifically, when the DIMD flag is one, another CU-level DIMD control flag is signalled to indicate the level at which the DIMD is performed. If this flag is zero, it means that the DIMD is performed at the PU level and all the TUs in the PU use the same derived intra mode for their intra prediction; otherwise (i.e., the DIMD control flag is one), it means that the DIMD is performed at the TU level and each TU in the PU derives its own intra mode.

Further, when the DIMD is enabled, the number of angular directions increases to 129, and the DC and planar modes still remain the same. To accommodate the increased granularity of angular intra modes, the precision of intra interpolation filtering for DIMD-coded CUs increases from 1/32-pel to 1/64-pel. Additionally, in order to use the derived intra mode of a DIMD coded CU as MPM candidate for neighbouring intra blocks, those 129 directions of the DIMD-coded CUs are converted to “normal” intra modes (i.e., 65 angular intra directions) before they are used as MPM.

### 2.16.3. DIMD for Intra N×N CUs

In the proposed method, intra modes of intra N×N CUs are always signalled. However, to improve the efficiency of intra mode coding, the intra modes derived from DIMD are used as MPM candidates for predicting the intra modes of four PUs in the CU. In order to not increase the overhead of MPM index signalling, the DIMD candidate is always placed at the first place in the MPM list and the last existing MPM candidate is removed. Also, pruning operation is performed such that the DIMD candidate will not be added to the MPM list if it is redundant.

### 2.16.4. Intra Mode Search Algorithm of DIMD

In order to reduce encoding/decoding complexity, one straightforward fast intra mode search algorithm is used for DIMD. Firstly, one initial estimation process is performed to provide a good starting point for intra mode search. Specifically, an initial candidate list is created by selecting N fixed modes from the allowed intra modes. Then, the SAD is calculated for all the candidate intra modes and the one that minimizes the SAD is selected as the starting intra mode. To achieve a good complexity/performance trade-off, the initial candidate list consists of 11 intra modes, including DC, planar and every 4-th mode of the 33 angular intra directions as defined in HEVC, i.e., intra modes 0, 1, 2, 6, 10 . . . 30, 34.

If the starting intra mode is either DC or planar, it is used as the DIMD mode. Otherwise, based on the starting intra mode, one refinement process is then applied where the optimal intra mode is identified through one iterative search. It works by comparing at each iteration the SAD values for three intra modes separated by a given search interval and maintain the intra mode that minimize the SAD. The search interval is then reduced to half, and the selected intra mode from the last iteration will serve as the center intra mode for the current iteration. For the current DIMD implementation with 129 angular intra directions, up to 4 iterations are used in the refinement process to find the optimal DIMD intra mode.

### 2.17. Decoder-Side Intra Mode Derivation by Calculating the Gradients of Neighbouring Samples

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e., throughput of 4×4 blocks). The following sections describe the modifications for each aspect.

### 2.17.1. Signalling

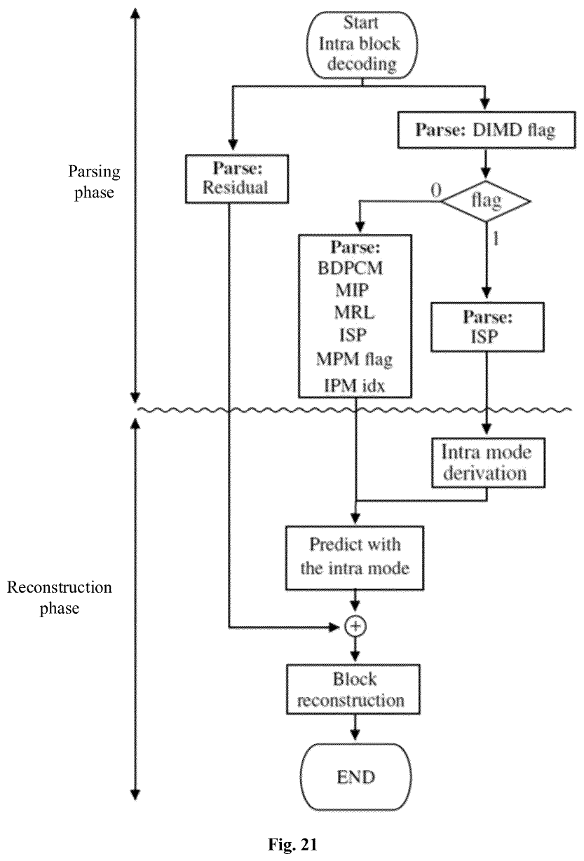

FIG. 21 shows the order of parsing flags/indices in VTM5, integrated with the proposed DIMD.

As can be seen, the DIMD flag of the block is parsed first using a single CABAC context, which is initialized to the default value of 154.

If flag==0, then the parsing continues normally.

Else (if flag==1), only the ISP index is parsed and the following flags/indices are inferred to be zero: BDPCM flag, MIP flag, MRL index. In this case, the entire IPM parsing is also skipped.

During the parsing phase, when a regular non-DIMD block inquires the IPM of its DIMD neighbor, the mode PLANAR_IDX is used as the virtual IPM of the DIMD block.

### 2.17.2. Texture Analysis

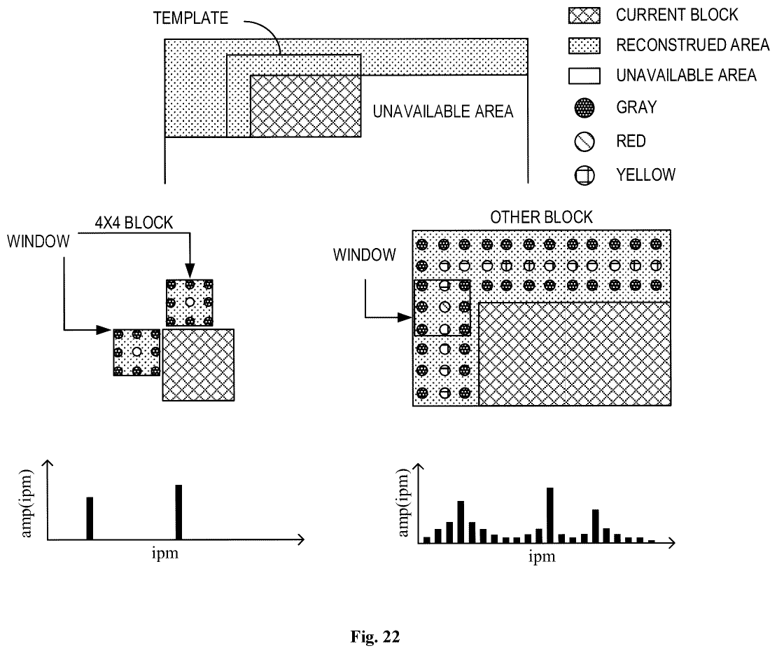

The texture analysis of DIMD includes a Histogram of Gradient (HoG) computation (FIG. 22). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block.

In previous versions, all pixels in the middle line of the template were involved in the HoG computation [1]. However, the current version improves the throughput of this process by applying the Sobel filter more sparsely on 4×4 blocks. To this aim, only one pixel from left and one pixel from above are used. This is shown in FIG. 22.

In addition to reduction in the number of operations for gradient computation, this property also simplifies the selection of best 2 modes from the HoG, as the resulting HoG cannot have more than two non-zero amplitudes.

### 2.17.3. Prediction Fusion

The current method uses a fusion of three predictors for each block. However, the choice of prediction modes is different and makes use of the combined hypothesis intra-prediction method proposed in [2], where the Planar mode is considered to be used in combination with other modes when computing an intra-predicted candidate. In the current version, the two IPMs corresponding to two tallest HoG bars are combined with the Planar mode.

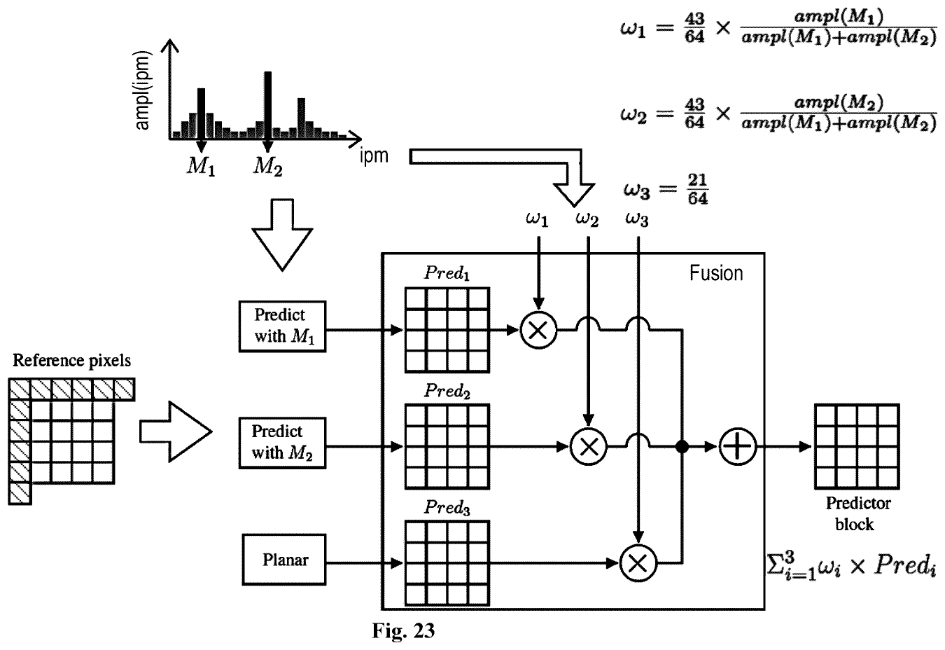

The prediction fusion is applied as a weighted average of the above three predictors. To this aim, the weight of planar is fixed to 21/64 (˜1/3). The remaining weight of 43/64 (˜2/3) is then shared between the two HoG IPMs, proportionally to the amplitude of their HoG bars. FIG. 23 visualises this process.

### 2.18. Template-Based Intra Mode Derivation (TIMD)

This contribution proposes a template-based intra mode derivation (TIMD) method using MPMs, in which a TIMD mode is derived from MPMs using the neighbouring template. The TIMD mode is used as an additional intra prediction method for a CU.

### 2.18.1. TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

### 2.18.2. TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.

### 2.18.3. Interaction with New Coding Tools

A DIMD method with prediction fusion using Planar was integrated in EE2. When EE2 DIMD flag is equal to true, the proposed TIMD flag is not signalled and set equal to false.

Similar to PDPC, Gradient PDPC is also included in the derivation of the TIMD mode.

When secondary MPM is enabled, both the primary MPMs and the secondary MPMs are used to derive the TIMD mode.

6-tap interpolation filter is not used in the derivation of the TIMD mode.

### 2.18.4. Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of the TIMD mode.

### 2.18.5. TIMD with Fusion

Instead of selecting the only one mode with the smallest SATD cost, this contribution proposes to choose the first two modes with the smallest SATD costs for the intra modes derived using TIMD method and then fuse them with the weights, and such weighted intra prediction is used to code the current CU.

The costs of the two selected modes are compared with a threshold, in the test the cost factor of 2 is applied as follows:

$$costMode 2 < {2}^{′} costMode 1.$$

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1.$$

### 2.19. Convolutional Cross-Component Model (CCCM) for Intra Prediction

It is proposed to apply convolutional cross-component model (CCCM) to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.19.1. Convolutional Filter

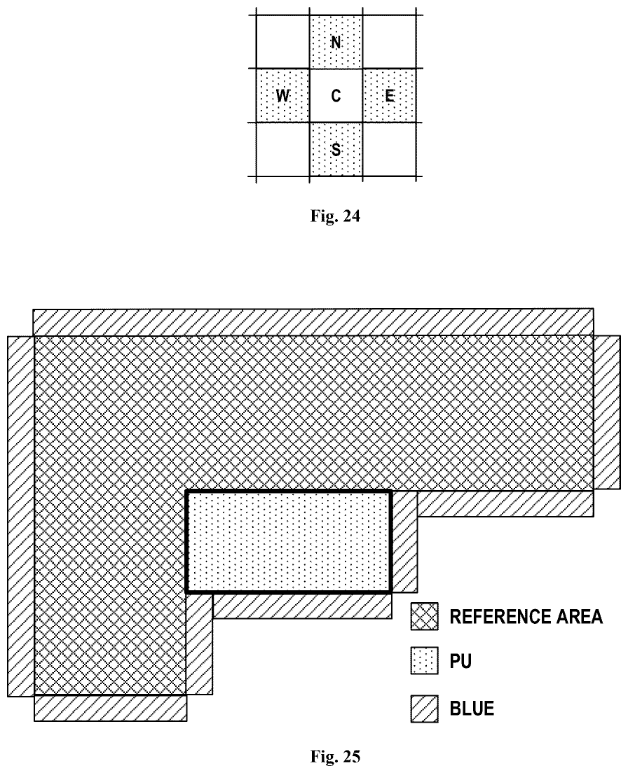

The proposed convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated below in FIG. 24.

The nonlinear term P is represented as power of two of the center luma sample C and scaled to the sample value range of the content:

$$P = ( C * C + midVal ) >> bitDepth .$$

That is, for 10-bit content it is calculated as:

$$P = ( C * C + 5 \; 12 ) >> 10.$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### 2.19.2. Calculation of Filter Coefficients (Training Process)

In a training process, the filter coefficients cᵢ are calculated by minimising MSE between predicted and reconstructed chroma samples in the reference area. FIG. 25 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations. The proposed approach uses only integer arithmetic.

### 2.19.3. Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA_IDX (to enable single mode CCCM) or MMLM_CHROMA_IDX (to enable multi-model CCCM).

### 2.20. Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

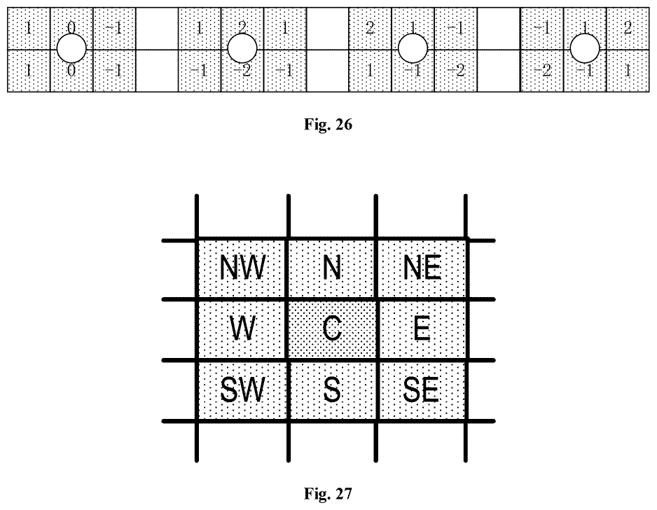

For signaling, when the CCLM mode is enabled to the current CU, two flags are signaled separately for Cb and Cr components to indicate whether GLM is enabled to each component; if the GLM is enabled for one component, one syntax element is further signaled to select one of 4 gradient filters for the gradient calculation.
Four gradient filters are enabled for the GLM, as illustrated in FIG. 26.
   GLM with Luma

In ECM-6.0 [1], GLM utilizes the gradient of luma samples to predict a chroma sample as:

$$p r e {d}_{C} ( i , j ) = α \cdot G ( i , j ) + β$$

where pred_{c}(i, j) represents the predicted value of a chroma sample, G(i, j) represents the gradient of the corresponding reconstructed luma samples, and the linear model parameters α and β are derived by adjacent reconstructed samples based on the linear minimum mean square error (LMMSE) method as CCLM.

A new GLM mode is proposed that a chroma sample is predicted based on both the gradient G(i,j) of luma samples and the reconstructed value

$${rec}_{L}^{′} ( i , j )$$

of the down-sampled luma sample with different parameters:

$$p r e {d}_{C} ( i , j ) = {α}_{0} \cdot G ( i , j ) + {α}_{1} \cdot {rec}_{L}^{′} ( i , j ) + {α}_{2} \cdot midValue$$

where the model parameters α₀, α₁ and α₂ are derived from six rows and columns adjacent samples based on the LDL decomposition method as the CCCM mode in ECM-6.0.

### 2.21. Gradient and Location Based Convolutional Cross-Component Model (GL-CCCM) for Intra Prediction

The proposed GL-CCCM method uses gradient and location information instead of the 4 spatial neighbor samples in the CCCM filter. The GL-CCCM filter for the prediction is:

$$predChromaVal = {c}_{0} C + {c}_{1} {G}_{y} + {c}_{2} {G}_{x} + {c}_{3} Y + {c}_{4} X + {c}_{5} P + {c}_{6} B .$$

Where G_{y} and Gₓ are the vertical and horizontal gradients, respectively, and are calculated as:

$${G}_{y} = ( 2 N + N W + N E ) - ( 2 S + S W + SE )$$

$${G}_{x} = ( 2 W + N W + S W ) - ( 2 E + N E + S E ) .$$

Moreover, the Y and X parameters are the vertical and horizontal locations of the center luma sample and they are calculated with respect to the top-left coordinates of the block.

The rest of the parameters are the same as CCCM tool. The reference area for the parameter calculation is the same as CCCM method. FIG. 27 shows spatial samples used for GL-CCCM.

### Bitstream Signalling

Usage of the mode is signalled with a CABAC coded PU level flag. One new CABAC context was included to support this. When it comes to signalling, GL-CCCM is considered a sub-mode of CCCM. That is, the GL-CCCM flag is only signalled if original CCCM flag is true.

### Encoder Operation

The encoder performs two new RD checks in the chroma prediction mode loop, one for checking single model GL-CCCM mode and one for checking multi-model GL-CCCM mode. FIG. 27 illustrates spatial samples used for GL-CCCM.

### 2.22. CCCM Using Non-Downsampled Luma Samples

### 2.22.1. Block Level

In this contribution, the CCCM using non-downsampled luma samples is proposed where the chroma samples are directly predicted from the original reconstructed luma samples, i.e., without downsampling. As shown in FIG. 28, the proposed CCCM filter consists of 6-tap spatial terms, two nonlinear terms and a bias term. The 6-tap spatial terms correspond to 6 neighboring luma samples (i.e., L₀, L₁, . . . , L₅) to the chroma sample (i.e., C) to be predicted.

$$C = {\sum }_{i = 0}^{5} {α}_{i} \cdot {L}_{i} + {\sum }_{i = 6}^{7} {α}_{i} \cdot ( ( {( {L}_{i - 4} )}^{2} + β ) ≫ bitDepth ) + {α}_{8} \cdot β$$

where α₁ is the coefficient associated with Lᵢ and β is the offset. Same to the existing CCCM design, up to 6 lines/columns of chroma samples above and left to the current CU are applied to derive the filter coefficients. The filter coefficients are derived based on the same LDL decomposition method used in CCCM. In the contribution, the proposed method is signaled as one extra CCCM model besides the existing CCCM model. For signaling, when the CCCM is selected, one single flag is signaled and used for both two chroma components to indicate whether the default CCCM model or the proposed CCCM model is applied.

### 2.22.2. High Level Control

Subsampling of luma component may not be optimal for CCCM model derivation for the content which has sharp details, such as SCC content. In this contribution it is proposed to disable luma subsampling, derive and apply model on nonsubsampled luma samples directly. CCCM model shape is diamond 5×5 if subsampling is not applied. SPS flag is signalled to indicate whether luma subsampling is applied for CCCM.

### 2.23. Spatial GPM (SGPM)

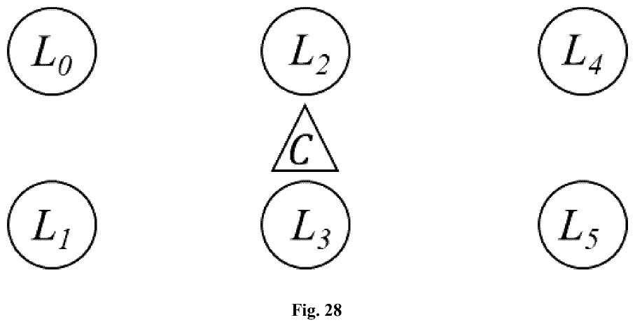

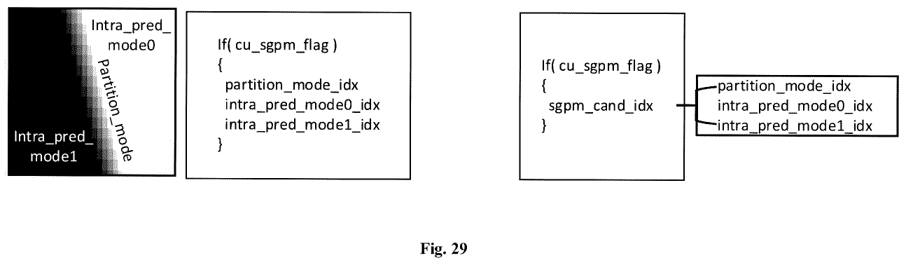

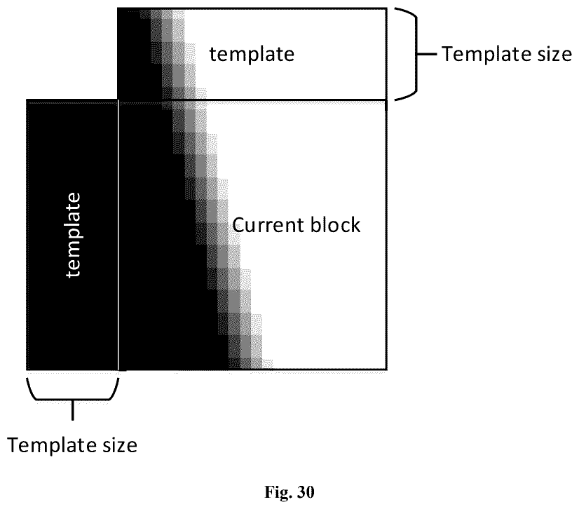

In spatial GPM, a candidate list is built which includes partition split and two intra prediction modes. Up to 11 MPMs of intra prediction modes are used to form the combinations, the length of the candidate list is set equal to 16. The selected candidate index is signalled. FIG. 29 shows spatial GPM candidates. FIG. 30 illustrates GPM template.

The list is reordered using template shown in the above figure. GPM blending process is not used in the template, and SAD between the prediction and reconstruction of the template is used for ordering. FIG. 30 shows GPM template.

The SGPM mode is applied to blocks whose width and height meet the same restrictions as in inter GPM.

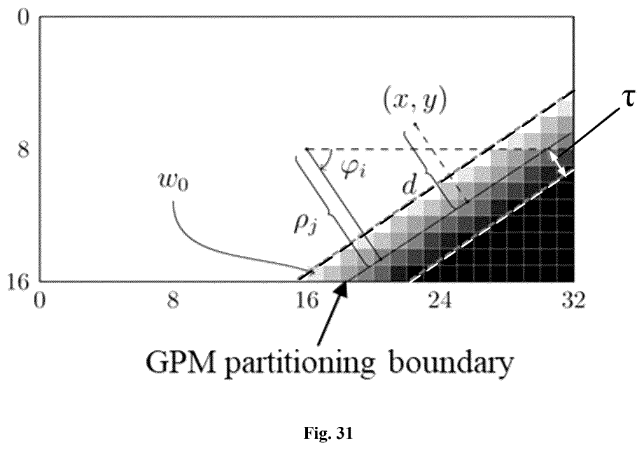

The following items are considered:
Spatial GPM partition modes:
   26 predefined modes;
   Adaptive derivation algorithm based on the horizontal and vertical gradients ratio.
Intra prediction mode selection:
   IPM list with and without TIMD:
      For each partition mode, an IPM list is derived for each part using intra-inter GPM list derivation. The IPM list size is 3. In the list, TIMD derived mode is replaced by 2 derived modes with horizontal and vertical orientations (using top or left templates) or TIMD derived mode is excluded.
   MPM list:
      A uniform MPM list, up to 11 elements, is used for all partition modes.
Template size (left and above): 1 or 4.
Extended block size:
   Spatial GPM is extended to be further applied to 4×8, 8×4, 4×16 and 16×4 blocks, which can be described as 4<=width<=64, 4<=height<=64, width<height*8, height<width*8, width*height>=32.
Adaptive blending:
   Adaptive blending is tested for spatial GPM, where blending depth τ is derived as follows:
      If min(width, height)==4, 1/2 τ is selected,
      else if min(width, height)==8, τ is selected,
      else if min(width, height)==16, 2 τ is selected,
      else if min(width, height)==32, 4 τ is selected,
      else, 8 τ is selected.
         FIG. 31 shows GPM blending.

### 2.24. Signaling of Cross-Component Prediction Modes in ECM

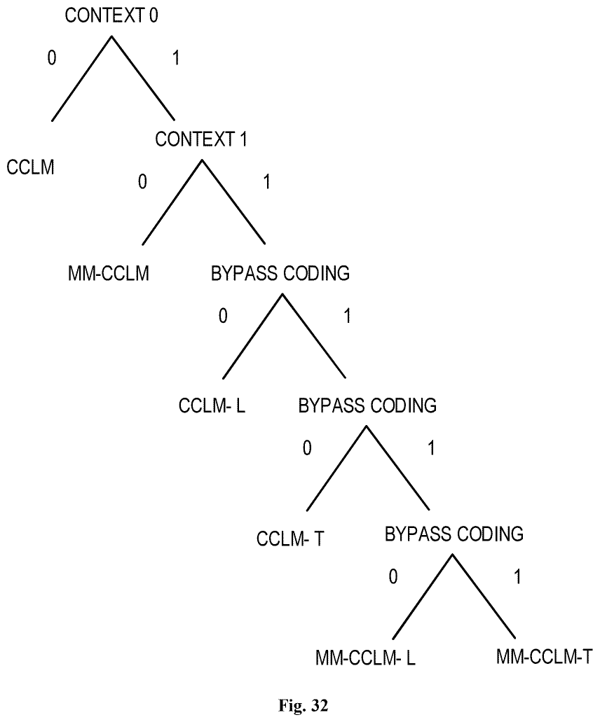

FIG. 32 illustrates binarization of cross-component prediction modes in ECM. “CCLM” in FIG. 32 may be replaced by “CCCM”. In ECM-7, cross-components modes include CCLM, CCLM-L, CCLM-T, MM-CCLM, MM-CCLM-L, MM-CCLM-T, and CCCM, CCCM-L, CCCM-T, MM-CCCM, MM-CCCM-L, MM-CCCM-T. One flag is signaled to determine whether it is a kind of CCCM mode or a kind of CCLM mode. A truncated unary code is applied to indicate the CCLM mode or CCCM mode shown in FIG. 32.
CCLM or CCCM: 0;
MM-CCLM or MM-CCCM: 10;
CCLM-L or CCCM-L: 110;
CCLM-T or CCCM-T: 1110;
MM-CCLM-L or MM-CCCM-L: 11110;
MM-CCLM-T or MM-CCCM-T: 11110.

### 2.25. Slope Adjustment for CCLM

CCLM uses a model with 2 parameters to map luma values to chroma values. The slope parameter “a” and the bias parameter “b” define the mapping as follows:

$$chromaVal = a * lumaVal + b .$$

It is proposed signal an adjustment “u” to the slope parameter to update the model to the following form:

$$chromaVal = {a}^{′} * lumaVal + {b}^{′}$$

$$where$$

$${a}^{′} = a + u$$

$${b}^{′} = b - u * {y}_{r .}$$

With this selection the mapping function is tilted or rotated around the point with luminance value yᵣ. It is proposed to use the average of the reference luma samples used in the model creation as yᵣ in order to provide a meaningful modification to the model. Picture below illustrates the process.

### 2.26. Fusion of Chroma Intra Prediction Modes

In the Test 1.2b, it is proposed that the DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signaled to indicate whether the fusion is applied. And the proposed fusion is only applied to I slices.

### 2.27. History-Based Cross-Component Prediction (H-CCP)

1. It is proposed that the model(s) of cross-component prediction (CCP), such as CCLM or CCCM, in a block may be stored into a history table (HT).
   a. A HT is a list with ordered entries.
      i. Each entry has an index. For example, the index of the first entry is 0, and indices of following entries are 1, 2, 3, . . . .
   b. Model parameters of CCLM and its variants may comprise a, b and a shift which controls the calculation precision.
   c. Model parameters of CCLM and its variants may comprise linear parts such as c0˜c4 and nonlinear part such as c5.
   d. Models may include models for different color components such as Cb and Cr.
      i. For example, models for Cb and Cr may be coupled in a entry.
   e. In one example, different CCPs like CCLM and CCCM may share the same HT.
      i. In one example, a segment in an entry of the HT may reflect the type of CCP model(s) stored in the entry.
   f. In one example, different CCPs like CCLM and CCCM may have different HTs.
      i. In one example, one CCLM_HT may store models of CCLM and its variants like CCLM-L or CCLM-T.
      ii. In one example, one CCCM_HT may store models of CCCM and its variants like CCCM-T or CCCM-T.
   g. In one example, CCP with a single model (like CCLM or CCCM) and CCP with multiple models (like MM-CCLM or MM-CCCM) may have different HTs.
   h. In one example, CCP with a single model (like CCLM or CCCM) and CCP with multiple models (like MM-CCLM or MM-CCCM) may share the same HT.
      i. In one example, a segment in an entry of the HT may reflect the number of models stored in the entry.
      ii. In one example, a segment in an entry of the HT may reflect at least one threshold used to classify samples into different groups of models.
   i. In one example, a first HT is used to store models of CCLM and its variants.
      i. In one example, CCLM variants may comprise CCLM-L, CCLM-T, MM-CCLM, MM-CCLM-L, MM-CCLM-T, GLM and CCLM with slope adjustments.
         1) A segment in an entry of the HT may reflect the number of models stored in the entry.
         2) A segment in an entry of the HT may reflect at least one threshold used to classify samples into different groups of models.
         3) A segment in an entry of the HT may reflect whether GLM is applied.
         4) A segment in an entry of the HT may reflect the down-sampling filter of GLM.
   j. In one example, a second HT is used to store models of CCCM and its variants.
      i. In one example, CCCM variants may comprise CCCM-L, CCCM-T, MM-CCCM, MM-CCCM-L, MM-CCCM-T.
         1) A segment in an entry of the HT may reflect the number of models stored in the entry.
         2) A segment in an entry of the HT may reflect at least one threshold used to classify samples into different groups of models.
2. It is proposed that a block can be coded with history-based CCP (H-CCP) mode, in which mode at least one CCP model used by the current block is fetched or derived from a HT.
   a. In one example, at least one syntax element (SE) may be signaled to indicate whether H-CCP is applied.
      i. In one example, the SE may be signaled conditionally. E.g. the SE is signaled only if a specific mode is used, such as CCCM or CCLM.
         1) For example, the SE is signaled only if the current mode is CCCM or CCLM.
   b. In one example, at least one syntax element (SE) may be signaled to indicate which entry in a HT is fetched to derive the model(s) of cross-component prediction.
      i. The SE may reflect an index in the HT.
         1) In one example, the SE may be set equal to f(k) where k is an index and f is a function.
         2) In one example, the SE may be set equal to f(k, M) where k is an index, M is the number of valid entries in the HT and f is a function.
         a) In another example, M is the size of HT.
         3) In one example, the SE may be set equal to k where k is an index.
         4) In one example, the SE may be set equal to M−1−k where k is an index and M is the number of valid entries in the HT.
         a) In another example, M is the size of HT.
      ii. The SE may reflect an index of a list and the list may be constructed based on the HT.
         1) In one example, the list L is constructed by reversing the HT. For example, L[i]=HT[M−1−i], wherein M is the number of valid entries in the HT.
         a) In another example, M is the size of HT.
         b) In one example, L may have a fixed size.
         c) In one example, if L is not full, the vacant entries are filled with default entries.
      iii. In one example, the SE may be signaled conditionally. E.g. the SE is signaled only if H-CCP is applicable.
      iv. The SE may be signaled only if more than one entry in the HT can be selected.
      v. The maximum value (denoted as V) of the SE is determined by the number of entries to be selected.
         1) For example, V=K, or V=K−1, or V=K+1, or V=K−2, or V=K+2.
   c. In one example, at least one syntax element (SE) may be signaled to indicate which HT is used.
      i. In one example, the SE may be signaled conditionally. E.g. the SE is signaled only if H-CCP is applicable.
      ii. The SE may be signaled only if more than one HTs can be selected.
   d. In one example, it may be derived at encoder/decoder which HT is used.
      i. In one example, if the current mode is CCLM, a first HT storing models of CCLM and its variants is used.
      ii. In one example, if the current mode is CCCM, a second HT storing models of CCCM and its variants is used.
   e. In one example, the current block may be predicted with the CCP model fetched from the determined entry of the determined HT.
   f. In one example, the current block may be predicted with either CCCM or CCLM based on whether the first HT or the second HT is applied.
   g. In one example, the current block may be predicted with multiple models.
      i. Whether single model or multiple models are applied may be derived/fetched from the determined entry of the determined HT.
      ii. At least one threshold used to classify samples into different groups of models may be fetched/derived from the determined entry of the determined HT.

### Maintenance of the HT

3. The maximum size of a HT may be predetermined, such as to be 5 or 6.
   a. Alternatively, the maximum size of a HT may be signaled as a SE at block level/sequence level/group of pictures level/picture level/slice level/tile group level, such as in coding structures of CTU/CU/TU/PU/CTB/CB/TB/PB, or sequence header/picture header/SPSNPS/DPS/DCI/PPS/APS/slice header/tile group header.
   b. Alternatively, the maximum size of a HT may be derived using coding/decoding information such as
      i. The mode of the current block;
      ii. The mode of a neighbouring block;
      iii. The mode of a luma block in the collocated region of the current block;
      iv. The mode of a luma block in the collocated region of a neighbouring block;
      v. QP;
      vi. Slice/picture type;
      vii. Picture width/height;
      viii. Block width/height;
      ix. Reconstructed samples.
4. A HT may be refreshed at the beginning of encoding/decoding a sequence/picture/slice/tile/sub-picture/CTU row/CTU.
   a. For example, a HT may be refreshed by emptying the table.
   b. For example, a HT may be refreshed by fulfilling the table with default entries.
5. After encoding/decoding a block (such as a CU), a HT may be updated.
   a. For example, the CU must be a chroma CU when dual-tree coding is applied.
   b. For example, the CU must be a CU with CCP modes.
   c. For example, which HT to be updated may depend on the coding mode of the CU.
      i. For example, if the CU is coded with a CCLM mode (such as CCLM, CCLM-L, CCLM-T, MM-CCLM, MM-CCLM-L, MM-CCLM-T, GLM and CCLM with slope adjustments), the model(s) and related information (such as threshold(s) used to classify samples into different groups of models) are stored in the first HT.
      ii. For example, if the CU is coded with a CCCM mode (such as CCCM, CCCM-L, CCCM-T, MM-CCCM, MM-CCCM-L, MM-CCCM-T), the model(s) and related information (such as threshold(s) used to classify samples into different groups of models) are stored in the first HT.
   d. For example, a set of information related to the CCP model(s) used by the current block may be put into the HT.
      i. The set may comprise one or multiple CCP models.
      ii. The set may comprise the number of models.
      iii. The set may comprise threshold(s) used to classify samples into different groups of models).
      iv. The set may comprise slope adjustments.
   e. In one example, the CCP model may be adjusted before being used to update the HT, if the current block is coded with CCLM with slope adjustments.
6. How to put a new set of information related to the CCP model(s) into a HT may depend on whether the HT is full.
   a. For example, if the HT is not full, the new set may be put to the first vacant entry of the HT.
      i. For example, the first vacant entry is the vacant entry with the smallest index.
      ii. For example, the first vacant entry is the vacant entry with the largest index.
      iii. After being put into the HT, the new set may be put as the last occupied entry in the HT.
         1) The last occupied entry may be the occupied entry with the largest index.
         2) The last occupied entry may be the occupied entry with the smallest index.
   b. For example, if the HT is full, one existing entry in the HT may be removed.
      i. In one example, the HT may be managed in a First In First Out way.
      ii. The existing entry with the smallest index may be removed.
         1) The updated HT′ may be set as: HT′[i]=HT[i+1], for 0<=i<=N−2, and HT′[N−1]=new set, wherein N is the size of HT.
      iii. The existing entry with the largest index may be removed.
         1) The updated HT′ may be set as: HT′[i]=HT[i−1], for 1<=i<=N−1, and HT′[0]=new set, wherein N is the size of HT.
7. In one example, the new set may be compared with at least one of the existing entries in the HT to determine whether to put into the new set and/or how to update the HT.
8. In one example, if the new set is the same or similar to one of the existing entries in the HT, the new set is not put into the HT. Suppose the new set is the same or similar to a special entry of HT.
   a. For example, in such a case, the special entry may be put to the first of the HT, and the entries originally before the special entry are pushed one position backward.
      i. For example, suppose entries are HT[i] with i=0, 1 . . . , and the special entry is HT[k], then the updated HT′ will be as: HT′[0]=HT[k]; HT′[i]=HT[i−1] for 1<=i<=k; HT′[i]=HT[i] for i>k.
   b. For example, in such a case, the special entry may be put to the end of the HT, and the entries originally before the special entry are pushed one position forward.
      i. For example, suppose entries are HT[i] with i=0, 1 . . . , and the special entry is HT[k], then the updated HT′ will be as: HT′[N−1]=HT[k]; HT′[i]=HT[i+1] for k<=i<=N−2; HT′[i]=HT[i] for i<k.
9. In one example, whether to put into the new set and/or how to update the HT may depend on the coding information of the CU with the new set.
10. In one example, if the new set is of a CU coded with H-CCP mode, the new set is not put into the HT. Suppose a special entry in HT is used by the CU coded with H-CCP.
   a. For example, in such a case, the special entry may be put to the first of the HT, and the entries originally before the special entry are pushed one position backward.
      i. For example, suppose entries are HT[i] with i=0, 1 . . . , and the special entry is HT[k], then the updated HT′ will be as: HT′[0]=HT[k]; HT′[i]=HT[i−1] for 1<=i<=k; HT′[i]=HT[i] for i>k.
   b. For example, in such a case, the special entry may be put to the end of the HT, and the entries originally before the special entry are pushed one position forward.
      i. For example, suppose entries are HT[i] with i=0, 1 . . . , and the special entry is HT[k], then the updated HT′ will be as: HT′[N−1]=HT[k]; HT′[i]=HT[i+1] for k<=i<=N−2; HT′[i]=HT[i] for i<k.
11. It is proposed that an entry of HT may include models for more than one chroma components, such as Cb and Cr.
   a. If an entry is selected, then the models for component Cb and Cr are applied on the two components respectively.
12. It is proposed that an entry of HT may include models for only one component, such as Cb or Cr.
   a. If an entry is selected, then the model for the specific component such as Cb or Cr is applied on the specific component.
   b. In one example, different HT may be built for different components.

### List Mode

13. It is proposed that at least one list with CCP models may be constructed.
   a. In one example, a chroma block may be predicted with a CCP model in the list, with a “list mode”.
   b. In one example, the list L may be filled with one type of CCP models, such as CCCM.
   c. In one example, the list may be filled with multiple types of CCP models, such as both CCCM and CCLM.
      i. In one example, the type of the CCP model will be stored in the list together with the CCP model.
   d. In one example, at least one syntax element (SE) may be signaled to indicate whether a CCP model in the list is used.
      i. In one example, the SE may be signaled conditionally. E.g. the SE is signaled only if a specific mode is used, such as CCCM or CCLM.
         1) For example, the SE is signaled only if the current mode is CCCM or CCLM.
         2) For example, the SE is signaled only if the “list mode” is applicable.
   e. In one example, at least one syntax element (SE) may be signaled to indicate which entry in the list is used to derive the model(s) of cross-component prediction.
      i. The SE may reflect an index in the list.
         1) In one example, the SE may be set equal to f(k) where k is an index and f is a function.
         2) In one example, the SE may be set equal to f(k, M) where k is an index, M is the number of valid entries in the list and f is a function.
         a) In another example, M is the size of list.
         3) In one example, the SE may be set equal to k where k is an index.
         4) In one example, the SE may be set equal to M−1−k where k is an index and M is the number of valid entries in the list.
         a) In another example, M is the size of list.
   f. In one example, L may have a fixed size.
   g. In one example, multiple lists may be constructed.
      i. For example, at least one syntax element (SE) may be signaled to indicate which list is used.
      ii. In one example, the SE may be signaled conditionally. E.g. the SE is signaled only if “list mode” is applicable.
      iii. The SE may be signaled only if more than one list can be selected.
   h. In one example, it may be derived at encoder/decoder which list is used.
      i. In one example, if the current mode is CCLM, a first list storing models of CCLM and its variants is used.
      ii. In one example, if the current mode is CCCM, a second list storing models of CCCM and its variants is used.
14. It is proposed that an entry of list may include models for more than one chroma components, such as Cb and Cr.
   a. If an entry is selected, then the models for component Cb and Cr are applied on the two components respectively.
15. It is proposed that an entry of list may include models for only one component, such as Cb or Cr.
   a. If an entry is selected, then the model for the specific component such as Cb or Cr is applied on the specific component.
16. Multiple candidates may be put into the list, including.
   a. A CCP model of an adjacent neighbouring block.
   b. A CCP model of a non-adjacent neighbouring block.
   c. A CCP model of a collocated block in a reference picture.
   d. A CCP model of a reference block in a reference picture.
   e. A CCP model in a history table.
   f. A CCP model derived from non-adjacent samples.
   g. A default CCP mode.
17. In one example, a list may be constructed by checking possible candidates in an order.
   a. For example, the order may be adjacent neighbouring blocks, non-adjacent neighbouring blocks, models in a history table, models derived from non-adjacent samples.
   b. For example, the list construction is finished if the number of candidates in the list achieves the maximum allowed size of the list (such as 5 or 6).
   c. For example, the list construction is finished if the number of candidates in the list achieves f(d), where d is the index of the selected candidate and f is a function. For example, f(d)=d+1.
   d. For example, default models may be put into the list if all possible candidates have been checked the the construction is not finished.
18. In one example, if a potential candidate is put into the list, it may be compared with at least one existing candidate in the list.
   a. For example, the potential candidate is not put into the list, if it is the same or similar to the existing candidate.
   b. In one example, if a potential entry of CCP information is put into the history-based table, it may be compared with at least one existing entries in the list.
      i. For example, the potential entry is not put into the list, if it is the same or similar to an existing entry.
   c. In one example, two CCP candidates or entries are determined NOT to be the same if
      i. The CCP types are different.
      ii. The numbers of models are different.
      iii. The thresholds are different if the CCP has multiple models.
      iv. At least one model is different.
      v. The luma sample offset is different. (maybe only applicable if the type is CCCM or GL-CCCM or GLM or CCCM with using non-downsampled luma samples.)
      vi. The sample location shifts are different. (maybe only applicable if the type is GL-CCCM).
19. For example, CCP information of an entry in the history-based table or of a candidate in a CCP candidate list may comprise:
   a. The type of the CCP method, such as CCLM or CCCM or GLM or GLM with luma or GL-CCCM or CCCM using non-downsampled luma samples.
      i. In one example, GLM method using different down-sampling filters may be considered as different types.
      ii. In one example, GLM with luma method using different down-sampling filters may be considered as different types.
      iii. In one example, the types may be CCCM, CCLM, 4 types of GLM using different down-sampling filters, 4 types of GLM with luma using different down-sampling filters, GL-CCCM and CCCM using non-downsampled luma samples.
      iv. “Not coded with CCP” (denoted as NonCCP) may also be treated as a type.
   b. The position (x, y).
   c. The number of models.
      i. For example, the number of models may be 1 or 2.
      ii. In one example, the number of models may be considered as a part of the CCP type. For example, CCLM and MM-CCLM may be considered as two types.
   d. At least one threshold to classify samples for different models.
      i. The threshold may be used only if the number of models is at least 2.
   e. At least one luma sample value offset.
      i. The luma sample value offset may be added to or subtracted from a luma sample (which may be down sampled) when it is used to derive a chroma prediction value.
      ii. The luma sample value offset may be used only for specific types such as CCCM, GLM with luma, GL-CCCM and CCCM using non-down-sample luma samples.
   f. At least one chroma sample value offset.
      i. The chroma sample value offset may be added to or subtracted from a chroma prediction value derived by a CCP model to generate the final prediction.
   g. At least one models for at least one chroma component.
      i. For example, it may include different models for Cb and Cr components.
      ii. For example, the number of models for each component may be included as a part of the information.
      iii. The model may be represented by the model form of CCLM or CCCM or GLM or GLM with luma or GL-CCCM or CCCM using non-downsampled luma samples.
   h. At least one sample location shift denoted as (dX, dY).
      i. The chroma sample location shift may be added to or subtracted from the sample location (x, y) when it is used to derive the chroma prediction value.
      ii. The chroma sample location shift may be used only for specific types such as GL-CCCM.
20. For example, the CCP coding information of a chroma block after being coded/decoded may be stored in the history-based table or in the CCP candidate list.
   a. In one example, the CCP coding information may be stored only if the chroma block is coded with a CCP mode.
      i. In one example, the CCP coding information may be stored if the chroma block is coded with at least one CCP mode, such as with the fusion of chroma intra prediction mode.
         1) The stored type may be set to be the CCP type used in the fusion of chroma intra prediction mode.
   b. In one example, the CCP coding information may be stored for any chroma block.
      i. If the chroma block is not coded with a CCP mode, the type is stored as “NonCCP”.
   c. If the chroma block is coded with a CCP mode, the type of information may be stored as depending on the coding mode.
      i. The type is set to be “CCCM” if the mode is CCCM, or CCCM-T, or CCCM-L, or MM-CCCM, or MM-CCCM-T, or MM-CCCM-L.
      ii. The type is set to be “CCLM” if the mode is CCLM, or CCLM-T, or CCLM-L, or MM-CCLM, or MM-CCLM-T, or MM-CCLM-L.
      iii. The type is set to be “CCLM” if the mode is CCLM, or CCLM-T, or CCLM-L, or MM-CCLM, or MM-CCLM-T, or MM-CCLM-L, with slope adjustments.
      iv. The type is set to be “GLM using filter X” if the mode is GLM using filter X.
      v. The type is set to be “GLM with luma using filter X” if the mode is GLM with luma using filter X.
      vi. The type is set to be “GL-CCCM” if the mode is GL-CCCM.
      vii. The type is set to be “CCCM using non-down-sample” if the mode is CCCM using non-down-sample.
      viii. The type is set to be “CCLM” if the mode is the fusion of chroma intra prediction mode.
   d. The number of models may be stored as the number of models of the chroma block.
      i. For example, the number of models is set to be 2 if the mode is MM-CCLM, or MM-CCLM-T, or MM-CCLM-L, or MM-CCLM, or MM-CCLM-T, or MM-CCLM-L or any other multi-model CCP modes (such as GLM or GL-CCCM or CCCM using non-downsampled luma samples with multi-models).
   e. Information such as the threshold, the luma/chroma sample value offset, sample location shift may be stored as the information used by the chroma block.
   f. The CCP model of one component may be stored as the model used by the chroma block.
      i. The model may be derived by any CCP method such as CCLM, or CCLM-T, or CCLM-L, or MM-CCLM, or MM-CCLM-T, or MM-CCLM-L or CCCM, or CCCM-T, or CCCM-L, or MM-CCCM, or MM-CCCM-T, or MM-CCCM-L or GLM using different down-sampling filters, or GLM with luma using different down-sampling filters, or GL-CCCM or CCCM using non-downsampled luma samples.
      ii. The stored model may be the final applied one, such as the one after been modified by the slope adjustment.
21. In one example, a history table of CCP information after coding/decoding a region (such as a CU/CTU/CTU line) may be stored, known as a stored table.
   a. The history table of CCP information maintained for the current block (known as an online table) may be used together with the stored history table of CCP information.
   b. In one example, entries in a stored table and in an on-line table may be checked in an order to generate new candidates.
      i. In one example, entries in the on-line table may be checked before all entries in the stored table.
      ii. In one example, entries in the stored table may be checked before all entries in the on-line table.
      iii. For example, k-th entry in the stored table may be checked after the k-th entry in the on-line table.
      iv. For example, k-th entry in the on-line table may be checked after the k-th entry in the stored table.
      v. For example, k-th entry in the on-line table may be checked after all the m-th entries, in the stored table, for m=0 . . . S where S is an integer.
      vi. For example, k-th entry in the stored table may be checked after all the m-th entries, in the on-line table, for m=0 . . . S where S is an integer.
      vii. For example, k-th entry in the on-line table may be checked after all the m-th entries, in the stored table, for m=S . . . maxT, where S is an integer and maxT is the last entry.
      viii. For example, k-th entry in the stored table may be checked after all the m-th entries, in the on-line table, for m=S . . . maxT, where S is an integer and maxT is the last entry.
   c. In one example, which stored table(s) to be used may depend on the dimension and/or location of the current block.
      i. For example, the table stored in the CTU above the current CTU may be used.
      ii. For example, the table stored in the CTU left-above to the current CTU may be used.
      iii. For example, the table stored in the CTU right-above to the current CTU may be used.
   d. In one example, whether to and/or how to use a stored table may depend on the dimension and/or location of the current block.
      i. In one example, whether to and/or how to use a stored table may depend on whether the current CU is at the top boundary of a CTU and the above neighbouring CTU is available.
         1) For example, a stored table may be used only if the current CU is at the top boundary of a CTU and the above neighbouring CTU is available.
         2) For example, at least one entry in a stored table may be put to a more forward position if the current CU is at the top boundary of a CTU and the above neighbouring CTU is available.
   e. In one example, entries in two stored tables may be checked in an order to generate new candidates.
      i. For example, a first (or a second) stored table may be stored in the CTU above the current CTU may be used.
      ii. For example, a first (or a second) stored table may be stored in the CTU left-above to the current CTU may be used.
      iii. For example, a first (or a second) stored table may be stored in the CTU right-above to the current CTU may be used.

### 2.28. Non-Adjacent Cross-Component Prediction (NA-CCP)

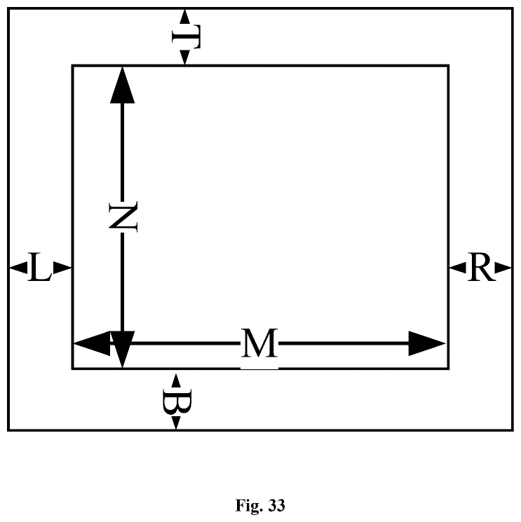

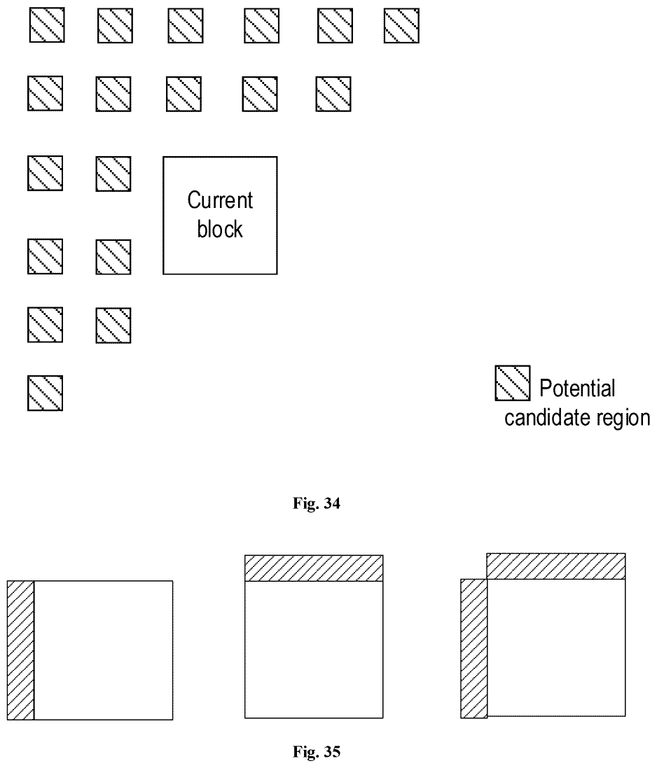

1. It is proposed that the model(s) of cross-component prediction, such as CCLM or CCCM, in a block may be derived based on a set of samples non-adjacent to the current block, known as non-adjacent cross-component prediction (NA-CCP).
   a. In one example, the set of samples are non-adjacent to the current block only if no sample in the set is adjacently neighbouring to the current block (such as adjacent above or adjacent left to the current block).
   b. In one example, the set of samples are reconstructed before coding/decoding the current block.
   c. The samples may comprise chroma samples and/or their corresponding luma samples, which may be generated by down-sampling if the color format is 4:2:0 or 4:2:2.
2. In one example, at least one syntax element (SE) may be signaled to indicate whether non-adjacent cross-component prediction is applied.
   a. In one example, the SE may be signaled conditionally. e.g. the SE is signaled only if a specific mode is used, such as CCCM or CCLM.
3. In one example, more than one sets of samples non-adjacent to the current block may be used to derive the model(s) of cross-component prediction.
   a. In one example, samples in more than one sets may be jointly used to derive the model(s) of cross-component prediction.
   b. In one example, one set of multiple candidate sets may be selected to derive the model(s) of cross-component prediction.
4. In one example, at least one syntax element (SE) may be signaled to indicate which set of non-adjacent samples is used to derive the model(s) of cross-component prediction.
   a. In one example, the SE may be signaled conditionally. E.g. the SE is signaled only if NA-CCP is applicable.
   b. The SE may be signaled only if more than one sets of non-adjacent samples can be selected.
   c. The maximum value (denoted as V) of the SE is determined by the number of sets of non-adjacent samples (denoted as K) to be selected.
      i. For example, V=K, or V=K−1, or V=K+1, or V=K−2, or V=K+2.
5. Whether to/how to apply NA-CCP may be the same for more than one color components, such as Cb and Cr.
   a. Alternatively, whether to/how to apply NA-CCP may be different for different components, such as Cb and Cr.
6. Whether NA-CCP is applicable may depend on the dimension/position of the current block.
7. In one example, a set of non-adjacent samples may comprise samples in a region.
   a. In one example, the region may be a coding block (e.g. a CU).
   b. In one example, the region may be represented by a position relative to the region.
   c. In one example, the region may be a M×N rectangle (e.g. M=N=8).
   d. In one example, the rectangular region may be represented by a position relative to the region (such as the top-left position (x, y) of the region) and dimensions M×N.
   e. In one example, the regions of different sets of non-adjacent samples may share the same shape and size.
   f. In one example, the regions of different sets of non-adjacent samples may have different shapes or sizes.
   g. A sample in the region must be reconstructed.
      i. Alternatively, if a sample in the region is not reconstructed, it should be padded.
8. In one example, luma samples corresponding to a set of non-adjacent chroma samples may be prepared or generated, to be used to train the cross-component model.
   a. In one example, down-sampling may be applied to generate the corresponding luma samples if the color format is 4:2:0 or 4:2:2.
   b. In one example, generated luma samples may correspond to a region larger than the region of non-adjacent chroma samples.
      i. In one example, suppose the region of non-adjacent chroma samples is a M×N rectangle, then the generated luma samples may correspond to a (M+T+B)×(N+L+R) chroma rectangle, as shown in FIG. 33. FIG. 33 illustrates an example of luma samples to be prepared.
         1) In one example, T=B=L=R=1.
   c. In one example, if a luma sample to be generated is not available (e.g., it is out of the picture boundary, or it is not reconstructed, or it is in a different CTU which has not been reconstructed, etc.), it may be specially treated.
      i. In one example, it may be padded, such as repetition padded with the nearby available generated luma value.
      ii. In one example, it may not be generated not marked as “unavailable”.
         1) The dimensions of the luma region may be set to be the available region.
9. In one example, whether a region comprising the non-adjacent samples is a valid set of samples to derive model(s) may be determined by the availability of at least one sample of the region.
   a. For example, the region is a rectangle.
   b. For example, the region is determined to be valid only if the top-left reconstructed sample and bottom-right reconstructed sample of the region are both available.
   c. For example, the region is determined to be valid only if the top-right reconstructed sample and bottom-left reconstructed sample of the region are both available.
10. In one example, a region list may be constructed to record the multiple sets of non-adjacent samples,
   a. In one example, an index of the list may be signaled as a SE to indicate which set of non-adjacent samples is used to derive the model(s) of cross-component prediction.
      i. For example, the SE may be binarized as a truncated unary code.
      ii. In one example, the SE may be signaled conditionally. E.g. the SE is signaled only if NA-CCP is applied.
      iii. The SE may be signaled only if more than one sets of non-adjacent samples can be selected.
      iv. The maximum value (denoted as V) of the SE is determined by the number of sets of non-adjacent samples (denoted as K) to be selected.
         1) For example, V=K, or V=K−1, or V=K+1, or V=K−2, or V=K+2.
   b. In one example, the list may be constructed by checking multiple potential candidate regions in an order.
      i. The list is initialized to be empty.
      ii. The list construction is finished if the number of candidate regions in the list is equal to the maximum size of the list, such as 6.
      iii. The list construction is finished if all the potential candidate regions have been checked.
      iv. A potential candidate may be put into the list if the region is determined to be valid.
      v. Pruning may be applied to construct the list.
         1) A potential candidate may not be put into the list if it is “duplicated” with an existing candidate in the list.
         a) A candidate region is “duplicated” with another region if their samples are the same. (or similar)
         b) A candidate region is “duplicated” with another region if the same or similar models may be derived from samples in those two regions.
11. In one example, the position and/or dimensions of the region comprising the non-adjacent samples may depend on coding information, such as width/height of the current block.
   a. The region may be a potential candidate region for the list.
   b. The distance between the region and the current block may depend on width/height of the current block.
12. In one example, potential candidate regions may be M×N rectangles (e.g. M=N=8) non-adjacently left to/left below to/left above/above/right above the current block. FIG. 34 shows an example. FIG. 34 illustrates an example of potential candidate regions.
13. In one example, a potential candidate region is a M×N (e.g. M=N=8) rectangle, and its top-left position (x0, y0) may be described as (suppose the top-left position of the current block with dimensions W×H is (0, 0)):
   a. (x0, y0)=(s*f(W, H), t*g(W, H)), wherein f and g are functions. s and t are scaling factors such as 0.5, 1 or 2.
   b. (x0, y0)=(s*f(W), t*g(H)), wherein f and g are functions. s and t are scaling factors such as 0.5, 1 or 2.
14. In one example, the potential candidate regions are M×N (e.g. M=N=8) rectangles, and their top-left positions in order are as below (suppose the top-left position of the current block with dimensions W×H is (0, 0)):
   (−xStep, 0),
   (0, −yStep),
   (xStep, −yStep),
   (−xStep, yStep),
   (−xStep, −yStep),

$$( - 2 * xStep , 0 ) ,$$

$$( 0 , - 2 * yStep ) ,$$

$$( - 2 * xStep , 2 * yStep ) ,$$

$$( 2 * xStep , - 2 * yStep ) ,$$

$$( - 2 * xStep , yStep ) ,$$

$$( xStep , - 2 * yStep ) ,$$

$$( - 2 * xStep , - yStep )$$

$$( - xStep , - 2 * yStep ) ,$$

$$( - 2 * xStep , - 2 * yStep ) ,$$

$$( - xStep / 2 , 0 ) ,$$

$$( 0 , - yStep / 2 ) ,$$

$$( xStep / 2 , - yStep / 2 )$$

$$( - xStep / 2 , yStep - 2 ) ,$$

$$( - xStep / 2 , - yStep / 2 ) ,$$

wherein xStep and yStep are integers.
a. The checking order may be changed.
b. In one example, xStep=Max(W, K1), yStep=Max(H, K2), wherein K1 and K2 are integers, e.g. K1=K2=16.
15. In one example, whether to and/or how to apply NA-CCP may be signaled from the encoder to the decoder.
   a. Alternatively, whether to and/or how to apply NA-CCP may be derived at encoder and decoder based on coded/decoded information without signaling.
   b. “How to apply NA-CCP” may comprise:
      i. Which CCP (such as CCLM or CCCM) model is derived by NA-CCP;
      ii. The shape/size/position of a (potential) candidate region;
      iii. The size of the region list;
      iv. The number of (potential) candidate regions;
      v. The color component to apply NA-CCP.
   c. “Coded/decoded information” may comprise:
      i. The mode of the current block;
      ii. The mode of a neighbouring block;
      iii. The mode of a luma block in the collocated region of the current block;
      iv. The mode of a luma block in the collocated region of a neighbouring block;
      v. QP;
      vi. Slice/picture type;
      vii. Picture width/height;
      viii. Block width/height;
      ix. Reconstructed samples.
16. In one example, the CCP coding information of a spatial or temporal neighbouring block may be used by the current block.
   a. For example, the spatial neighbouring block may be adjacent or non-adjacent to the current block.
   b. For example, the CCP coding information may comprise:
      i. The type of the CCP method, such as CCLM or CCCM or GLM or GLM with luma or GL-CCCM or CCCM using non-downsampled luma samples.
         1) In one example, GLM method using different down-sampling filters may be considered as different types.
         2) In one example, GLM with luma method using different down-sampling filters may be considered as different types.
         3) In one example, the types may be CCCM, CCLM, 4 types of GLM using different down-sampling filters, 4 types of GLM with luma using different down-sampling filters, GL-CCCM and CCCM using non-downsampled luma samples.
         4) “Not coded with CCP” (denoted as NonCCP) may also be treated as a type.
      ii. The position (x, y).
      iii. The number of models.
         1) For example, the number of models may be 1 or 2.
         2) In one example, the number of models may be considered as a part of the CCP type. For example, CCLM and MM-CCLM may be considered as two types.
      iv. At least one threshold to classify samples for different models.
         1) The threshold may be used only if the number of models is at least 2.
      v. At least one luma sample value offset.
         1) The luma sample value offset may be added to or subtracted from a luma sample (which may be down sampled) when it is used to derive a chroma prediction value.
         2) The luma sample value offset may be used only for specific types such as CCCM, GLM with luma, GL-CCCM and CCCM using non-down-sample luma samples.
      vi. At least one chroma sample value offset.
         1) The chroma sample value offset may be added to or subtracted from a chroma prediction value derived by a CCP model to generate the final prediction.
      vii. At least one models for at least one chroma component.
         1) For example, it may include different models for Cb and Cr components.
         2) For example, the number of models for each component may be included as a part of the information.
         3) The model may be represented by the model form of CCLM or CCCM or GLM or GLM with luma or GL-CCCM or CCCM using non-downsampled luma samples.
      viii. At least one sample location shift denoted as (dX, dY).
         1) The chroma sample location shift may be added to or subtracted from the sample location (x, y) when it is used to derive the chroma prediction value.
         2) The chroma sample location shift may be used only for specific types such as GL-CCCM.
   c. For example, the CCP coding information may be stored after a chroma block is coded/decoded.
      i. In one example, the CCP coding information may be stored only if the chroma block is coded with a CCP mode.
         1) In one example, the CCP coding information may be stored if the chroma block is coded with at least one CCP mode, such as with the fusion of chroma intra prediction mode.
         a) The stored type may be set to be the CCP type used in the fusion of chroma intra prediction mode.
      ii. In one example, the CCP coding information may be stored for any chroma block.
         1) If the chroma block is not coded with a CCP mode, the type is stored as “NonCCP”.
      iii. If the chroma block is coded with a CCP mode, the type of information may be stored as depending on the coding mode.
         1) The type is set to be “CCCM” if the mode is CCCM, or CCCM-T, or CCCM-L, or MM-CCCM, or MM-CCCM-T, or MM-CCCM-L.
         2) The type is set to be “CCLM” if the mode is CCLM, or CCLM-T, or CCLM-L, or MM-CCLM, or MM-CCLM-T, or MM-CCLM-L.
         3) The type is set to be “CCLM” if the mode is CCLM, or CCLM-T, or CCLM-L, or MM-CCLM, or MM-CCLM-T, or MM-CCLM-L, with slope adjustments.
         4) The type is set to be “GLM using filter X” if the mode is GLM using filter X.
         5) The type is set to be “GLM with luma using filter X” if the mode is GLM with luma using filter X.
         6) The type is set to be “GL-CCCM” if the mode is GL-CCCM.
         7) The type is set to be “CCCM using non-down-sample” if the mode is CCCM using non-down-sample.
         8) The type is set to be “CCLM” if the mode is the fusion of chroma intra prediction mode.
      iv. The number of models may be stored as the number of models of the chroma block.
         1) For example, the number of models is set to be 2 if the mode is MM-CCLM, or MM-CCLM-T, or MM-CCLM-L, or MM-CCLM, or MM-CCLM-T, or MM-CCLM-L or any other multi-model CCP modes (such as GLM or GL-CCCM or CCCM using non-downsampled luma samples with multi-models).
      v. Information such as the threshold, the luma/chroma sample value offset, sample location shift may be stored as the information used by the chroma block.
      vi. The CCP model of one component may be stored as the model used by the chroma block.
         1) The model may be derived by any CCP method such as CCLM, or CCLM-T, or CCLM-L, or MM-CCLM, or MM-CCLM-T, or MM-CCLM-L or CCCM, or CCCM-T, or CCCM-L, or MM-CCCM, or MM-CCCM-T, or MM-CCCM-L or GLM using different down-sampling filters, or GLM with luma using different down-sampling filters, or GL-CCCM or CCCM using non-downsampled luma samples.
         2) The stored model may be the final applied one, such as the one after been modified by the slope adjustment.
   d. For example, the CCP coding information may be stored in M×N granularity.
      i. For example, M=N=2.
      ii. For example, the CCP coding information of a specific chroma block covered by or covering or overlapped with the M×N region may be stored to the M×N region.
         1) For example, the CCP coding information of the first coded/decode block with CCP information covered by or covering or overlapped with the M×N region may be stored.
         2) For example, the CCP coding information of the last coded/decode block with CCP information covered by or covering or overlapped with the M×N region may be stored.
         3) For example, the CCP coding information of the coded/decode block with CCP information covered by or covering or overlapped a specific position of the M×N region may be stored.
         a) The specific position may be the top-left/bottom-right/top-right/bottom-left/center position of the M×N region.
17. In one example, a CCP candidate list may be built for a chroma block.
   a. In one example, a first syntax element (SE) may be signaled to indicate whether a CCP candidate in the list is applied to the current chroma block. (It may be denoted as “The block is coded with the CCP candidate list mode”)
      i. For example, the SE may be a flag.
      ii. For example, the SE may be coded by a context.
   b. For example, the first SE may be signaled in a conditional way.
      i. For example, the first SE may be signaled only if CCP is applied.
      ii. For example, the first SE may be signaled only if CCP is applied, and a specific mode is applied.
         1) The specific mode may be CCLM.
         2) The specific mode may be CCCM.
   c. In one example, a second syntax element (SE) may be signaled to indicate which CCP candidate is applied.
      i. For example, the SE may be an index.
      ii. For example, the SE may be binarized as a truncated unary code.
         1) For example, the maximum value of the SE may be S−1, where S is the maximum size of the candidate list.
      iii. For example, the first bin of the SE may be coded by a context.
   d. For example, the second SE may be signaled in a conditional way.
      i. For example, the second SE may be signaled only if the first SE indicates a CCP candidate in the list is applied.
   e. In one example, whether the CCP candidate list mode is applicable may be signaled in VPS/DPS/SPS/PPS/picture header/slice header/etc.
   f. In one example, the maximum size/length of the CCP candidate list may be signaled in VPS/DPS/SPS/PPS/picture header/slice header/etc.
18. In one example, a CCP candidate list may comprise at least one CCP candidates stored in a spatial neighbouring block may be adjacent or non-adjacent to the current block (suppose the top-left position of the current block is (Xt, Yt), the width and height of the current block is W and H, respectively.
   a. In one example, a set of positions are checked in order to find stored CCP information.
      i. For example, if the type of the stored CCP information associated with the position is NonCCP, the position is skipped.
         1) Alternatively, if the type of the stored CCP information associated with the position is NonCCP, the position is put in a backup position list.
      ii. For example, if the type of the stored CCP information associated with the position is NOT NonCCP, the stored CCP information is tried to be appended to the list.
   b. In one example, the set of positions (Xi, Yi) to be checked in order may be derived from positions near to the current block, to positions far from the current block.
      i. For example, the positions may be checked in a cycle by cycle manner. For a cycle, several positions are checked, and the next cycle is performed.
      ii. In one example, positions to be checked in a cycle are:

$$( Xt - NDHor - 1 , Yt + H + NDVer - 1 ) , \\ ( Xt + W + NDHor - 1 , Yt - NDVer - 1 ) , ( Xt + ( W >> 1 ) , Yt - NDVer - 1 ) , \\ ( Xt - NDHor - 1 , Yt + ( H >> 1 ) ) , ( Xt - NDHor - 1 , Yt - NDVer - 1 ) .$$

where NDHor and NDVer are different for different cycles.
iii. In one example, positions to be checked for the cycle k are derived as:

$$NDHor = ( k == 0 ? W / 2 : W * k ) ;$$

$$NDVer = ( k == 0 ? H / 2 : H * k ) .$$

iv. In one example, positions to be checked for different cycle may be different.
c. In one example, the set of positions (Xi, Yi) to be checked may be the same as the set of positions checked when building the merge list.
d. In one example, the set of positions (Xi, Yi) to be checked may be the same as the set of positions checked when building the sub-block-based merge list.
19. In one example, when trying to put stored CCP information into the CCP candidate list as a candidate (known as a potential candidate), it may be compared with at least one candidate already in the CCP candidate list.
   a. In one example, all the candidates in the list may be compared with the potential candidate.
   b. In one example, if a candidate already in the CCP candidate list is the same or similar as the potential candidate, then potential candidate cannot be put into the CCP candidate list.
   c. In one example, two CCP candidates are determined NOT to be the same if
      i. The CCP types are different.
      ii. The numbers of models are different.
      iii. The thresholds are different if the CCP has multiple models.
      iv. At least one model is different.
      v. The luma sample offset is different. (maybe only applicable if the type is CCCM or GL-CCCM or GPM or CCCM with using non-downsampled luma samples.)
      vi. The sample location shifts are different. (maybe only applicable if the type is GL-CCCM).
20. In one example, when a CCP candidate in the list is used to generate prediction for the current block, the CCP will be performed following the CCP information.
   a. CCCM, CCLM, 4 types of GLM using different down-sampling filters, 4 types of GLM with luma using different down-sampling filters, GL-CCCM and CCCM using non-downsampled luma samples may be applied to the current block, based on the CCP type of the candidate.
   b. One model or multiple models with at least one threshold may be used, based on the model number and thresholds of the candidate.
   c. The luma sample value offset of the candidate may be added to or subtracted from the luma samples (which may be down-sampled) to be put into the CCP model.
      i. The process may be only applicable if the type is CCCM or GL-CCCM or GPM or CCCM with using non-downsampled luma samples.
   d. The sample location shift(s) may be added to or subtracted from the location coordinator to be put into the CCP model.
      i. The process may be only applicable if the type is GL-CCCM.
   e. How to get down-sampled luma samples may be based on the CCP type.
      i. The down-sampled luma samples may be obtained following the down-sampling method required by the CCP mode corresponding to the type.
21. In example, the prediction value generated by a CCP candidate may be modified before being used to obtain the reconstruction sample value.
   a. In one example, an offset D may be added to or subtracted from the prediction value.
   b. In one example, the offset may be derived based on luma/chroma samples of a template, which is calculated using reconstructed samples neighbouring to the current block, known as a “template”. FIG. 35 shows examples of a template. FIG. 35 illustrates possible templates.
      i. In one example, the template may consist of reconstructed samples left to the current block, if reconstructed samples left to the current block are available.
      ii. In one example, the template may consist of reconstructed samples above to the current block, if reconstructed samples above to the current block are available.
      iii. In one example, the template may consist of reconstructed samples above or left to the current block, if reconstructed samples above/left to the current block are available.
      iv. Corresponding luma samples of the template may be down-sampled with the same manner as luma samples inside the current block.
   c. In one example, if there are N models (such as two models) required by the CCP type, N offsets denoted as {D⁰, . . . , D^{N-1}} may be derived for the N models.
      i. Offset Dⁱ may be added to or subtracted from the prediction value generated by model i.
   d. In one example, the CCP method indicated by the type of the CCP candidate may be applied on the template.
      i. For example, for the k-th sample of the template, Sₖ=Rₖ−Pₖ is calculated, where Rₖ and Pₖ represent the reconstructed sample value and the prediction value with CCP of the k-th sample, respectively, is calculated.
         1) For example, D is calculated as the average value of {Sₖ}.
         2) For example, suppose the number of Sₖ is M, D is calculated as D=sign(sum)×((|sum|+off)>>W), where

$$sum = {\sum }_{k = 0}^{M - 1} {S}_{k}$$

and W=└ log₂|sum|┘.
ii. For example, for the k-th sample using model i of the template, Sⁱₖ=Rⁱₖ−Pⁱₖ is calculated, where Rⁱₖ and Pⁱₖ represent the reconstructed sample value and the prediction value with CCP of the k-th sample using model i, respectively, is calculated.
   1) For example, Dⁱ is calculated as the average value of {Sⁱₖ}.
   2) For example, suppose the number of Sⁱₖ is M, D is calculated as Dⁱ=sign(sum)×((|sum|+off)>>W), where

$$sum = {\sum }_{k = 0}^{M - 1} {S}_{k}^{i}$$

and W=└ log₂|sum|┘.
iii. In one example, no division operation is used to calculate D or Dⁱ.
   1) For example, a lookup table may be used to calculate D or Dⁱ.
e. For example, only specific types of CCP may apply the modifications, such as CCLM and CCCM with multiple models.
   i. For example, types of CCLM, CCLM with multiple models, CCCM with multiple models, and GLM may apply the modifications.
22. In one example, a candidate with type “Non-adjacent” may be put into the candidate list.
   a. The information includes a position (x, y).
   b. If such a candidate is used to predict the current block, CCP model(s) may be derived with samples referred to by (x, y), as stated by bullet 1-bullet 15.
   c. In one example, the positions stored in the backup position list disclosed in bullet 18 may be checked in order to put valid ones in the candidate list.
23. In one example, the construction of the candidate list may be terminated if the number of candidates in the list is M and M=D+1, wherein D is the index indicating the selected candidate.
24. In one example, if all possible potential candidates are checked and the size of the candidate list is smaller than S, wherein S is the maximum number of candidates, then default candidates may be put into the list to fulfill the list.
25. In one example, the CCP candidate list my compirse at least one candidate fetched from a history-based table.
   a. The history table may be an online table.
   b. The history table may be a stored table.
   c. To build the CCP candidate list, the potential candidates may be checked in an order.
      i. For example, the order may be (1) CCP information stored in spatial adjacent/non-adjacent blocks; (2) CCP candidate with type “Non-adjacent; (3) history-based candidates from the on-line table; (4) history-based candidates from the stored table; (5) default candidates.
      ii. For example, the order may be (1) CCP information stored in spatial adjacent blocks; (2) CCP information stored in spatial non-adjacent blocks; (3) CCP candidate with type “Non-adjacent; (4) history-based candidates from the on-line table; (5) history-based candidates from the stored table; (6) default candidates.
      iii. For example, the order may be (1) CCP information stored in spatial adjacent blocks; (2) CCP information stored in spatial non-adjacent blocks; (3) history-based candidates from the on-line table; (4) history-based candidates from the stored table; (5) CCP candidate with type “Non-adjacent; (6) default candidates.
      iv. For example, the order may be (1) CCP information stored in spatial adjacent blocks; (2) history-based candidates from the on-line table; (3) CCP information stored in spatial non-adjacent blocks; (4) CCP candidate with type “Non-adjacent; (5) history-based candidates from the stored table; (6) default candidates.
      v. Any type of candidates in an exemplary order may be removed from.
      vi. Any other orders of these kinds of potential candidates.
26. In one example, if a chroma block is coded by using at least one CCP candidate, the CCP information of the CCP candidate may be stored.
   a. The storing method may follow the way disclosed in bullet 16.
27. In one example, if a chroma block is coded by using at least one CCP candidate, the CCP information of the CCP candidate may be put into the history-based table.
   a. The process to put the CCP information into the history-based table may follow the process described in section 2.27.

### 2.29. CCCM Using Multiple Downsampling Filters (MF-CCCM)

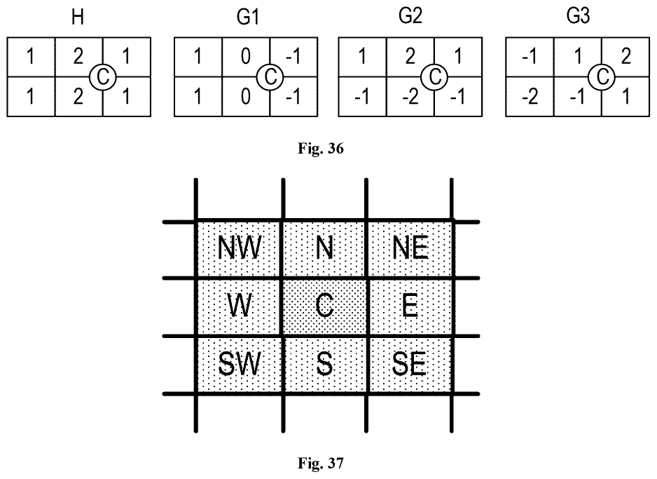

It is proposed to apply multiple downsampling filters to a group of reconstructed luma samples in a CCCM. The linear combination of these downsampled reconstructed samples is multiplied by derived filter coefficients to form the final chroma predictor. The horizontal or vertical location of the center luma sample may be also considered in the proposed model. The coefficients are derived by Gaussian elimination method as currently used by CCCM modes in ECM. The cross-component models shown below are tested as additional CCCM modes with a mode index signaled in the bitstream:

$$Model 1 : predChroma = c 0 * H ( C ) + c 1 * G 1 ( C ) + c 2 * G 2 ( C ) + c 3 * G 3 ( C ) + c 4 * P ( H ( C ) ) + c 5 * P ( G 1 ( C ) ) + c 6 * P ( G 2 ( C ) ) + c 7 * X + c 8 * Y + c 9 * B \qquad ( 1 )$$

$$Model 2 : predChroma = c 0 * H ( C ) + c 1 * H ( W ) + c 2 * H ( E ) + c 3 * G 1 ( C ) + c 4 * G 1 ( W ) + c 5 * G 1 ( E ) + c 6 * P ( H ( C ) ) + c 7 * P ( H ( W ) ) + c 8 * P ( H ( E ) ) + c 9 * X + c 10 * B \qquad ( 2 )$$

$$Model 3 : predChroma = c 0 * H ( C ) + c 1 * H ( NE ) + c 2 * H ( SW ) + c 3 * G 3 ( C ) + c 4 * G 3 ( NE ) + c 5 * G 3 ( SW ) + c 6 * P ( H ( C ) ) + c 7 * P ( H ( NE ) ) + c 8 * P ( H ( SW ) ) + c 9 * Y + c 10 * B \qquad ( 3 )$$

where H(⋅), G1(⋅), G2(⋅), G3(⋅) are various downsampling filters as indicated in FIG. 36, C denotes the current chroma sample position, and N, S, W, E, NE, SW are the positions around C as indicated in FIG. 37, cᵢ are filter coefficients, P and B are nonlinear term and bias term, and X and Y are the horizontal and vertical locations of the center luma sample with respect to the top-left coordinates of the block. It is noted that Model 1 is a 1×1 prediction shape using current chroma sample only while the other models are one-directional prediction models using 3 chroma samples.

### 2.30. Non-Local Cross-Component Prediction and Cross-Component Merge Mode

The CCP candidate mode disclosed in 2.27 and 2.28 may also be denoted as the “cross-component merge mode”.

A CCP candidate disclosed in 2.27 and 2.28 may also be denoted as a cross-component merge candidate.

A CCP candidate list disclosed in 2.27 and 2.28 may also be denoted as a cross-component merge candidate list.

In this document, CCP candidate mode, cross-component merge mode, and CCP merge mode may have the same meaning.

In this document, a CCP candidate, a cross-component merge candidate, and a CCP merge candidate may have the same meaning.

In this document, a CCP candidate list, a cross-component merge candidate list, and a CCP merge candidate list may have the same meaning.

In ECM-9.0, a CCP merge candidate list is constructed from the spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, 1/8, −1/8, 2/8, −2/8, 3/8, −3/8, 4/8, −4/8, 5/8, −5/8, 6/8}. Otherwise, the default scaling parameters are {0, the scaling parameter of the first CCLM candidate+{1/8, −1/8, 2/8, −2/8, 3/8, −3/8, 4/8, −4/8, 5/8, −5/8, 6/8}}. The offset parameter is derived according to the default scaling parameter, average neighbouring reconstructed luma sample value, and average neighbouring reconstructed Cb/Cr sample value.

A flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra subpartitions (ISP) with single tree, or the current chroma coding block size is less than or equal to 16.

### 3. Problems

Luma samples used in CCP methods such as CCCM are limited. More luma samples may introduce additional benefits.

Chroma information is not involved in the CCP approach.

### 4. Detailed Description

The detailed embodiments below should be considered as examples to explain general concepts. These embodiments should not be interpreted in a narrow way. Furthermore, these embodiments can be combined in any manner.

In the following discussion, CCCM may refer to the original CCCM mode, or it may refer to a variance of CCCM, such as CCCM-L, CCCM-T, MM-CCCM, MM-CCCM-L, MM-CCCM-T.

In the following discussion, CCLM may refer to the original CCLM mode, or it may refer to a variance of CCLM, such as CCLM-L, CCLM-T, MM-CCLM, MM-CCLM-L, MM-CCLM-T, etc.

In one following discussion, cross-component prediction (CCP) may refer to any cross-component prediction such as CCLM or CCCM or GLM or CCLM with sliding offsets.

### Extended CCCM Type #1

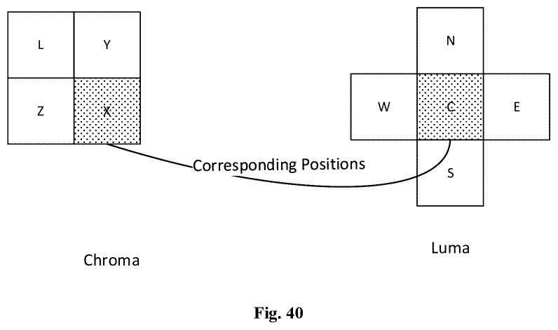

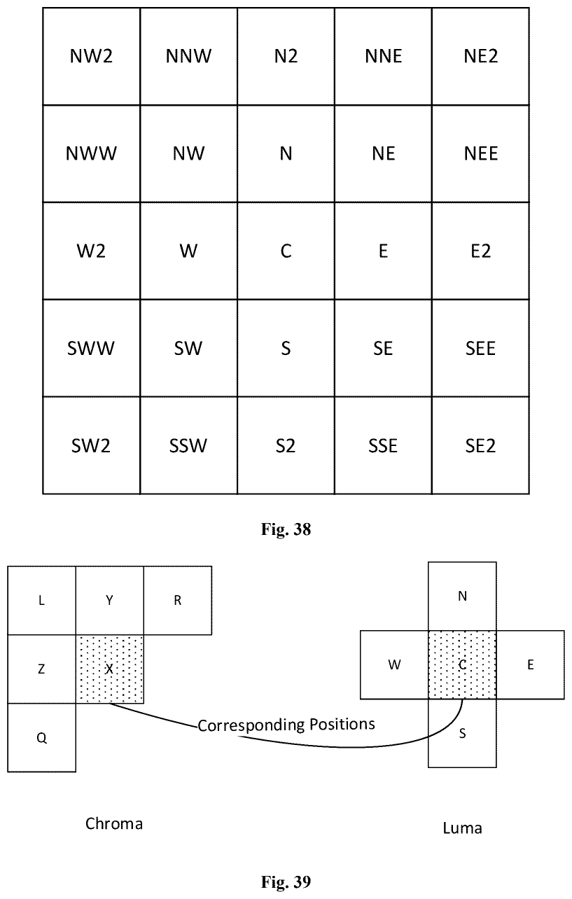

1. New added reconstructed luma samples beyond those at the positions N, W, E, S and C as shown in FIG. 37 may be involved in the CCP approach. As in FIG. 37, position C corresponds to the position of the chroma sample to be predicted. The luma positions may be after down-sampling for specific colour format such as YCbCr 4:2:0 or YCbCr 4:2:2.
   a. In one example, the new added luma samples may be at NW and/or NE and/or SW and/or SE as shown in FIG. 38. FIG. 38 illustrates an example of luma positions (which may be after down-sampling) to be used in CCP.
      i. For example, predChromaVal=c₀C+c₁N+c₂S+c₃E+c₄W+c₅P++c₆NW+c₇NE+c₈SW+c₉SE+c₁₀B, wherein P and B are nonlinear term (e.g., P=C²) and bias term (e.g. B=1<<(bitdepth−1)).
   b. In one example, a new added luma sample may be at a position non-adjacent to C such as N2, W2, S2, E2, NNW, NW2, NWW, SWW, SW2, SSW, SEE, SE2, SSE, NEE, NNE, NE2, etc.
      i. For example, predChromaVal=c₀C+c₁N+c₂S+c₃E+c₄W+c₅P++c₆NW+c₇NE+c₈SW+c₉SE+c₁₀N2+c₁₁S2+c₁₂E2+c₁₃W2+c₁₄B, wherein P and B are nonlinear term (e.g., P=C²) and bias term (e.g. B=1<<(bitdepth−1)).
   c. In one example, padding may be used to obtain the new added luma samples if unavailable.
   d. In one example, a function with at least one input as a new added luma sample may be involved in the CCP approach.
      i. For example, the function may be the derivation of a gradient.
   e. In one example, the luma samples may be obtained with down-sampling methods same as in CCLM, or CCCM or GLM, or MF-CCCM.
      i. In one example, the luma samples may be obtained with a different down-sampling method.
   f. In one example, the CCP approach using new added luma samples may be denoted as a new mode extCCCM.
      i. extCCCM mode may have variants in a same way as CCCM, such as MM-extCCCM, extCCCM-L, extCCCM-T, MM-extCCCM-L, MM-extCCCM-T.
   g. In one example, extCCCM mode and its variants may replace an exiting mode, such as CCCM, and its variants.
   h. In one example, extCCCM may be used as an additional mode.
   i. In one example, whether to and/or how to use extCCCM mode may depend on the coding information of the current block, such as.
      i. The mode of the current block;
         1) In one example, extCCCM may not be applicable GL-CCCM is applied.
         2) In one example, extCCCM may not be applicable unsampling CCCM is applied.
         3) In one example, extCCCM may not be applicable if MF-CCCM is applied.
         4) In one example, extCCCM may not be applicable if inside filtering is applied.
         5) In one example, extCCCM may be applicable only for extCCCM not its variants.
         6) In one example, extCCCM may be applicable only for extCCCM and MM-extCCCM, not other variants.
      ii. The mode of a neighbouring block;
      iii. The mode of a luma block in the collocated region of the current block;
      iv. The mode of a luma block in the collocated region of a neighbouring block;
      v. QP;
      vi. Slice/picture type;
      vii. Picture width/height;
      viii. Block width (W)/height (H);
         1) In one example, extCCCM may not be applicable if W<T1 and/or H<T2.
         2) In one example, extCCCM may not be applicable if W+H<T.
         3) In one example, extCCCM may not be applicable if W*H<T.
         4) In one example, extCCCM may not be applicable if W>T1 and/or H>T2.
         5) In one example, extCCCM may not be applicable if W+H>T.
         6) In one example, extCCCM may not be applicable if W*H>T.
      ix. Position of the block.
      x. Reconstructed samples.
   j. In one example, a flag (denoted as extCCCM flag) may be signaled to indicate whether extCCCM and/or its variant is applied.
      i. For example, the flag may be signalled conditionally.
      ii. For example, the flag is signalled only if CCCM flag (indicating CCCM mode) is true.
      iii. For example, the flag is not signalled if CCP merge mode is applied.
      iv. For example, the flag is signaled only if extCCCM mode is applicable.
      v. For example, whether extCCCM or its variant is applied may depend on signaled mode.
         1) For example, if the signaled mode is CCLM, CCCM_flag and extCCCM flag are both true, then the current block uses extCCCM mode.
         2) For example, if the signaled mode is MM-CCLM, CCCM flag and extCCCM flag are both true, then the current block uses MM-extCCCM mode.
         3) For example, if the signaled mode is CCLM-T, CCCM flag and extCCCM_flag are both true, then the current block uses extCCCM-T mode.
         4) For example, if the signaled mode is MM-CCLM-T, CCCM flag and extCCCM flag are both true, then the current block uses MM-extCCCM-T mode.
         5) For example, if the signaled mode is CCLM-L, CCCM flag and extCCCM_flag are both true, then the current block uses extCCCM-T mode.
         6) For example, if the signaled mode is MM-CCLM-L, CCCM flag and extCCCM flag are both true, then the current block uses MM-extCCCM-T mode.
   k. In one example, extCCCM mode can be used with merge CCP mode.
      i. For example, extCCCM mode can be regarded as a new type in merge CCP mode.
      ii. Information and/or parameters of extCCCM can be stored in blocks.
      iii. Information and/or parameters of extCCCM can be stored in the history table.
      iv. The stored Information and/or parameters of extCCCM can be used to generate a candidate in the merge CCP candidate list.
      v. The candidate with the type of extCCCM can be involved in the candidate list reordering process as candidates with other types such as CCCM.
      vi. The candidate with the type of extCCCM can be involved in the candidate list pruning process as candidates with other types such as CCCM.
      vii. The candidate with the type of extCCCM can be involved in the candidate list offset updating process as candidates with other types such as CCCM.
      viii. If a candidate with the type of extCCCM is selected, extCCCM is used for the current block, instructed by the parameters of the candidate.
   l. In one example, the same training process as CCCM is applied to derive the parameters of extCCCM, but maybe with different number of parameters.
      i. In one example, the region of chroma reconstructed samples and their corresponding luma reconstructed samples (which may be obtained by down-sampling) used by extCCCM or its variant may be the same to that of CCCM or the corresponding variant of CCCM.
      ii. In one example, the region of chroma reconstructed samples and their corresponding luma reconstructed samples (which may be obtained by down-sampling) used by extCCCM or its variant may be different from (e.g. larger than) that of CCCM or the corresponding variant of CCCM.

### Extended CCCM Type #2

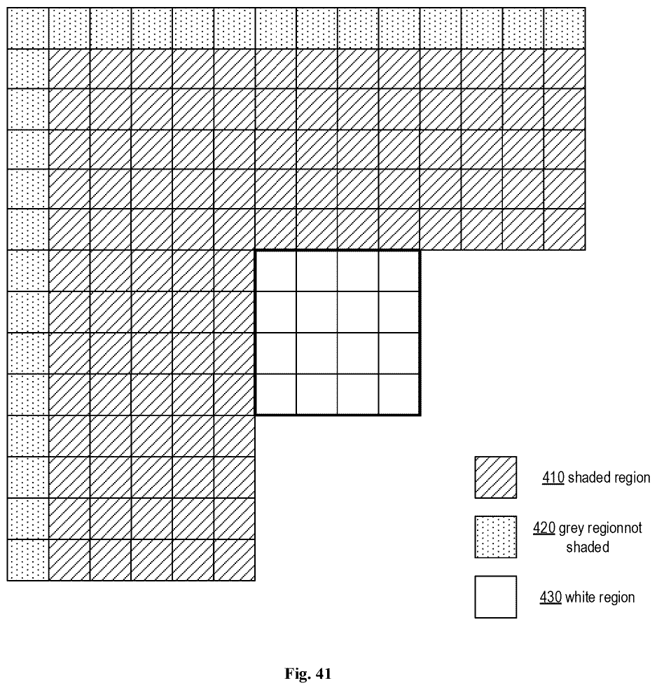

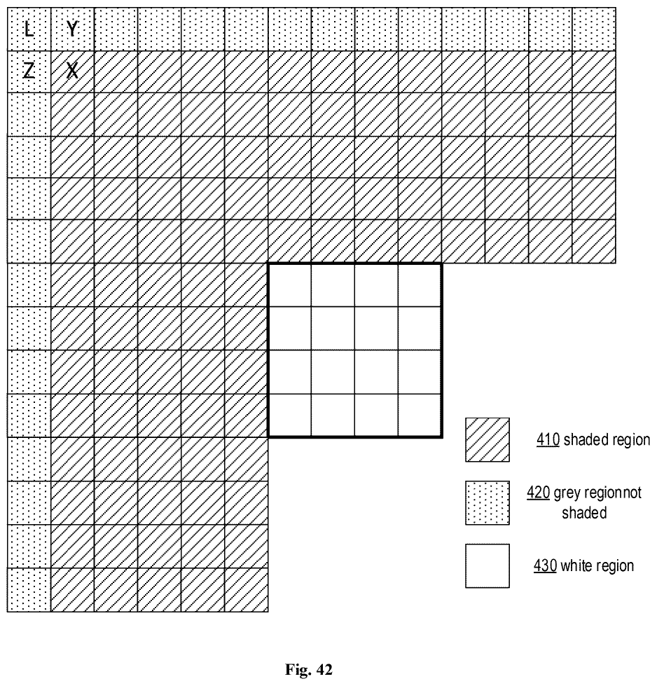

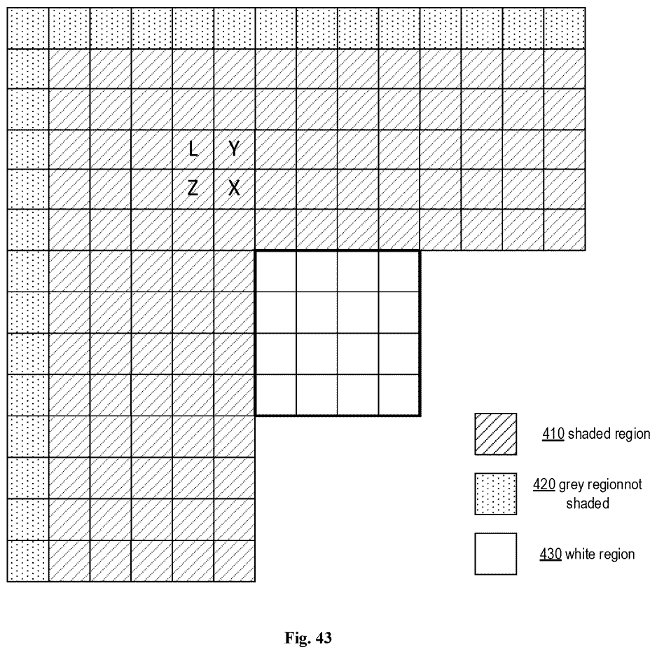

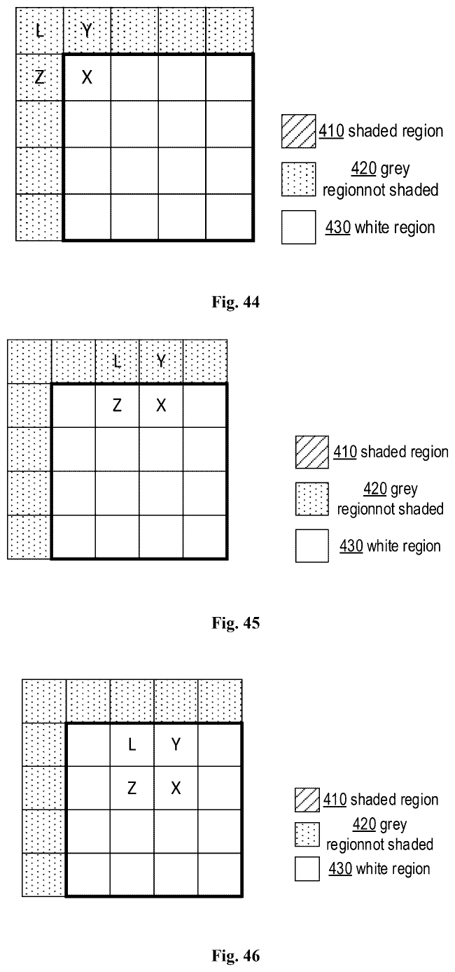

2. Reconstructed and/or predicted chroma samples may be involved in the CCP approach.
   a. FIG. 39 illustrates an example of luma positions (which may be after down-sampling) and chroma positions to be used in CCP. As in FIG. 39, luma position C corresponds to the position X of the chroma sample to be predicted. The luma positions may be after down-sampling for specific colour format such as YCbCr 4:2:0 or YCbCr 4:2:2.
   b. In one example, the new added chroma samples may be at L and/or Y and/or Z and/or R and/or Q as shown in FIG. 39.
      i. For example, predChromaVal(X)=c₀C+c₁N+c₂S+c₃E+c₄W+C₅P++c₆L+c₇Y+c₈Z+c₉R+c₁₀Q+c₁₁B, wherein P and B are nonlinear term (e.g., P=C²) and bias term (e.g. B=1<<(bitdepth−1)).
   c. In one example, the new added chroma samples may be at L and/or Y and/or Z as shown in FIG. 40. FIG. 40 illustrates a second example of luma positions (which may be after down-sampling) and chroma positions to be used in CCP.
      i. For example, predChromaVal(X)=c₀C+c₁N+c₂S+c₃E+c₄W+C₅P+c₆L+c₇Y+c₈Z+c₉B, wherein P and B are nonlinear term (e.g., P=C²) and bias term (e.g. B=1<<(bitdepth−1)).
   d. In one example, padding may be used to obtain the new added chroma reconstructed samples if unavailable.
   e. In one example, a function with at least one input as a new added chroma sample may be involved in the CCP approach.
      i. For example, the function may be the derivation of a gradient.
      ii. For example, the function may be a non-linear operation such as the squared operation.
   f. In one example, the luma samples may be obtained with down-sampling methods same as in CCLM, or CCCM or GLM, or MF-CCCM.
      i. In one example, the luma samples may be obtained with a different down-sampling method.
   g. In one example, the CCP approach using new added chroma samples may be denoted as a new mode mixCCCM.
      i. mixCCCM mode may have variants in a same way as CCCM, such as MM-mixCCCM, mixCCCM-L, mixCCCM-T, MM-mixCCCM-L, MM-mixCCCM-T.
   h. In one example, mixCCCM mode and its variants may replace an exiting mode, such as CCCM, and its variants.
   i. In one example, mixCCCM may be used as an additional mode.
   j. In one example, whether to and/or how to use mixCCCM mode may depend on the coding information of the current block, such as.
      i. The mode of the current block;
         1) In one example, mixCCCM may not be applicable GL-CCCM is applied.
         2) In one example, mixCCCM may not be applicable unsampling CCCM is applied.
         3) In one example, mixCCCM may not be applicable if MF-CCCM is applied.
         4) In one example, mixCCCM may not be applicable if inside filtering is applied.
         5) In one example, mixCCCM may be applicable only for mixCCCM not its variants.
         6) In one example, mixCCCM may be applicable only for mixCCCM and MM-mixCCCM, not other variants.
      ii. The mode of a neighbouring block;
      iii. The mode of a luma block in the collocated region of the current block;
      iv. The mode of a luma block in the collocated region of a neighbouring block;
      v. QP;
      vi. Slice/picture type;
      vii. Picture width/height;
      viii. Block width (W)/height (H);
         1) In one example, mixCCCM may not be applicable if W<T1 and/or H<T2.
         2) In one example, mixCCCM may not be applicable if W+H<T.
         3) In one example, mixCCCM may not be applicable if W*H<T.
         4) In one example, mixCCCM may not be applicable if W>T1 and/or H>T2.
         5) In one example, mixCCCM may not be applicable if W+H>T.
         6) In one example, mixCCCM may not be applicable if W*H>T.
      ix. Position of the block.
         1) In one example, mixCCCM may not be applicable if posX==0 or posY==0, wherein the top-left position of the block is (posX, posY).
      x. Reconstructed samples.
   k. In one example, a flag (denoted as mixCCCM_flag) may be signaled to indicate whether mixCCCM and/or its variant is applied.
      i. For example, the flag may be signalled conditionally.
      ii. For example, the flag is signalled only if CCCM_flag (indicating CCCM mode) is true.
      iii. For example, the flag is not signalled if CCP merge mode is applied.
      iv. For example, the flag is signaled only if mixCCCM mode is applicable.
      v. For example, whether mixCCCM or its variant is applied may depend on signaled mode.
         1) For example, if the signaled mode is CCLM, CCCM_flag and mixCCCM_flag are both true, then the current block uses mixCCCM mode.
         2) For example, if the signaled mode is MM-CCLM, CCCM flag and mixCCCM_flag are both true, then the current block uses MM-mixCCCM mode.
         3) For example, if the signaled mode is CCLM-T, CCCM flag and mixCCCM_flag are both true, then the current block uses mixCCCM-T mode.
         4) For example, if the signaled mode is MM-CCLM-T, CCCM flag and mixCCCM_flag are both true, then the current block uses MM-mixCCCM-T mode.
         5) For example, if the signaled mode is CCLM-L, CCCM flag and mixCCCM_flag are both true, then the current block uses mixCCCM-T mode.
         6) For example, if the signaled mode is MM-CCLM-L, CCCM flag and mixCCCM_flag are both true, then the current block uses MM-mixCCCM-T mode.
   l. In one example, mixCCCM mode can be used with merge CCP mode.
      i. For example, mixCCCM mode can be regarded as a new type in merge CCP mode.
      ii. Information and/or parameters of mixCCCM can be stored in blocks.
      iii. Information and/or parameters of mixCCCM can be stored in the history table.
      iv. The stored Information and/or parameters of mixCCCM can be used to generate a candidate in the merge CCP candidate list.
      v. The candidate with the type of mixCCCM can be involved in the candidate list reordering process as candidates with other types such as CCCM.
      vi. The candidate with the type of mixCCCM can be involved in the candidate list pruning process as candidates with other types such as CCCM.
      vii. The candidate with the type of mixCCCM can be involved in the candidate list offset updating process as candidates with other types such as CCCM.
      viii. If a candidate with the type of mixCCCM is selected, mixCCCM is used for the current block, instructed by the parameters of the candidate.
   m. In one example, the same training process as CCCM is applied to derive the parameters of mixCCCM, but maybe with different number of parameters.
      i. In one example, the region of chroma reconstructed samples and their corresponding luma reconstructed samples (which may be obtained by down-sampling) used by mixCCCM or its variant may be the same to that of CCCM or the corresponding variant of CCCM.
      ii. In one example, the region of chroma reconstructed samples and their corresponding luma reconstructed samples (which may be obtained by down-sampling) used by mixCCCM or its variant may be different from (e.g. smaller than) that of CCCM or the corresponding variant of CCCM.
         1) In one example, the region of chroma reconstructed samples as targe values and their corresponding luma reconstructed samples (which may be obtained by down-sampling) used by mixCCCM or its variant may be smaller than that of CCCM or the corresponding variant of CCCM as shown in FIG. 41, wherein the top row and left-most column involved in the CCCM training process are excluded. FIG. 41 illustrates an example of reconstructed chroma sample positions (in region 410) used to derive the parameters of mixCCCM as the target values in the training process. The grey positions shaded (in region 410) or not shaded (in region 420) are used to derive the parameters of CCCM. The white positions (in region 430) are the current 4×4 chroma block.
      iii. In the training process of mixCCCM, a reconstructed sample may be used as an input value (such as L, Y, R, Z, Q in FIG. 39 or FIG. 40), but not used as a target value (such as X in FIG. 39 or FIG. 40).
         1) FIG. 42 shows an example, where L, Y and Z can only used as input values of X, but they may not be used as target values in the training process. FIG. 42 illustrates an example of reconstructed chroma sample positions used as input values (L, Y, Z) of a target value X in the training process of mixCCCM, where (L, Y, Z) are out of the shaded region (region 410), in which of reconstructed chroma samples serve as target values in the parameter training process.
      iv. In the training process of mixCCCM, a reconstructed sample may be used as an input value (such as L, Y, R, Z, Q in FIG. 39 or FIG. 40), and may also be used as a target value (such as X in FIG. 39 or FIG. 40).
         1) FIG. 43 shows an example, where L, Y and Z are used as input values of X. L, Y and Z are also used as target values in the training process before processing X. FIG. 43 illustrates an example of reconstructed chroma sample positions used as input values (L, Y, Z) of a target value X in the training process of mixCCCM, where (L, Y, Z) are in the shaded region (in region 410), in which of reconstructed chroma samples serve as target values in the parameter training process. In other words, L, Y, Z serve as input value for target value X in the training process, and they also serve as the target values in the training process.
   n. When applying the mixCCCM model to predict a chroma sample, the chroma samples input to the model at specific positions such as L, Y and Z may be reconstructed samples, or prediction samples.
      1) In one example, if the specific position is out of the current block, the reconstructed sample may be input.
      2) In one example, if the specific position is in the current block, the prediction sample may be input.
         a) In one example, the prediction sample of a position may be obtained by using the mixCCCM model on that position as the target to get the prediction value.
      3) FIG. 44 shows an example, where L, Y and Z are used as input values of X. L, Y and Z are all reconstructed samples. FIG. 44 illustrates an example of applying the mixCCCM model in a 4×4 chroma block. The targe value is X and the input values (L, Y, Z) are reconstructed samples out of the current block.
      4) FIG. 45 shows an example, where L, Y and Z are used as input values of Xₒ L and Y are reconstructed samples, but Z is a prediction sample. FIG. 45 illustrates a second example of applying the mixCCCM model in a 4×4 chroma block. The targe value is X and the input values (L, Y) are reconstructed samples out of the current block. The input value Z is a prediction sample, which is in the current block.
      5) FIG. 46 shows an example, where L, Y and Z are used as input values of X, L, Y and Z are all prediction samples. FIG. 46 illustrates a second example of applying the mixCCCM model in a 4×4 chroma block. The targe value is X and the input values (L, Y, Z) are prediction samples in the current block.

### Harmonization of Extended CCCM Types

3. In one example, more than one extended CCCM modes may be applied.
   a. For example, extCCCM and mixCCCM may coexist.
   b. For example, a first flag (denoted as extended_CCCM_flag) may be signaled to indicate whether a kind of extended CCCM mode is applied.
      i. For example, the flag may be signalled conditionally.
         1) For example, the flag is signalled only if CCCM_flag (indicating CCCM mode) is true.
         2) For example, the flag is not signalled if CCP merge mode is applied.
         3) For example, the flag is signaled only if a kind of extended CCCM mode is applicable.
   c. For example, a second syntax element (extended_CCCM_type) may be signaled to indicate which kind of extended CCCM mode is applied
      i. For example, the flag may be signalled conditionally.
         1) For example, the flag is signalled only if extended_CCCM_flag is true.

### General Aspects

4. A syntax element disclosed above may be binarized as a flag, a fixed length code, an EG(x) code, a unary code, a truncated unary code, a truncated binary code, etc. It can be signed or unsigned.
5. A syntax element disclosed above may be coded with at least one context model. Or it may be bypass coded.
6. A syntax element disclosed above may be signaled in a conditional way.
   a. The SE is signaled only if the corresponding function is applicable.
   b. The SE is signaled only if the dimensions (width and/or height) of the block satisfy a condition.
7. A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
8. Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
9. Whether to and/or how to apply the disclosed methods above may be dependent on coded information, such as block size, colour format, single/dual tree partitioning, colour component, slice/picture type.
10. The proposed methods disclosed in this document may be used in other coding tools which require chroma fusion.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one or multiple CTUs/CTBs, one or multiple Virtual Pipeline Data Unit (VPDU), a sub-region within a picture/slice/tile/brick. The terms ‘block’ may represent a coding tree block (CTB), a coding tree unit (CTU), a coding block (CB), a CU, a PU, a TU, a PB, a TB.

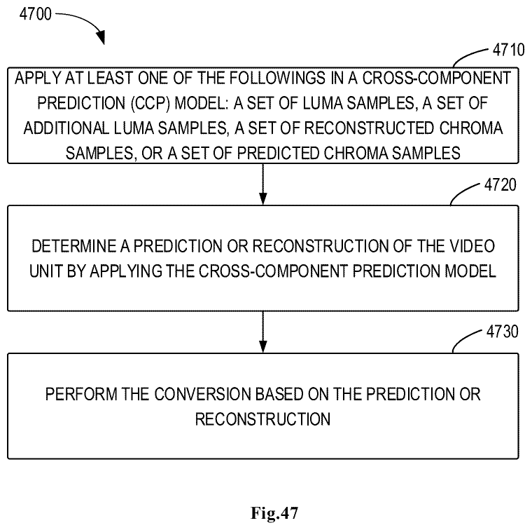

FIG. 47 illustrates a flowchart of a method 4700 for video processing in accordance with embodiments of the present disclosure. The method 4700 is implemented during a conversion between a video unit of a video and a bitstream of the video.

At block 4710, for a conversion between a video unit of a video and a bitstream of the video unit, at least one of the followings: a set of luma samples, a set of additional luma samples, a set of reconstructed chroma samples, or a set of predicted chroma samples is applied in a cross-component prediction (CCP) model.

At block 4720, a prediction or reconstruction of the video unit is determined by applying the CCP model to the video unit.

At block 4730, the conversion is performed based on the prediction or reconstruction. In some embodiments, the conversion includes encoding the video unit into the bitstream. In some other embodiments, the conversion includes decoding the video unit from the bitstream. In this way, the coding performance and coding efficiency can be improved by introducing additional luma samples and/or chroma samples.

In some embodiments, luma positions used in the CCP model are after down-sampling for a colour format. For example, the colour format may be YCbCr 4:2:0 or YCbCr 4:2:2.

In some embodiments, the set of additional luma samples are at positions which are beyond a center position corresponding to a chroma sample to be predicted, a north position relative to the center position, a west position relative to the center position, an east position relative to the center position and a south position relative to the center position.

In some embodiments, the set of additional luma samples are at at least one of the following positions relative to the center position: a north west position, a north east position, a south west position, or a south east position. An example is shown in FIG. 39. For example, predChromaVal=c₀C+c₁N+c₂S+c₃E+c₄W+c₅P+c₆NW+c₇NE+c₈SW+c₉SE+c₁₀B, where predChromaVal represents a chroma sample to be predicted, C represents a luma sample at the center position, N represents a luma sample at the north position, S represents a luma sample at the south position, E represents a luma sample at the east position, W represents a luma sample at the west position, NW represents a luma sample at the north west position, NE represents a luma sample at the north east position, SW represents a luma sample at the south west position, SE represents a luma sample at the south east position, P and B represents nonlinear term and bias term, respectively, c₀, c₁, c₂, c₃, c₄, c₅, c₆, c₇, c₈, c₉ and c₁₀ represent parameters. In some embodiments, P=C². Alternatively, or in addition, B=1<<(bitdepth−1).

In some embodiments, the set of additional luma samples are at a position non-adjacent to the center position. In one example, a new added luma sample may be at a position non-adjacent to C such as N2, W2, S2, E2, NNW, NW2, NWW, SWW, SW2, SSW, SEE, SE2, SSE, NEE, NNE, NE2, etc.

In some embodiments, predChromaVal=c₀C+c₁N+c₂S+c₃E+c₄W+c₅P+c₆NW+c₇NE+c₈SW+c₉SE+c₁₀N2+c₁₁S2+c₁₂E2+c₁₃W2+c₁₄B, where predChromaVal represents a chroma sample to be predicted, C represents a luma sample at the center position, N represents a luma sample at the north position, S represents a luma sample at the south position, E represents a luma sample at the east position, W represents a luma sample at the west position, NW represents a luma sample at the north west position, NE represents a luma sample at the north east position, SW represents a luma sample at the south west position, SE represents a luma sample at the south east position, N2, S2, E2 and W2 represent luma samples at non-adjacent positions to the center position, respectively, P and B represents nonlinear term and bias term, respectively, c₀, c₁, c₂, c₃, c₄, c₅, c₆, c₇, c₈, c₉, c₁₀, c₁₁, c₁₂, c₁₃ and c₁₄ represent parameters. In some embodiments, P=C². Alternatively, or in addition, B=1<<(bitdepth−1).

In some embodiments, if one or more luma samples are unavailable, padding is used to obtain the set of additional luma samples. In some embodiments, a function with at least one input as an additional luma sample is involved in the CCP model. For example, the function is a derivation of a gradient.

In some embodiments, the set of luma samples and the set of additional luma samples are obtained with down-sampling approaches same as those used in one of: cross-component linear model (CCLM), convolutional cross-component model (CCCM), gradient linear model (GLM), or CCCM using multiple downsampling filters (MF-CCCM). In some other embodiments, the set of luma samples and the set of additional luma samples are obtained with down-sampling approaches same as those used in one of: CCLM, CCCM, GLM, or MF-CCCM.

In some embodiments, in response to the video unit is coded with a first target coding mode, the set of luma samples and the set of additional luma samples are applied in the CCP model. In some embodiments, the first target coding mode is an extended CCCM (extCCCM) mode.

In some embodiments, the first target coding mode has variants is a same way of CCCM. For example, the variants of the first target coding mode comprise at least one of: multiple model-extCCCM (MM-extCCCM), extCCCM-left (extCCCM-L), extCCCM-top (extCCCM-T), MM-extCCCM-L, or MM-extCCCM-T.

In some embodiments, the first target coding mode and variants of the first target coding mode replace an exiting mode. For example, the existing mode comprises CCCM and/or variants of the CCCM. In some other embodiments, the first target coding mode is used as an additional mode.

In some embodiments, whether to and/or how to use the first target coding mode depend on coding information of a current block. In some embodiments, the coding information comprises at least one of: a mode of the current block, a mode of a neighbouring block, a mode of a luma block in a collocated region of the current block, a mode of a luma block in a collocated region of a neighbouring block, quantization parameter (QP), slice type, picture type, block width, block height, position of the current block, or reconstructed samples.

In some embodiments, the first target coding mode is not applicable, if a gradient and location based convolutional cross-component model (GL-CCCM) is applied. Alternatively, or in addition, the first target coding mode is not applicable, if unsampling CCCM is applied. Alternatively, or in addition, the first target coding mode is not applicable, if MF-CCCM is applied. Alternatively, or in addition, the first target coding mode is not applicable, if inside filtering is applied. Alternatively, or in addition, the first target coding mode is applicable only for the first target coding mode not variants of the first target coding mode. Alternatively, or in addition, the first target coding mode is applicable only for the first target coding mode and MM-extCCCM but not other variants of the first target coding mode.

In some embodiments, the first target coding mode is not applicable if W<T1 and/or H<T2. Alternatively, the first target coding mode is not applicable, if W+H<T. Alternatively, the first target coding mode is not applicable if W*H<T. Alternatively, the first target coding mode is not applicable if W>T1 and/or H>T2. Alternatively, the first target coding mode is not applicable if W+H>T. Alternatively, the first target coding mode is not applicable if W*H>T. For example, W represents the block width, H represents the block height, T1, T2, and T represent thresholds, respectively.

In some embodiments, a flag is signaled to indicate whether the first target coding mode and/or a variant of the first target coding mode is applied. In some embodiments, the flag is signalled based on a condition.

In some embodiments, the flag is signalled, if another flag indicating CCCM mode is true. Alternatively, or in addition, the flag is not signalled, if CCP merge mode is applied. Alternatively, or in addition, the flag is signaled, if the first target coding mode is applicable.

In some embodiments, whether the first target coding mode or the variant of the first target coding mode is applied depends on signaled mode. In some embodiments, if the signaled mode is CCLM, a flag indicating CCCM mode and the flag are both true, a current block uses the first target coding mode. Alternatively, or in addition, if the signaled mode is MM-CCLM, a flag indicating CCCM mode and the flag are both true are both true, a current block uses MM-extCCCM mode. Alternatively, or in addition, if the signaled mode is CCLM-T, a flag indicating CCCM mode and the flag are both true, a current block uses extCCCM-T mode. Alternatively, or in addition, if the signaled mode is MM-CCLM-T, a flag indicating CCCM mode and the flag are both true, a current block uses MM-extCCCM-T mode. Alternatively, or in addition, if the signaled mode is CCLM-L, a flag indicating CCCM mode and the flag are both true, a current block uses extCCCM-T mode. Alternatively, or in addition, if the signaled mode is MM-CCLM-L, a flag indicating CCCM mode and the flag are both true, a current block uses MM-extCCCM-T mode.

In some embodiments, the first target coding mode is used with merge CCP mode. In some embodiments, the first target coding mode is regarded as a new type in merge CCP mode.

In some embodiments, information and/or parameters of the first target coding mode are stored in blocks. In some other embodiments, information and/or parameters of the first target coding mode are stored in a history table. In some embodiments, stored information and/or parameters of the first target coding mode are used to generate a candidate in a merge CCP candidate list.

In some embodiments, a candidate with a type of the first target coding mode is involved in a candidate list reordering process. Alternatively, or in addition, a candidate with a type of the first target coding mode is involved in a candidate list pruning process. Alternatively, or in addition, a candidate with a type of the first target coding mode is involved in a candidate list offset updating process. Alternatively, or in addition, if a candidate with a type of the first target coding mode is selected, the first target coding mode is used for the current block which is instructed by parameters of the candidate.

In some embodiments, a training process which is same as CCCM is applied to derive parameters of the first target coding mode, but the training process is with different number of parameters. In some embodiments, a region of chroma reconstructed samples and corresponding luma reconstructed samples of the chroma reconstructed samples used by the first target coding mode or a variant of the first target coding mode is the same to that of CCCM or a variant of CCCM. In some other embodiments, a region of chroma reconstructed samples and corresponding luma reconstructed samples of the chroma reconstructed samples used by the first target coding mode or a variant of the first target coding mode is different from that of CCCM or a variant of CCCM.

In some embodiments, the set of reconstructed chroma samples and/or the set of predicted chroma samples are at at least one of: the target position, an above position relative to a target position of a chroma sample to be predicted, a left position relative to the target position, a left-above position relative to the target position, a right-above position relative to the target position, or a left-bottom position relative to the target position. An example is shown in FIG. 40. In some embodiments, predChromaVal(X)=c₀C+c₁N+c₂S+c₃E+c₄W+c₅P+c₆L+c₇Y+c₈Z+c₉R+c₁₀Q+c₁₁B, where predChromaVal(X) represents the chroma sample to be predicted, C represents a luma sample at a position corresponding to the target position, N represents a luma sample at the north position, S represents a luma sample at the south position, E represents a luma sample at the east position, W represents a luma sample at the west position, L represents a chroma sample at the left-above position, Y represents a chroma sample at the above position, Z represents a chroma sample at the left position, R represents a chroma sample at the right-above position, Q represents a chroma sample at the left-bottom position position, P and B represents nonlinear term and bias term, respectively, c₀, c₁, c₂, c₃, c₄, c₅, c₆, c₇, c₈, c₉, c₁₀ and c₁₁ represent parameters. In some embodiments, P=C². Alternatively, or in addition, B=1<<(bitdepth−1).

In some embodiments, predChromaVal(X)=c₀C+c₁N+c₂S+c₃E+c₄W+c₅P+c₆L+c₇Y+c₈Z+c₉B, wherein predChromaVal(X) represents the chroma sample to be predicted, C represents a luma sample at a position corresponding to the target position, N represents a luma sample at the north position, S represents a luma sample at the south position, E represents a luma sample at the east position, W represents a luma sample at the west position, L represents a chroma sample at the left-above position, Y represents a chroma sample at the above position, Z represents a chroma sample at the left position, P and B represents nonlinear term and bias term, respectively, c₀, c₁, c₂, c₃, c₄, c₅, c₆, c₇, c₈, and c₉ represent parameters. In some embodiments, P=C². Alternatively, or in addition, B=1<<(bitdepth−1).

In some embodiments, if one or more chroma samples are unavailable, padding is used to obtain the set of reconstructed chroma samples and/or the set of predicted chroma samples. In some other embodiments, a function with at least one input as an additional chroma sample is involved in the CCP model. For example, the function is a derivation of a gradient, or wherein the function is a non-linear operation.

In some embodiments, the set of luma samples are obtained with down-sampling approaches same as those used in one of: cross-component linear model (CCLM), convolutional cross-component model (CCCM), gradient linear model (GLM), or CCCM using multiple downsampling filters (MF-CCCM). In some other embodiments, the set of luma samples are obtained with down-sampling approaches different as those used in one of: CCLM, CCCM, GLM, or MF-CCCM.

In some embodiments, in response to the video unit is coded with a second target coding mode, the set of reconstructed chroma samples and/or the set of predicted chroma samples are applied in the CCP model. In some embodiments, the second target coding mode is a mix CCCM (mixCCCM) mode.

In some embodiments, the second target coding mode has variants is a same way of CCCM. In some embodiments, the variants of the second target coding mode comprise at least one of: multiple model-mixCCCM (MM-mixCCCM), mixCCCM-left (mixCCCM-L), mixCCCM-top (mixCCCM-T), MM-mixCCCM-L, or MM-mixCCCM-T.

In some embodiments, the second target coding mode and variants of the second target coding mode replace an exiting mode. In some embodiments, the existing mode comprises CCCM and/or variants of the CCCM. In some other embodiments, the second target coding mode is used as an additional mode.

In some embodiments, whether to and/or how to use the second target coding mode depend on coding information of a current block. In some embodiments, the coding information comprises at least one of: a mode of the current block, a mode of a neighbouring block, a mode of a luma block in a collocated region of the current block, a mode of a luma block in a collocated region of a neighbouring block, QP, slice type, picture type, block width, block height, position of the current block, or reconstructed samples.

In some embodiments, the second target coding mode is not applicable, if a gradient and location based convolutional cross-component model (GL-CCCM) is applied. Alternatively, or in addition, the second target coding mode is not applicable, if unsampling CCCM is applied. Alternatively, or in addition, the second target coding mode is not applicable, if MF-CCCM is applied. Alternatively, or in addition, the second target coding mode is not applicable, if inside filtering is applied. Alternatively, or in addition, the second target coding mode is applicable only for the second target coding mode not variants of the second target coding mode. Alternatively, or in addition, the second target coding mode is applicable only for the second target coding mode and MM-mixCCCM but not other variants of the second target coding mode.

In some embodiments, the second target coding mode is not applicable if W<T1 and/or H<T2. Alternatively, the second target coding mode is not applicable, if W+H<T. Alternatively, the second target coding mode is not applicable if W*H<T. Alternatively, the second target coding mode is not applicable if W>T1 and/or H>T2. Alternatively, the second target coding mode is not applicable if W+H>T. Alternatively, the second target coding mode is not applicable if W*H>T. In some embodiments, W represents the block width, H represents the block height, T1, T2, and T represent thresholds, respectively. In some embodiments, the second target coding mode is not applicable, if posX==0 or posY==0, where a top-left position of the current block is (posX, posY).

In some embodiments, a flag is signaled to indicate whether the second target coding mode and/or a variant of the second target coding mode is applied. In some embodiments, the flag is signalled based on a condition.

In some embodiments, the flag is signalled, if another flag indicating CCCM mode is true. In some other embodiments, the flag is not signalled, if CCP merge mode is applied. In some further embodiments, the flag is signaled, if the second target coding mode is applicable.

In some embodiments, whether the second target coding mode or the variant of the second target coding mode is applied depends on signaled mode. In some embodiments, if the signaled mode is CCLM, a flag indicating CCCM mode and the flag are both true, a current block uses the second target coding mode. In some other embodiments, if the signaled mode is MM-CCLM, a flag indicating CCCM mode and the flag are both true are both true, a current block uses MM-mixCCCM mode. In some further embodiments, if the signaled mode is CCLM-T, a flag indicating CCCM mode and the flag are both true, a current block uses mixCCCM-T mode.

In some embodiments, if the signaled mode is MM-CCLM-T, a flag indicating CCCM mode and the flag are both true, a current block uses MM-mixCCCM-T mode. In some other embodiments, if the signaled mode is CCLM-L, a flag indicating CCCM mode and the flag are both true, a current block uses mixCCCM-T mode. In some further embodiments, if the signaled mode is MM-CCLM-L, a flag indicating CCCM mode and the flag are both true, a current block uses MM-mixCCCM-T mode.

In some embodiments, the second target coding mode is used with merge CCP mode. In some embodiments, the second target coding mode is regarded as a new type in merge CCP mode. In some embodiments, information and/or parameters of the second target coding mode are stored in blocks. In some other embodiments, information and/or parameters of the second target coding mode are stored in a history table. In some embodiments, stored information and/or parameters of the second target coding mode are used to generate a candidate in a merge CCP candidate list.

In some embodiments, a candidate with a type of the second target coding mode is involved in a candidate list reordering process. In some other embodiments, a candidate with a type of the second target coding mode is involved in a candidate list pruning process. In some further embodiments, a candidate with a type of the second target coding mode is involved in a candidate list offset updating process. In some embodiments, if a candidate with a type of the second target coding mode is selected, the second target coding mode is used for the current block which is instructed by parameters of the candidate.

In some embodiments, a training process which is same as CCCM is applied to derive parameters of the second target coding mode, but the training process is with different number of parameters. In some embodiments, a region of chroma reconstructed samples and corresponding luma reconstructed samples of the chroma reconstructed samples used by the second target coding mode or a variant of the second target coding mode is the same to that of CCCM or a variant of CCCM.

In some embodiments, a region of chroma reconstructed samples and corresponding luma reconstructed samples of the chroma reconstructed samples used by the second target coding mode or a variant of the second target coding mode is different from that of CCCM or a variant of CCCM. In some embodiments, the region of chroma reconstructed samples and the corresponding luma reconstructed samples used by the second target coding mode or the variant of the second target coding mode is smaller than that of CCCM or the variant of CCCM, wherein a top row and left-most column involved in the CCCM training process are excluded.

In some embodiments, in the training process of the second target coding mode, a reconstructed sample is used as an input value, but not used as a target value. In some embodiments, a reconstructed chroma sample at the left-above position, a reconstructed chroma sample at the above position, and a reconstructed chroma sample at the left position are used input values of the target value but not used as target values in the training process, as shown in FIG. 42.

In some embodiments, in the training process of the second target coding mode, a reconstructed sample is used as an input value and also used as a target value. In some embodiments, a reconstructed chroma sample at the left-above position, a reconstructed chroma sample at the above position, and a reconstructed chroma sample at the left position are used input values of the target value and used as target values in the training process, as shown in FIG. 43.

In some embodiments, if the second target coding tool is applied to predict a chroma sample, a chroma sample input to the CCP model at a specific position is a reconstructed sample or prediction sample. In some embodiments, if the specific position is out of a current block, the reconstructed sample is input.

In some embodiments, if the specific position is in a current block, the prediction sample is input. For example, a prediction sample of a position is obtained by using a mixCCCM model on the position to get the prediction value.

In some embodiments, a chroma sample at the left-above position, a chroma sample at the above position, and a chroma sample at the left position are used as input values to predict the chroma sample. For example, as shown in FIG. 44, the chroma sample at the left-above position, the chroma sample at the above position, and the chroma sample at the left position are all reconstructed samples. Alternatively, as shown in FIG. 45, the chroma sample at the left-above position and the chroma sample at the above position are reconstructed samples, and the chroma sample at the left position is a prediction sample. Alternatively, as shown in FIG. 46, the chroma sample at the left-above position, the chroma sample at the above position, and the chroma sample at the left position are all prediction samples.

In some embodiments, a plurality of extended CCCM modes are applied. In some embodiments, the first target coding mode and the second target coding mode coexist.

In some embodiments, a first flag is signaled to indicate whether a kind of extended CCCM mode is applied. In some embodiments, the first flag is signaled based on a condition. In some embodiments, the first flag is singaled if a flag indicating CCCM mode is true. In some other embodiments, the first flag is not signalled, if CCP merge mode is applied. In some embodiments, the first flag is signaled, if a kind of extended CCCM mode is applicable.

In some embodiments, a second syntax element is signaled to indicate which kind of extended CCCM mode is applied. In some embodiments, the second syntax element is signalled based on a condition. In some embodiments, the second syntax element is signalled, if a first flag indicating whether the kind of extended CCCM mode is applied is true.

In some embodiments, an indication of whether to and/or how to apply at least one of the followings in the CCP model: the set of luma samples, the set of additional luma samples, the set of reconstructed chroma samples or the set of predicted chroma samples is indicated at one of the followings: sequence level, group of pictures level, picture level, slice level, or tile group level.

In some embodiments, an indication of whether to and/or how to apply at least one of the followings in the CCP model: the set of luma samples, the set of additional luma samples, the set of reconstructed chroma samples or the set of predicted chroma samples is indicated in one of the following: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

In some embodiments, an indication of whether to and/or how to apply at least one of the followings in the CCP model: the set of luma samples, the set of additional luma samples, the set of reconstructed chroma samples or the set of predicted chroma samples is included in one of the following: a prediction block (PB), a transform block (TB), a coding block (CB), a prediction unit (PU), a transform unit (TU), a coding unit (CU), a coding tree block (CTB), or a coding tree unit (CTU).

In some embodiments, the method 4700 further comprises: determining, based on coded information of the video unit, whether and/or how to determine apply at least one of the followings in the CCP model: the set of luma samples, the set of additional luma samples, the set of reconstructed chroma samples or the set of predicted chroma samples. The coded information may include at least one of: a block size, a colour format, a single and/or dual tree partitioning, a colour component, a slice type, or a picture type.

In some embodiments, a syntax element (SE) is binarized as one of a flag, a fixed length code, an EG(x) code, a unary code, a truncated unary code, or a truncated binary code. In some embodiments, the SE is signed or unsigned. In some embodiments, the SE is coded with at least one context model. Alternatively, the SE is bypass coded.

In some embodiments, the SE is signaled in a conditional way. In some embodiments, the SE is signaled only if a corresponding function is applicable. Alternatively, the SE is signaled only if dimensions of the video unit satisfy a condition.

In some embodiments, the SE is indicated at one of the followings: sequence level, group of pictures level, picture level, slice level, or tile group level. In some embodiments, the SE is indicated at one of the followings: a prediction block (PB), a transform block (TB), a coding block (CB), a prediction unit (PU), a transform unit (TU), a coding unit (CU), a coding tree block (CTB), or a coding tree unit (CTU).

In some embodiments, the video unit is applied with other coding tools which require chroma fusion.

According to further embodiments of the present disclosure, a non-transitory computer-readable recording medium is provided. The non-transitory computer-readable recording medium stores a bitstream of a video which is generated by a method performed by an apparatus for video processing. The method comprises: applying at least one of the followings in a cross-component prediction (CCP) model: a set of luma samples, a set of additional luma samples, a set of reconstructed chroma samples, or a set of predicted chroma samples; determining a prediction or reconstruction of a video unit of the video by applying the CCP model to the video unit; and generating the bitstream based on the prediction or reconstruction.

According to still further embodiments of the present disclosure, a method for storing bitstream of a video is provided. The method comprises: applying at least one of the followings in a cross-component prediction (CCP) model: a set of luma samples, a set of additional luma samples, a set of reconstructed chroma samples, or a set of predicted chroma samples; determining a prediction or reconstruction of a video unit of the video by applying the CCP model to the video unit; generating the bitstream based on the prediction or reconstruction; and storing the bitstream in a non-transitory computer-readable recording medium.

Implementations of the present disclosure can be described in view of the following clauses, the features of which can be combined in any reasonable manner.

Clause 1. A method of video processing, comprising: applying, for a conversion between a video unit of a video and a bitstream of the video unit, at least one of the followings in a cross-component prediction (CCP) model: a set of luma samples, a set of additional luma samples, a set of reconstructed chroma samples, or a set of predicted chroma samples; determining a prediction or reconstruction of the video unit by applying the CCP model to the video unit; and performing the conversion based on the prediction or reconstruction.

Clause 2. The method of clause 1, wherein luma positions used in the CCP model are after down-sampling for a colour format.

Clause 3. The method of clause 1, wherein the set of additional luma samples are at positions which are beyond a center position corresponding to a chroma sample to be predicted, a north position relative to the center position, a west position relative to the center position, an east position relative to the center position and a south position relative to the center position.

Clause 4. The method of clause 3, wherein the set of additional luma samples are at at least one of the following positions relative to the center position: a north west position, a north east position, a south west position, or a south east position.

Clause 5. The method of clause 4, wherein predChromaVal=c₀C+c₁N+c₂S+c₃E+c₄W+c₅P+c₆NW+c₇NE+c₈SW+c₉SE+c₁₀B, wherein predChromaVal represents a chroma sample to be predicted, C represents a luma sample at the center position, N represents a luma sample at the north position, S represents a luma sample at the south position, E represents a luma sample at the east position, W represents a luma sample at the west position, NW represents a luma sample at the north west position, NE represents a luma sample at the north east position, SW represents a luma sample at the south west position, SE represents a luma sample at the south east position, P and B represents nonlinear term and bias term, respectively, c₀, c₁, c₂, c₃, c₄, c₅, c₆, c₇, c₈, c₉ and c₁₀ represent parameters.

Clause 6. The method of clause 5, wherein P=C² and/or B=1<<(bitdepth−1).

Clause 7. The method of clause 3, wherein the set of additional luma samples are at a position non-adjacent to the center position.

Clause 8. The method of clause 7, wherein predChromaVal=c₀C+c₁N+c₂S+c₃E+c₄W+c₅P+c₆NW+c₇NE+c₈SW+c₉SE+c₁₀N2+c₁₁S2+c₁₂E2+c₁₃W2+c₁₄B, wherein predChromaVal represents a chroma sample to be predicted, C represents a luma sample at the center position, N represents a luma sample at the north position, S represents a luma sample at the south position, E represents a luma sample at the east position, W represents a luma sample at the west position, NW represents a luma sample at the north west position, NE represents a luma sample at the north east position, SW represents a luma sample at the south west position, SE represents a luma sample at the south east position, N2, S2, E2 and W2 represent luma samples at non-adjacent positions to the center position, respectively, P and B represents nonlinear term and bias term, respectively, c₀, c₁, c₂, c₃, c₄, c₅, c₆, c₇, c₈, c₉, c₁₀, c₁₁, c₁₂, c₁₃ and c₁₄ represent parameters.

Clause 9. The method of clause 8, wherein P=C² and/or B=1<<(bitdepth−1).

Clause 10. The method of clause 1, wherein if one or more luma samples are unavailable, padding is used to obtain the set of additional luma samples.

Clause 11. The method of clause 1, wherein a function with at least one input as an additional luma sample is involved in the CCP model.

Clause 12. The method of clause 11, wherein the function is a derivation of a gradient.

Clause 13. The method of clause 1, wherein the set of luma samples and the set of additional luma samples are obtained with down-sampling approaches same as those used in one of: cross-component linear model (CCLM), convolutional cross-component model (CCCM), gradient linear model (GLM), or CCCM using multiple downsampling filters (MF-CCCM).

Clause 14. The method of clause 1, wherein the set of luma samples and the set of additional luma samples are obtained with down-sampling approaches different from those used in one of: CCLM, CCCM, GLM, or MF-CCCM.

Clause 15. The method of clause 1, wherein in response to the video unit is coded with a first target coding mode, the set of luma samples and the set of additional luma samples are applied in the CCP model.

Clause 16. The method of clause 15, wherein the first target coding mode is an extended CCCM (extCCCM) mode.

Clause 17. The method of clause 15, wherein the first target coding mode has variants is a same way of CCCM.

Clause 18. The method of clause 17, wherein the variants of the first target coding mode comprise at least one of: multiple model-extCCCM (MM-extCCCM), extCCCM-left (extCCCM-L), extCCCM-top (extCCCM-T), MM-extCCCM-L, or MM-extCCCM-T.

Clause 19. The method of clause 15, wherein the first target coding mode and variants of the first target coding mode replace an exiting mode.

Clause 20. The method of clause 19, wherein the existing mode comprises CCCM and/or variants of the CCCM.

Clause 21. The method of clause 15, wherein the first target coding mode is used as an additional mode.

Clause 22. The method of clause 15, wherein whether to and/or how to use the first target coding mode depend on coding information of a current block.

Clause 23. The method of clause 22, wherein the coding information comprises at least one of: a mode of the current block, a mode of a neighbouring block, a mode of a luma block in a collocated region of the current block, a mode of a luma block in a collocated region of a neighbouring block, quantization parameter (QP), slice type, picture type, block width, block height, position of the current block, or reconstructed samples.

Clause 24. The method of clause 23, wherein the first target coding mode is not applicable, if a gradient and location based convolutional cross-component model (GL-CCCM) is applied, and/or wherein the first target coding mode is not applicable, if unsampling CCCM is applied, and/or wherein the first target coding mode is not applicable, if MF-CCCM is applied, and/or wherein the first target coding mode is not applicable, if inside filtering is applied, and/or wherein the first target coding mode is applicable only for the first target coding mode not variants of the first target coding mode, and/or wherein the first target coding mode is applicable only for the first target coding mode and MM-extCCCM but not other variants of the first target coding mode.

Clause 25. The method of clause 23, wherein the first target coding mode is not applicable if W<T1 and/or H<T2, or wherein the first target coding mode is not applicable, if W+H<T, or wherein the first target coding mode is not applicable if W*H<T, or wherein the first target coding mode is not applicable if W>T1 and/or H>T2, or wherein the first target coding mode is not applicable if W+H>T, or wherein the first target coding mode is not applicable if W*H>T, and wherein W represents the block width, H represents the block height, T1, T2, and T represent thresholds, respectively.

Clause 26. The method of clause 15, wherein a flag is signaled to indicate whether the first target coding mode and/or a variant of the first target coding mode is applied.

Clause 27. The method of clause 26, wherein the flag is signalled based on a condition.

Clause 28. The method of clause 26, wherein the flag is signalled, if another flag indicating CCCM mode is true.

Clause 29. The method of clause 26, wherein the flag is not signalled, if CCP merge mode is applied.

Clause 30. The method of clause 26, wherein the flag is signaled, if the first target coding mode is applicable.

Clause 31. The method of clause 26, wherein whether the first target coding mode or the variant of the first target coding mode is applied depends on signaled mode.

Clause 32. The method of clause 31, wherein if the signaled mode is CCLM, a flag indicating CCCM mode and the flag are both true, a current block uses the first target coding mode.

Clause 33. The method of clause 31, wherein if the signaled mode is MM-CCLM, a flag indicating CCCM mode and the flag are both true are both true, a current block uses MM-extCCCM mode.

Clause 34. The method of clause 31, wherein if the signaled mode is CCLM-T, a flag indicating CCCM mode and the flag are both true, a current block uses extCCCM-T mode.

Clause 35. The method of clause 31, wherein if the signaled mode is MM-CCLM-T, a flag indicating CCCM mode and the flag are both true, a current block uses MM-extCCCM-T mode.

Clause 36. The method of clause 31, wherein if the signaled mode is CCLM-L, a flag indicating CCCM mode and the flag are both true, a current block uses extCCCM-T mode.

Clause 37. The method of clause 31, wherein if the signaled mode is MM-CCLM-L, a flag indicating CCCM mode and the flag are both true, a current block uses MM-extCCCM-T mode.

Clause 38. The method of clause 15, wherein the first target coding mode is used with merge CCP mode.

Clause 39. The method of clause 38, wherein the first target coding mode is regarded as a new type in merge CCP mode.

Clause 40. The method of clause 38, wherein information and/or parameters of the first target coding mode are stored in blocks.

Clause 41. The method of clause 38, wherein information and/or parameters of the first target coding mode are stored in a history table.

Clause 42. The method of clause 38, wherein stored information and/or parameters of the first target coding mode are used to generate a candidate in a merge CCP candidate list.

Clause 43. The method of clause 38, wherein a candidate with a type of the first target coding mode is involved in a candidate list reordering process.

Clause 44. The method of clause 38, wherein a candidate with a type of the first target coding mode is involved in a candidate list pruning process.

Clause 45. The method of clause 38, wherein a candidate with a type of the first target coding mode is involved in a candidate list offset updating process.

Clause 46. The method of clause 38, wherein if a candidate with a type of the first target coding mode is selected, the first target coding mode is used for the current block which is instructed by parameters of the candidate.

Clause 47. The method of clause 15, wherein a training process which is same as CCCM is applied to derive parameters of the first target coding mode, but the training process is with different number of parameters.

Clause 48. The method of clause 47, wherein a region of chroma reconstructed samples and corresponding luma reconstructed samples of the chroma reconstructed samples used by the first target coding mode or a variant of the first target coding mode is the same to that of CCCM or a variant of CCCM.

Clause 49. The method of clause 47, wherein a region of chroma reconstructed samples and corresponding luma reconstructed samples of the chroma reconstructed samples used by the first target coding mode or a variant of the first target coding mode is different from that of CCCM or a variant of CCCM.

Clause 50. The method of clause 1, wherein the set of reconstructed chroma samples and/or the set of predicted chroma samples are at least one of: the target position, an above position relative to a target position of a chroma sample to be predicted, a left position relative to the target position, a left-above position relative to the target position, a right-above position relative to the target position, or a left-bottom position relative to the target position.

Clause 51. The method of clause 50, wherein predChromaVal(X)=c₀C+c₁N+c₂S+c₃E+c₄W+c₅P+c₆L+c₇Y+c₈Z+c₉R+c₁₀Q+c₁₁B, wherein predChromaVal(X) represents the chroma sample to be predicted, C represents a luma sample at a position corresponding to the target position, N represents a luma sample at the north position, S represents a luma sample at the south position, E represents a luma sample at the east position, W represents a luma sample at the west position, L represents a chroma sample at the left-above position, Y represents a chroma sample at the above position, Z represents a chroma sample at the left position, R represents a chroma sample at the right-above position, Q represents a chroma sample at the left-bottom position position, P and B represents nonlinear term and bias term, respectively, c₀, c₁, c₂, c₃, c₄, c₅, c₆, c₇, c₈, c₉, c₁₀ and c₁₁ represent parameters.

Clause 52. The method of clause 51, wherein P=C² and/or B=1<<(bitdepth−1).

Clause 53. The method of clause 50, wherein predChromaVal(X)=c₀C+c₁N+c₂S+c₃E+c₄W+c₅P+c₆L+c₇Y+c₈Z+c₉B, wherein predChromaVal(X) represents the chroma sample to be predicted, C represents a luma sample at a position corresponding to the target position, N represents a luma sample at the north position, S represents a luma sample at the south position, E represents a luma sample at the east position, W represents a luma sample at the west position, L represents a chroma sample at the left-above position, Y represents a chroma sample at the above position, Z represents a chroma sample at the left position, P and B represents nonlinear term and bias term, respectively, c₀, c₁, c₂, c₃, c₄, c₅, c₆, c₇, c₈, and c₉ represent parameters.

Clause 54. The method of clause 53, wherein P=C² and/or B=1<<(bitdepth−1).

Clause 55. The method of clause 1, wherein if one or more chroma samples are unavailable, padding is used to obtain the set of reconstructed chroma samples and/or the set of predicted chroma samples.

Clause 56. The method of clause 1, wherein a function with at least one input as an additional chroma sample is involved in the CCP model.

Clause 57. The method of clause 56, wherein the function is a derivation of a gradient, or wherein the function is a non-linear operation.

Clause 58. The method of clause 1, wherein the set of luma samples are obtained with down-sampling approaches same as those used in one of: cross-component linear model (CCLM), convolutional cross-component model (CCCM), gradient linear model (GLM), or CCCM using multiple downsampling filters (MF-CCCM).

Clause 59. The method of clause 1, wherein the set of luma samples are obtained with down-sampling approaches different from those used in one of: CCLM, CCCM, GLM, or MF-CCCM.

Clause 60. The method of clause 1, wherein in response to the video unit is coded with a second target coding mode, the set of reconstructed chroma samples and/or the set of predicted chroma samples are applied in the CCP model.

Clause 61. The method of clause 60, wherein the second target coding mode is a mix CCCM (mixCCCM) mode.

Clause 62. The method of clause 60, wherein the second target coding mode has variants is a same way of CCCM.

Clause 63. The method of clause 62, wherein the variants of the second target coding mode comprise at least one of: multiple model-mixCCCM (MM-mixCCCM), mixCCCM-left (mixCCCM-L), mixCCCM-top (mixCCCM-T), MM-mixCCCM-L, or MM-mixCCCM-T.

Clause 64. The method of clause 60, wherein the second target coding mode and variants of the second target coding mode replace an exiting mode.

Clause 65. The method of clause 64, wherein the existing mode comprises CCCM and/or variants of the CCCM.

Clause 66. The method of clause 60, wherein the second target coding mode is used as an additional mode.

Clause 67. The method of clause 60, wherein whether to and/or how to use the second target coding mode depend on coding information of a current block.

Clause 68. The method of clause 67, wherein the coding information comprises at least one of: a mode of the current block, a mode of a neighbouring block, a mode of a luma block in a collocated region of the current block, a mode of a luma block in a collocated region of a neighbouring block, QP, slice type, picture type, block width, block height, position of the current block, or reconstructed samples.

Clause 69. The method of clause 68, wherein the second target coding mode is not applicable, if a gradient and location based convolutional cross-component model (GL-CCCM) is applied, and/or wherein the second target coding mode is not applicable, if unsampling CCCM is applied, and/or wherein the second target coding mode is not applicable, if MF-CCCM is applied, and/or wherein the second target coding mode is not applicable, if inside filtering is applied, and/or wherein the second target coding mode is applicable only for the second target coding mode not variants of the second target coding mode, and/or wherein the second target coding mode is applicable only for the second target coding mode and MM-mixCCCM but not other variants of the second target coding mode.

Clause 70. The method of clause 68, wherein the second target coding mode is not applicable if W<T1 and/or H<T2, or wherein the second target coding mode is not applicable, if W+H<T, or wherein the second target coding mode is not applicable if W*H<T, or wherein the second target coding mode is not applicable if W>T1 and/or H>T2, or wherein the second target coding mode is not applicable if W+H>T, or wherein the second target coding mode is not applicable if W*H>T, and wherein W represents the block width, H represents the block height, T1, T2, and T represent thresholds, respectively.

Clause 71. The method of clause 68, wherein the second target coding mode is not applicable, if posX==0 or posY==0, wherein a top-left position of the current block is (posX, posY).

Clause 72. The method of clause 60, wherein a flag is signaled to indicate whether the second target coding mode and/or a variant of the second target coding mode is applied.

Clause 73. The method of clause 72, wherein the flag is signalled based on a condition.

Clause 74. The method of clause 72, wherein the flag is signalled, if another flag indicating CCCM mode is true.

Clause 75. The method of clause 72, wherein the flag is not signalled, if CCP merge mode is applied.

Clause 76. The method of clause 72, wherein the flag is signaled, if the second target coding mode is applicable.

Clause 77. The method of clause 72, wherein whether the second target coding mode or the variant of the second target coding mode is applied depends on signaled mode.

Clause 78. The method of clause 77, wherein if the signaled mode is CCLM, a flag indicating CCCM mode and the flag are both true, a current block uses the second target coding mode.

Clause 79. The method of clause 77, wherein if the signaled mode is MM-CCLM, a flag indicating CCCM mode and the flag are both true are both true, a current block uses MM-mixCCCM mode.

Clause 80. The method of clause 77, wherein if the signaled mode is CCLM-T, a flag indicating CCCM mode and the flag are both true, a current block uses mixCCCM-T mode.

Clause 81. The method of clause 77, wherein if the signaled mode is MM-CCLM-T, a flag indicating CCCM mode and the flag are both true, a current block uses MM-mixCCCM-T mode.

Clause 82. The method of clause 77, wherein if the signaled mode is CCLM-L, a flag indicating CCCM mode and the flag are both true, a current block uses mixCCCM-T mode.

Clause 83. The method of clause 77, wherein if the signaled mode is MM-CCLM-L, a flag indicating CCCM mode and the flag are both true, a current block uses MM-mixCCCM-T mode.

Clause 84. The method of clause 60, wherein the second target coding mode is used with merge CCP mode.

Clause 85. The method of clause 84, wherein the second target coding mode is regarded as a new type in merge CCP mode.

Clause 86. The method of clause 84, wherein information and/or parameters of the second target coding mode are stored in blocks.

Clause 87. The method of clause 84, wherein information and/or parameters of the second target coding mode are stored in a history table.

Clause 88. The method of clause 84, wherein stored information and/or parameters of the second target coding mode are used to generate a candidate in a merge CCP candidate list.

Clause 89. The method of clause 84, wherein a candidate with a type of the second target coding mode is involved in a candidate list reordering process.

Clause 90. The method of clause 84, wherein a candidate with a type of the second target coding mode is involved in a candidate list pruning process.

Clause 91. The method of clause 84, wherein a candidate with a type of the second target coding mode is involved in a candidate list offset updating process.

Clause 92. The method of clause 84, wherein if a candidate with a type of the second target coding mode is selected, the second target coding mode is used for the current block which is instructed by parameters of the candidate.

Clause 93. The method of clause 60, wherein a training process which is same as CCCM is applied to derive parameters of the second target coding mode, but the training process is with different number of parameters.

Clause 94. The method of clause 93, wherein a region of chroma reconstructed samples and corresponding luma reconstructed samples of the chroma reconstructed samples used by the second target coding mode or a variant of the second target coding mode is the same to that of CCCM or a variant of CCCM.

Clause 95. The method of clause 93, wherein a region of chroma reconstructed samples and corresponding luma reconstructed samples of the chroma reconstructed samples used by the second target coding mode or a variant of the second target coding mode is different from that of CCCM or a variant of CCCM.

Clause 96. The method of clause 95, wherein the region of chroma reconstructed samples and the corresponding luma reconstructed samples used by the second target coding mode or the variant of the second target coding mode is smaller than that of CCCM or the variant of CCCM, wherein a top row and left-most column involved in the CCCM training process are excluded.

Clause 97. The method of clause 93, wherein in the training process of the second target coding mode, a reconstructed sample is used as an input value, but not used as a target value.

Clause 98. The method of clause 97, wherein a reconstructed chroma sample at the left-above position, a reconstructed chroma sample at the above position, and a reconstructed chroma sample at the left position are used input values of the target value but not used as target values in the training process.

Clause 99. The method of clause 93, wherein in the training process of the second target coding mode, a reconstructed sample is used as an input value and also used as a target value.

Clause 100. The method of clause 99, wherein a reconstructed chroma sample at the left-above position, a reconstructed chroma sample at the above position, and a reconstructed chroma sample at the left position are used input values of the target value and used as target values in the training process.

Clause 101. The method of clause 60, wherein if the second target coding tool is applied to predict a chroma sample, a chroma sample input to the CCP model at a specific position is a reconstructed sample or prediction sample.

Clause 102. The method of clause 101, wherein if the specific position is out of a current block, the reconstructed sample is input.

Clause 103. The method of clause 101, wherein if the specific position is in a current block, the prediction sample is input.

Clause 104. The method of clause 103, wherein a prediction sample of a position is obtained by using a mixCCCM model on the position to get the prediction value.

Clause 105. The method of clause 101, wherein a chroma sample at the left-above position, a chroma sample at the above position, and a chroma sample at the left position are used as input values to predict the chroma sample, and wherein the chroma sample at the left-above position, the chroma sample at the above position, and the chroma sample at the left position are all reconstructed samples, or wherein the chroma sample at the left-above position and the chroma sample at the above position are reconstructed samples, and the chroma sample at the left position is a prediction sample, or wherein he chroma sample at the left-above position, the chroma sample at the above position, and the chroma sample at the left position are all prediction samples.

Clause 106. The method of any of clauses 1-105, wherein a plurality of extended CCCM modes are applied.

Clause 107. The method of clause 106, wherein the first target coding mode and the second target coding mode coexist.

Clause 108. The method of clause 106, wherein a first flag is signaled to indicate whether a kind of extended CCCM mode is applied.

Clause 109. The method of clause 108, wherein the first flag is signaled based on a condition.

Clause 110. The method of clause 109, wherein the first flag is singaled if a flag indicating CCCM mode is true.

Clause 111. The method of clause 109, wherein the first flag is not signalled, if CCP merge mode is applied.

Clause 112. The method of clause 109, wherein the first flag is signaled, if a kind of extended CCCM mode is applicable.

Clause 113. The method of clause 106, wherein a second syntax element is signaled to indicate which kind of extended CCCM mode is applied.

Clause 114. The method of clause 113, wherein the second syntax element is signalled based on a condition.

Clause 115. The method of clause 114, wherein the second syntax element is signalled, if a first flag indicating whether the kind of extended CCCM mode is applied is true.

Clause 116. The method of any of clauses 1-115, wherein an indication of whether to and/or how to apply at least one of the followings in the CCP model: the set of luma samples, the set of additional luma samples, the set of reconstructed chroma samples or the set of predicted chroma samples is indicated at one of the followings: sequence level, group of pictures level, picture level, slice level, or tile group level.

Clause 117. The method of any of clauses 1-115, wherein an indication of whether to and/or how to apply at least one of the followings in the CCP model: the set of luma samples, the set of additional luma samples, the set of reconstructed chroma samples or the set of predicted chroma samples is indicated in one of the following: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

Clause 118. The method of any of clauses 1-115, wherein an indication of whether to and/or how to apply at least one of the followings in the CCP model: the set of luma samples, the set of additional luma samples, the set of reconstructed chroma samples or the set of predicted chroma samples is included in one of the following: a prediction block (PB), a transform block (TB), a coding block (CB), a prediction unit (PU), a transform unit (TU), a coding unit (CU), a coding tree block (CTB), or a coding tree unit (CTU).

Clause 119. The method of any of clauses 1-115, further comprising: determining, based on coded information of the video unit, whether and/or how to determine apply at least one of the followings in the CCP model: the set of luma samples, the set of additional luma samples, the set of reconstructed chroma samples or the set of predicted chroma samples, the coded information including at least one of: a block size, a colour format, a single and/or dual tree partitioning, a colour component, a slice type, or a picture type.

Clause 120. The method of any of clauses 1-119, wherein a syntax element (SE) is binarized as one of a flag, a fixed length code, an EG(x) code, a unary code, a truncated unary code, or a truncated binary code.

Clause 121. The method of clause 120, wherein the SE is signed or unsigned.

Clause 122. The method of any of clauses 1-121, wherein the SE is coded with at least one context model, or wherein the SE is bypass coded.

Clause 123. The method of any of clauses 1-121, wherein the SE is signaled in a conditional way.

Clause 124. The method of clause 123, wherein the SE is signaled only if a corresponding function is applicable, or wherein the SE is signaled only if dimensions of the video unit satisfy a condition.

Clause 125. The method of any of clauses 1-124, wherein the SE is indicated at one of the followings: sequence level, group of pictures level, picture level, slice level, or tile group level.

Clause 126. The method of any of clauses 1-124, wherein the SE is indicated at one of the followings: a prediction block (PB), a transform block (TB), a coding block (CB), a prediction unit (PU), a transform unit (TU), a coding unit (CU), a coding tree block (CTB), or a coding tree unit (CTU).

Clause 127. The method of any of clauses 1-126, wherein the video unit is applied with other coding tools which require chroma fusion.

Clause 128. The method of any of clauses 1-127, wherein the conversion includes encoding the video unit into the bitstream.

Clause 129. The method of any of clauses 1-127, wherein the conversion includes decoding the video unit from the bitstream.

Clause 130. An apparatus for video processing comprising a processor and a non-transitory memory with instructions thereon, wherein the instructions upon execution by the processor, cause the processor to perform a method in accordance with any of clauses 1-129.

Clause 131. A non-transitory computer-readable storage medium storing instructions that cause a processor to perform a method in accordance with any of clauses 1-129.

Clause 132. A non-transitory computer-readable recording medium storing a bitstream of a video which is generated by a method performed by an apparatus for video processing, wherein the method comprises: applying at least one of the followings in a cross-component prediction (CCP) model: a set of luma samples, a set of additional luma samples, a set of reconstructed chroma samples, or a set of predicted chroma samples; determining a prediction or reconstruction of a video unit of the video by applying the CCP model to the video unit; and generating the bitstream based on the prediction or reconstruction.

Clause 133. A method for storing a bitstream of a video, comprising: applying at least one of the followings in a cross-component prediction (CCP) model: a set of luma samples, a set of additional luma samples, a set of reconstructed chroma samples, or a set of predicted chroma samples; determining a prediction or reconstruction of a video unit of the video by applying the CCP model to the video unit; generating the bitstream based on the prediction or reconstruction; and storing the bitstream in a non-transitory computer-readable recording medium.

### Example Device

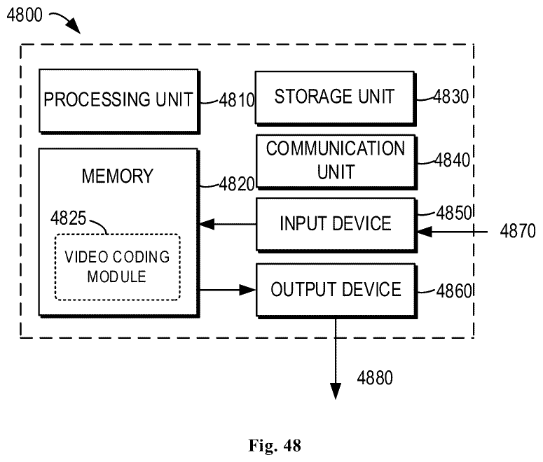

FIG. 48 illustrates a block diagram of a computing device 4800 in which various embodiments of the present disclosure can be implemented. The computing device 4800 may be implemented as or included in the source device 110 (or the video encoder 114 or 200) or the destination device 120 (or the video decoder 124 or 300).

It would be appreciated that the computing device 4800 shown in FIG. 48 is merely for purpose of illustration, without suggesting any limitation to the functions and scopes of the embodiments of the present disclosure in any manner.

As shown in FIG. 48, the computing device 4800 includes a general-purpose computing device 4800. The computing device 4800 may at least comprise one or more processors or processing units 4810, a memory 4820, a storage unit 4830, one or more communication units 4840, one or more input devices 4850, and one or more output devices 4860.

In some embodiments, the computing device 4800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 4800 can support any type of interface to a user (such as “wearable” circuitry and the like).

The processing unit 4810 may be a physical or virtual processor and can implement various processes based on programs stored in the memory 4820. In a multi-processor system, multiple processing units execute computer executable instructions in parallel so as to improve the parallel processing capability of the computing device 4800. The processing unit 4810 may also be referred to as a central processing unit (CPU), a microprocessor, a controller or a microcontroller.

The computing device 4800 typically includes various computer storage medium. Such medium can be any medium accessible by the computing device 4800, including, but not limited to, volatile and non-volatile medium, or detachable and non-detachable medium. The memory 4820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 4830 may be any detachable or non-detachable medium and may include a machine-readable medium such as a memory, flash memory drive, magnetic disk or another other media, which can be used for storing information and/or data and can be accessed in the computing device 4800.

The computing device 4800 may further include additional detachable/non-detachable, volatile/non-volatile memory medium. Although not shown in FIG. 48, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 4840 communicates with a further computing device via the communication medium. In addition, the functions of the components in the computing device 4800 can be implemented by a single computing cluster or multiple computing machines that can communicate via communication connections. Therefore, the computing device 4800 can operate in a networked environment using a logical connection with one or more other servers, networked personal computers (PCs) or further general network nodes.

The input device 4850 may be one or more of a variety of input devices, such as a mouse, keyboard, tracking ball, voice-input device, and the like. The output device 4860 may be one or more of a variety of output devices, such as a display, loudspeaker, printer, and the like. By means of the communication unit 4840, the computing device 4800 can further communicate with one or more external devices (not shown) such as the storage devices and display device, with one or more devices enabling the user to interact with the computing device 4800, or any devices (such as a network card, a modem and the like) enabling the computing device 4800 to communicate with one or more other computing devices, if required. Such communication can be performed via input/output (I/O) interfaces (not shown).

In some embodiments, instead of being integrated in a single device, some or all components of the computing device 4800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 4800 may be used to implement video encoding/decoding in embodiments of the present disclosure. The memory 4820 may include one or more video coding modules 4825 having one or more program instructions. These modules are accessible and executable by the processing unit 4810 to perform the functionalities of the various embodiments described herein.

In the example embodiments of performing video encoding, the input device 4850 may receive video data as an input 4870 to be encoded. The video data may be processed, for example, by the video coding module 4825, to generate an encoded bitstream. The encoded bitstream may be provided via the output device 4860 as an output 4880.

In the example embodiments of performing video decoding, the input device 4850 may receive an encoded bitstream as the input 4870. The encoded bitstream may be processed, for example, by the video coding module 4825, to generate decoded video data. The decoded video data may be provided via the output device 4860 as the output 4880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
applying, for a conversion between a video unit of a video and a bitstream of the video unit, at least one of the following in a cross-component prediction (CCP) model: a set of luma samples or a set of additional luma samples;
determining a prediction or reconstruction of the video unit by applying the CCP model to the video unit; and
performing the conversion based on the prediction or reconstruction.

2. The method of claim 1, wherein luma positions used in the CCP model are after down-sampling for a colour format.

3. The method of claim 1, wherein the set of additional luma samples are at positions which are beyond a center position corresponding to a chroma sample to be predicted, a north position relative to the center position, a west position relative to the center position, an east position relative to the center position and a south position relative to the center position.

4. The method of claim 3, wherein the set of additional luma samples are at least one of the following positions relative to the center position: a north west position, a north east position, a south west position, or a south east position, or
wherein the set of additional luma samples are at a position non-adjacent to the center position.

5. The method of claim 4, wherein predChromaVal=c₀C+c₁N+c₂S+c₃E+c₄W+C₅P+c₆NW+c₇NE+c₈SW+c₉SE+c₁₀B, wherein predChromaVal represents a chroma sample to be predicted, C represents a luma sample at the center position, N represents a luma sample at the north position, S represents a luma sample at the south position, E represents a luma sample at the east position, W represents a luma sample at the west position, NW represents a luma sample at the north west position, NE represents a luma sample at the north east position, SW represents a luma sample at the south west position, SE represents a luma sample at the south east position, P and B represents nonlinear term and bias term, respectively, c₀, c₁, c₂, c₃, c₄, C₅, c₆, c₇, C₈, C₉ and c₁₀ represent parameters, or
wherein predChromaVal=c₀C+c₁N+c₂S+c₃E+c₄W+C₅P+c₆NW+c₇NE+c₈SW+c₉SE+c₁₀N2+C₁₁S2+c₁₂E2+c₁₃W2+c₁₄B, wherein predChromaVal represents a chroma sample to be predicted, C represents a luma sample at the center position, N represents a luma sample at the north position, S represents a luma sample at the south position, E represents a luma sample at the east position, W represents a luma sample at the west position, NW represents a luma sample at the north west position, NE represents a luma sample at the north east position, SW represents a luma sample at the south west position, SE represents a luma sample at the south east position, N2, S2, E2 and W2 represent luma samples at non-adjacent positions to the center position, respectively, P and B represents nonlinear term and bias term, respectively, c₀, c₁, c₂, c₃, c₄, c₅, c₆, c₇, c₈, c₉, c₁₀, c₁₁, c₁₂, c₁₃ and c₁₄ represent parameters.

6. The method of claim 5, wherein P=C² and/or B=1<<(bitdepth−1).

7. The method of claim 1, wherein if one or more luma samples are unavailable, padding is used to obtain the set of additional luma samples.

8. The method of claim 1, wherein a function with at least one input as an additional luma sample is involved in the CCP model.

9. The method of claim 8, wherein the function is a derivation of a gradient.

10. The method of claim 1, wherein the set of luma samples and the set of additional luma samples are obtained with down-sampling approaches same as those used in one of: cross-component linear model (CCLM), convolutional cross-component model (CCCM), gradient linear model (GLM), or CCCM using multiple downsampling filters (MF-CCCM).

11. The method of claim 1, wherein the set of luma samples and the set of additional luma samples are obtained with down-sampling approaches different from those used in one of: CCLM, CCCM, GLM, or MF-CCCM.

12. The method of claim 1, wherein in response to the video unit is coded with a first target coding mode, the set of luma samples and the set of additional luma samples are applied in the CCP model.

13. The method of claim 12, wherein the first target coding mode is an extended CCCM (extCCCM) mode, and/or
wherein the first target coding mode has variants is a same way of CCCM, and/or
wherein the first target coding mode and variants of the first target coding mode replace an exiting mode, and/or
wherein the first target coding mode is used as an additional mode, and/or
wherein whether to and/or how to use the first target coding mode depend on coding information of a current block, and/or
wherein a flag is signaled to indicate whether the first target coding mode and/or a variant of the first target coding mode is applied, and/or
wherein the first target coding mode is used with merge CCP mode, and/or
wherein a training process which is same as CCCM is applied to derive parameters of the first target coding mode, but the training process is with different number of parameters.

14. The method of claim 13, wherein the variants of the first target coding mode comprise at least one of: multiple model-extCCCM (MM-extCCCM), extCCCM-left (extCCCM-L), extCCCM-top (extCCCM-T), MM-extCCCM-L, or MM-extCCCM-T, and/or
wherein the existing mode comprises CCCM and/or variants of the CCCM, and/or
wherein the coding information comprises at least one of: a mode of the current block, a mode of a neighbouring block, a mode of a luma block in a collocated region of the current block, a mode of a luma block in a collocated region of a neighbouring block, quantization parameter (QP), slice type, picture type, block width, block height, position of the current block, or reconstructed samples, and/or
wherein the flag is signalled based on a condition, and/or
wherein the flag is signalled, if another flag indicating CCCM mode is true, and/or
wherein the flag is not signalled, if CCP merge mode is applied, and/or
wherein the flag is signaled, if the first target coding mode is applicable, and/or
wherein whether the first target coding mode or the variant of the first target coding mode is applied depends on signaled mode, and/or
wherein the first target coding mode is regarded as a new type in merge CCP mode, and/or
wherein information and/or parameters of the first target coding mode are stored in blocks, and/or
wherein information and/or parameters of the first target coding mode are stored in a history table, and/or
wherein stored information and/or parameters of the first target coding mode are used to generate a candidate in a merge CCP candidate list, and/or
wherein a candidate with a type of the first target coding mode is involved in a candidate list reordering process, and/or
wherein a candidate with a type of the first target coding mode is involved in a candidate list pruning process, and/or
wherein a candidate with a type of the first target coding mode is involved in a candidate list offset updating process, and/or
wherein if a candidate with a type of the first target coding mode is selected, the first target coding mode is used for the current block which is instructed by parameters of the candidate, and/or
wherein a region of chroma reconstructed samples and corresponding luma reconstructed samples of the chroma reconstructed samples used by the first target coding mode or a variant of the first target coding mode is the same to that of CCCM or a variant of CCCM, and/or
wherein a region of chroma reconstructed samples and corresponding luma reconstructed samples of the chroma reconstructed samples used by the first target coding mode or a variant of the first target coding mode is different from that of CCCM or a variant of CCCM.

15. The method of claim 14, wherein the first target coding mode is not applicable, if a gradient and location based convolutional cross-component model (GL-CCCM) is applied, and/or
wherein the first target coding mode is not applicable, if unsampling CCCM is applied, and/or
wherein the first target coding mode is not applicable, if MF-CCCM is applied, and/or
wherein the first target coding mode is not applicable, if inside filtering is applied, and/or
wherein the first target coding mode is applicable only for the first target coding mode not variants of the first target coding mode, and/or
wherein the first target coding mode is applicable only for the first target coding mode and MM-extCCCM but not other variants of the first target coding mode, and/or
wherein the first target coding mode is not applicable if W<T1 and/or H<T2, or
wherein the first target coding mode is not applicable, if W+H<T, or
wherein the first target coding mode is not applicable if W*H<T, or
wherein the first target coding mode is not applicable if W>T1 and/or H>T2, or
wherein the first target coding mode is not applicable if W+H>T, or
wherein the first target coding mode is not applicable if W*H>T, and
wherein W represents the block width, H represents the block height, T1, T2, and T represent thresholds, respectively, and/or
wherein if the signaled mode is CCLM, a flag indicating CCCM mode and the flag are both true, a current block uses the first target coding mode, and/or
wherein if the signaled mode is MM-CCLM, a flag indicating CCCM mode and the flag are both true are both true, a current block uses MM-extCCCM mode, and/or
wherein if the signaled mode is CCLM-T, a flag indicating CCCM mode and the flag are both true, a current block uses extCCCM-T mode, and/or
wherein if the signaled mode is MM-CCLM-T, a flag indicating CCCM mode and the flag are both true, a current block uses MM-extCCCM-T mode, and/or
wherein if the signaled mode is CCLM-L, a flag indicating CCCM mode and the flag are both true, a current block uses extCCCM-T mode, and/or
wherein if the signaled mode is MM-CCLM-L, a flag indicating CCCM mode and the flag are both true, a current block uses MM-extCCCM-T mode.

16. The method of claim 1, wherein the conversion includes encoding the video unit into the bitstream.

17. The method of claim 1, wherein the conversion includes decoding the video unit from the bitstream.

18. An apparatus for video processing comprising a processor and a non-transitory memory with instructions thereon, wherein the instructions upon execution by the processor, cause the processor to perform acts comprising:
applying, for a conversion between a video unit of a video and a bitstream of the video unit, at least one of the following in a cross-component prediction (CCP) model: a set of luma samples or a set of additional luma samples;
determining a prediction or reconstruction of the video unit by applying the CCP model to the video unit; and
performing the conversion based on the prediction or reconstruction.

19. A non-transitory computer-readable storage medium storing instructions that cause a processor to perform acts comprising:
applying, for a conversion between a video unit of a video and a bitstream of the video unit, at least one of the following in a cross-component prediction (CCP) model: a set of luma samples or a set of additional luma samples;
determining a prediction or reconstruction of the video unit by applying the CCP model to the video unit; and
performing the conversion based on the prediction or reconstruction.

20. A non-transitory computer-readable recording medium storing a bitstream of a video which is generated by a method performed by an apparatus for video processing, wherein the method comprises:
applying at least one of the following in a cross-component prediction (CCP) model: a set of luma samples or a set of additional luma samples;
determining a prediction or reconstruction of a video unit of the video by applying the CCP model to the video unit; and
generating the bitstream based on the prediction or reconstruction.
